(19) United States
(12) Patent Application Publication
(10) Pub. No.: US 2013/0218765 A1
(43) Pub. Date: Aug. 22, 2013

(54) GRADUATED SECURITY SEASONING APPARATUSES, METHODS AND SYSTEMS

(71) Applicants: Ayman Hammad, Pleasanton, CA (US); Kevin P. Siegel, Mountain View, CA (US); Craig O'Connell, San Mateo, CA (US)

(72) Inventors: Ayman Hammad, Pleasanton, CA (US); Kevin P. Siegel, Mountain View, CA (US); Craig O'Connell, San Mateo, CA (US)

(21) Appl. No.: 13/434,818

(22) Filed: Mar. 29, 2012

Related U.S. Application Data
(60) Provisional application No. 61/469,063, filed on Mar. 29, 2011.
(60) Provisional application No. 61/563,941, filed on Nov. 28, 2011.
(60) Provisional application No. 61/569,371, filed on Dec. 12, 2011.
(60) Provisional application No. 61/566,969, filed on Dec. 5, 2011.

(51) Int. Cl. G06Q 20/36

(52) U.S. Cl. 705/41

(57) ABSTRACT

The GRADUATED SECURITY SEASONING APPARATUSES, METHODS AND SYSTEMS (“GSS”) transform user virtual wallet activity and historical fraud reports via GSS components into transaction authorization triggers generated pursuant to graduated, transaction risk-appropriate, escalated security protocols. In one implementation, the GSS obtains a current transaction request, the request utilizing a user virtual wallet account for payment. The GSS identifies a transaction risk type associated with the request, and calculates a transaction risk level associated with the transaction risk type. Based on the transaction risk level, the GSS selects a security protocol for processing the current transaction request; and provide a security data request in accordance with the selected security protocol. The GSS also generates an offer, for an entity involved in processing the current transaction request, of a financial incentive in exchange for assuming the transaction risk level associated with the transaction risk type; and provides the offer for the entity.

### PRIORITY CLAIM

This application claims priority under 35 USC §119 to: U.S. provisional patent application Ser. No. 61/469,063 filed Mar. 29, 2011, entitled “WALLET TRANSACTION AUTHENTICATION APPARATUSES, METHODS AND SYSTEMS,” attorney docket no. P-42167PRV|20270-144PV2, U.S. provisional patent application Ser. No. 61/563,941 filed Nov. 28, 2011, entitled “WALLET VERIFICATION APPARATUSES, METHODS AND SYSTEMS,” attorney docket no. 13US01|20270-179PV, U.S. provisional patent application Ser. No. 61/569,371 filed Dec. 12, 2011, entitled “WALLET VERIFICATION APPARATUSES, METHODS AND SYSTEMS,” attorney docket no. 13US03|20270-179PV2, and U.S. provisional patent application Ser. No. 61/566,969 filed Dec. 5, 2011, entitled “DYNAMIC NETWORK ANALYTICS SYSTEM.” The entire contents of the aforementioned applications are expressly incorporated by reference herein.

This application for letters patent discloses and describes various novel innovations and inventive aspects of GRADUATED SECURITY SEASONING technology (hereinafter “disclosure”) and contains material that is subject to copyright, mask work, and/or other intellectual property protection. The respective owners of such intellectual property have no objection to the facsimile reproduction of the disclosure by anyone as it appears in published Patent Office file/records, but otherwise reserve all rights.

### FIELD

The present innovations generally address apparatuses, methods, and systems for electronic security, and more particularly, include GRADUATED SECURITY SEASONING APPARATUSES, METHODS AND SYSTEMS (“GSS”).

### BACKGROUND

Consumer transactions typically require a customer to select a product from a store shelf or website, and then to check the out at a checkout counter or webpage. The customer usually has to provide login information to proceed to checkout, or enter a 4-digit PIN number to authorize a transaction at checkout. Once payment is made and approved, the point-of-sale terminal memorializes the transaction in the merchant's computer system, and a receipt is generated indicating the satiSRActory consummation of the transaction.

### BRIEF DESCRIPTION OF THE DRAWINGS

The accompanying appendices, drawings, figures, images, etc. illustrate various example, non-limiting, inventive aspects, embodiments, and features (“e.g.,” or “example(s)”) in accordance with the present disclosure:

FIGS. 1A-B show block diagrams illustrating example aspects of the GSS;

FIG. 2 shows a block diagram illustrating an example GSS logic flow and component configuration;

FIG. 3 shows a datagraph diagram illustrating examples of transforming user virtual wallet activity via a User Wallet Activity Recording (“UWAR”) component into stored user wallet activity records;

FIG. 4 shows a logic flow diagram illustrating examples of transforming user virtual wallet activity via a User Wallet Activity Recording (“UWAR”) component into stored user wallet activity records;

FIG. 5 shows a datagraph diagram illustrating examples of transforming user fraud reporting inputs via a Fraud Data Recording (“FDR”) component into stored fraud report data records;

FIGS. 6A-B shows a logic flow diagram illustrating examples of transforming historical virtual wallet fraud reports via a Statistical Risk Analysis (“SRA”) component into transaction risk assessment data and rules;

FIG. 7 shows a logic flow diagram illustrating examples of transforming transaction requests, security inputs, historical wallet activity data, and transaction risk assessment data/rules via a Transaction Risk Assessment (“TRA”) component into transaction risk assessment type/score signals;

FIG. 8 shows block and logic flow diagrams illustrating examples of transforming transaction risk type and score assessments, security data, and transaction risk allocation offer responses via a Graduated Security Escalation (“GSE”) component into transaction authorization notifications/triggers and transaction denial notifications;

FIG. 9 shows a datagraph diagram illustrating example aspects of transforming a user checkout request input via a User Purchase Checkout (“UPC”) component into a checkout data display output;

FIG. 10 shows a logic flow diagram illustrating example aspects of transforming a user checkout request input via a User Purchase Checkout (“UPC”) component into a checkout data display;

FIGS. 11A-B show datagraph diagrams illustrating example aspects of transforming a user virtual wallet access input via a Purchase Transaction Authorization (“PTA”) component into a purchase transaction receipt notification;

FIGS. 12A-B show logic flow diagrams illustrating example aspects of transforming a user virtual wallet access input via a Purchase Transaction Authorization (“PTA”) component into a purchase transaction receipt notification;

FIGS. 13A-B show datagraph diagrams illustrating example aspects of transforming a merchant transaction batch data query via a Purchase Transaction Clearance (“PTC”) component into an updated payment ledger record;

FIGS. 14A-B show logic flow diagrams illustrating example aspects of transforming a merchant transaction batch data query via a Purchase Transaction Clearance (“PTC”) component into an updated payment ledger record;

FIG. 15 shows a user interface diagram illustrating an overview of example features of virtual wallet applications in some embodiments of the GSS;

FIGS. 16A-G show user interface diagrams illustrating example features of virtual wallet applications in a shopping mode, in some embodiments of the GSS;

FIGS. 17A-F show user interface diagrams illustrating example features of virtual wallet applications in a payment mode, in some embodiments of the GSS;

FIG. 18 shows a user interface diagram illustrating example features of virtual wallet applications, in a history mode, in some embodiments of the GSS;

FIGS. 19A-E show user interface diagrams illustrating example features of virtual wallet applications in a snap mode, in some embodiments of the GSS;

FIG. 20 shows a user interface diagram illustrating example features of virtual wallet applications, in an offers mode, in some embodiments of the GSS;

FIGS. 21A-B show user interface diagrams illustrating example features of virtual wallet applications, in a security and privacy mode, in some embodiments of the GSS;

FIGS. 22A-F include example data flows, where the GSS may be effected, and illustrates various additional advantageous aspects of the GSS; and

FIG. 23 shows a block diagram illustrating example aspects of a GSS controller.

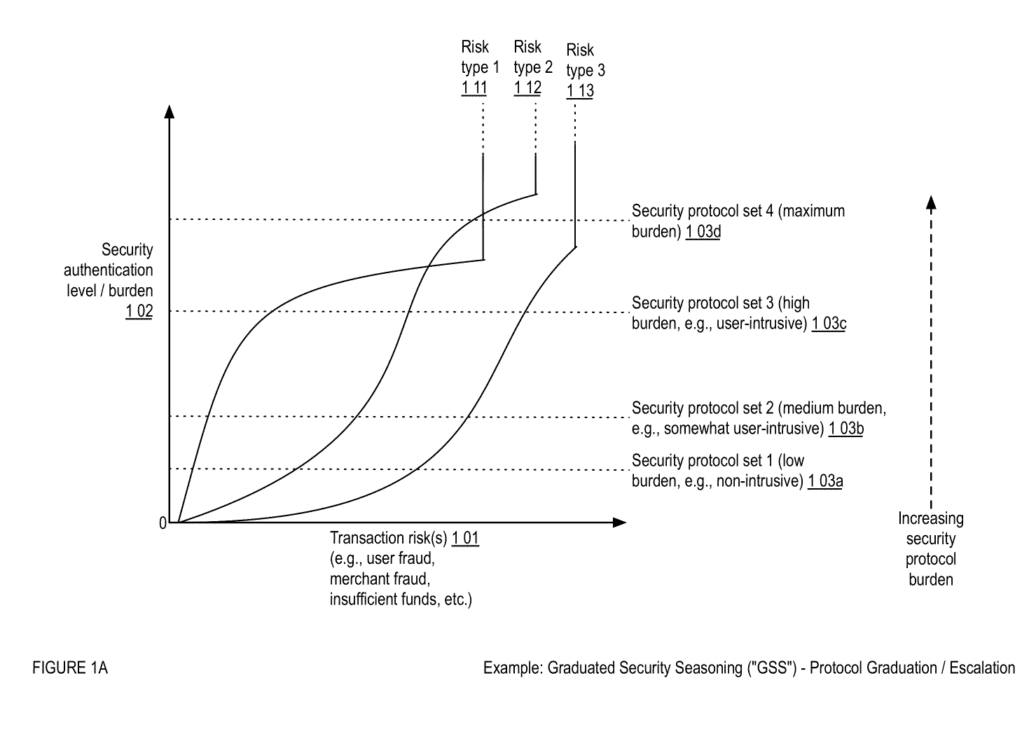

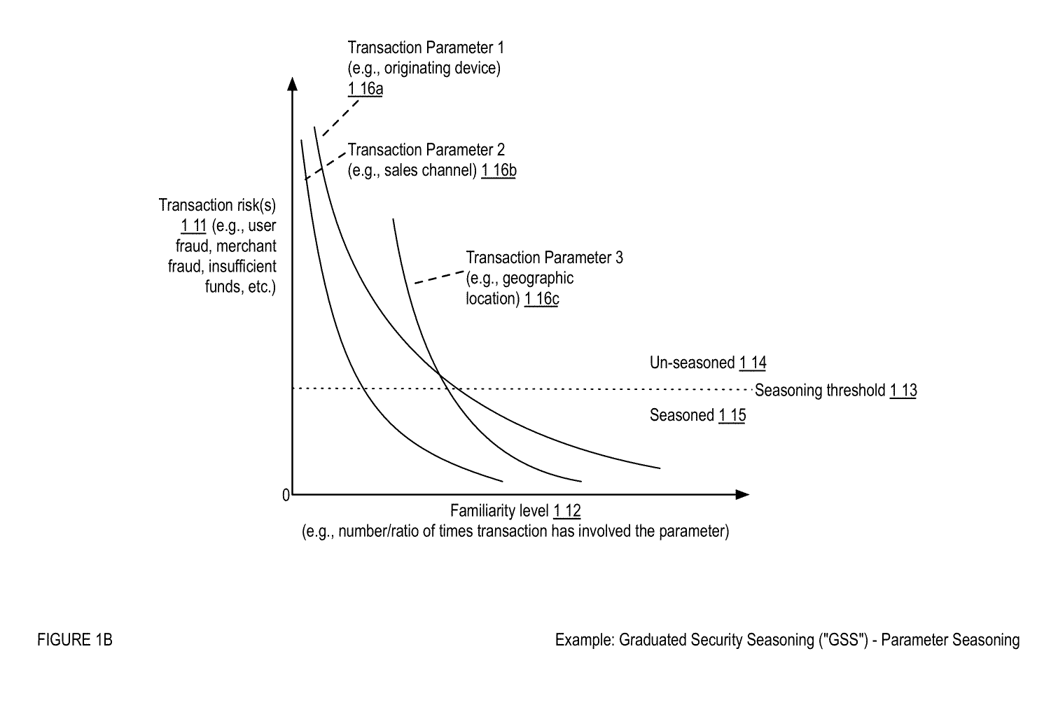

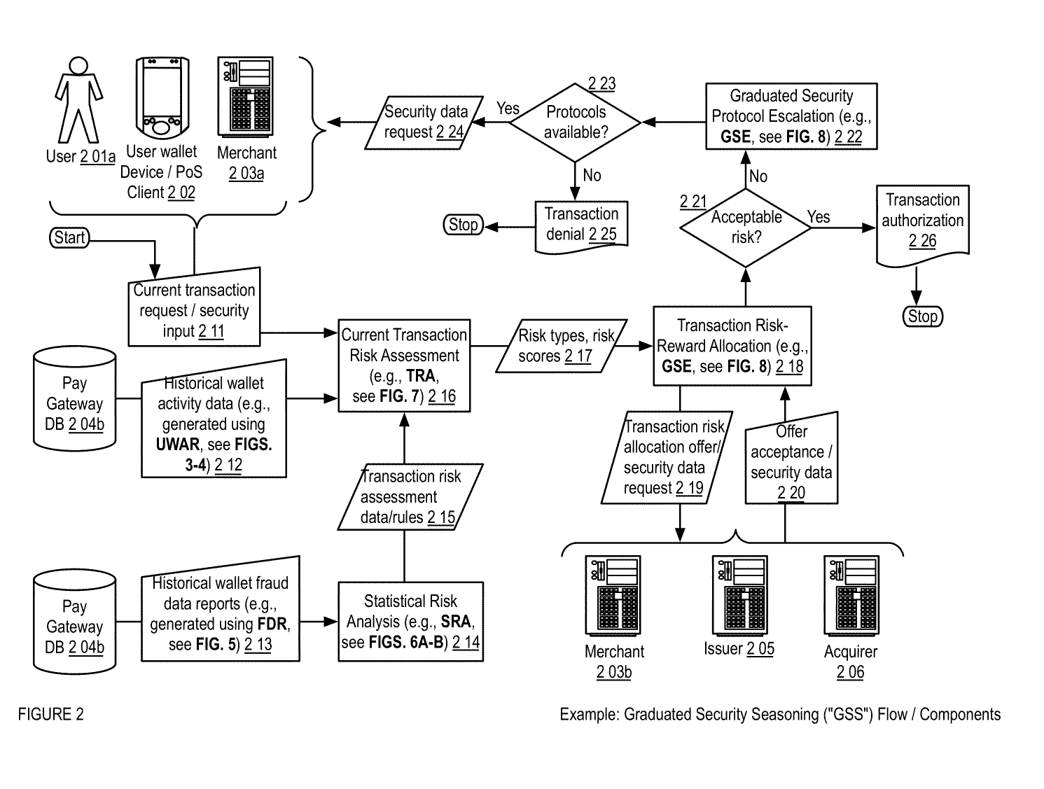

The leading number of each reference number within the drawings indicates the figure in which that reference number is introduced and/or detailed. As such, a detailed discussion of reference number 101 would be found and/or introduced in FIG. 1. Reference number 201 is introduced in FIG. 2, etc.

### DETAILED DESCRIPTION

### Graduated Security Seasoning (GSS)

The GRADUATED SECURITY SEASONING APPARATUSES, METHODS AND SYSTEMS (hereinafter “GSS”) transform user virtual wallet activity and historical fraud reports, via GSS components, into transaction authorization triggers generated pursuant to graduated, transaction risk-appropriate, escalated security protocols. FIGS. 1A-B show block diagrams illustrating example aspects of the GSS. With reference to FIG. 1A, in some embodiments, the GSS may allow a user to engage in a purchase transaction with a merchant using one or more accounts stored in a virtual wallet of the user. For example, the user may download and install a GSS mobile wallet component on a mobile device (e.g., an Apple iPhone, a BlackBerry, a Google Android, a Samsung Galaxy, etc.) or other portable web-enabled computing device. As another example, a user may be able to access a virtual wallet account from a point-of-sale (“POS”) terminal in a merchant store, or on a merchant website. Alternative and/or complementary user interfaces are also contemplated including: desktop applications, plug-ins to existing applications, stand alone mobile applications, web based applications (e.g., applications with web objects/frames, HTML 5 applications/wrappers, web pages, etc.), and/or the like.

In some embodiments, the GSS may perform security checks before authorizing a transaction using an account from the user's virtual wallet. For example, the GSS may assess transaction risks associated with authorizing the transaction to be completed. For example, the GSS may identify one or more transaction risk types, and associated risk scores to each of the transaction risk types. Examples of risk types include, without limitation: user fraud, merchant fraud, insufficient account funds, product return, television advertisement scams, product recall, account hacks, wire fraud, mail fraud, spyware/malware invading transaction privacy, etc. The GSS may require specific security protocols to be adopted depending on the transaction risk types. In some embodiments, the GSS may determine a risk score associated with each risk type, and modify the security protocols followed to authorize the transaction depending on the risk scores. For example, the GSS may determine a risk score for each risk type based on factors such as, without limitation: the type of the current transaction (e.g., user enrollment into a new request, purchase transaction, modifying user wallet settings, modifying privacy settings, accessing personal information), current user transaction request details, historical (including recent/real-time) user virtual wallet activity, historical fraud reporting data (e.g., including parameters correlated to fraudulent activity), responses to secure authentication requests, etc.

In some embodiments, the GSS may categorize risks associated with a type of transaction risk into graduated levels. According to the graduated level of the risk type, the GSS may appropriately escalate (or de-escalate, as the case may be) the security protocol(s) required to mitigate the risk. For example, where a transaction risk type is at a higher risk level, the GSS may escalate the security protocol required to authorize the transaction to a more secure protocol, which in some scenarios may come with additional attendant burden on the entity (e.g., a user) required to engage in the security protocol.

With reference to FIG. 1A, a first tier of (low) risk may only require a security protocol set 1 (103a), which may have a low burden. For example, the protocol may only require a response from a device of the user, without requiring the user to provide any input for the device to generate a response. For example, if a device has to provide its IP address, user intervention may not be required. However, if a transaction risk type (e.g., risk types (iii), risk type 2 (112), risk type 3 (113)), has a higher risk score, then the GSS may escalate the protocols employed from security protocol set 1 to security protocol set 2 (103b) (which may pose a higher burden to one of the entites involved in the transaction). Similarly, as the transaction risk score for a transaction risk type increases, the GSS may escalate the security protocol set for the entities involved in the transaction to security protocol set 3 (103c) or security protocol set 4 (103d). It is to be understood that different transaction risk types may be escalated at different values of risk scores associated with each of the risk types, either dependent on or independent of the escalation of security protocols for any of the other transaction risk types associated with the transaction. For example, the graduated levels for the different transaction risk type may be drawn at different values of transaction risk scores associated with the transaction risk types. Further, it is to be understood that the set of entities engaged in a security protocol associated with one graduate risk level may be the same as, of different from, the set of entities engaged in a different security protocol associated with a different graduated risk level.

In some embodiments, the selection of a security protocol may be dependent on the amount of burden (e.g., amount of time, amount of user input, amount of attention that needs to be paid, etc.) imposed on the entity (e.g., a user) engaged in the security protocol. For example, if a risk can be mitigated by either of two sets of protocols, and one set imposes a lesser burden on the entity engaged in the security protocol than the other, then the first set may be chosen in some embodiments. Similarly, in some embodiments, the security protocol that imposes the least burden on a human (e.g., a user) may be chosen, even if it means that the burden imposed on a device (e.g., the user's smartphone) may be higher. For example, the GSS may choose security protocols that can mitigate the risk while minimizing the intrusion into the user's experience, or minimizing the amount of attention the user needs to pay to the security protocol.

With reference to FIG. 1B, in some embodiments, the GSS may determine a transaction risk level in, of a transaction risk type associated with a transaction request, based on the familiarity 112 that the GSS has with the parameters of the transaction request. For example, when the GSS has a low level of familiarity with an originating device (e.g., a smartphone, desktop computer, point-of-sale terminal), the GSS may calculate the transaction risk(s) associated with the transaction request as being higher compared to when the GSS has a higher level of familiarity with the originating device (see curve in FIG. 1B for transaction parameter 1, 116a). Such familiarity-based transaction risk assessment may extend to any parameter of the current transaction request. For example, FIG. 1B shows two curves representing the dependence of the transaction risk level of a transaction risk type associated with the transaction request on the familiarity of the GSS with the sales channel (e.g., mobile, online, physical store, etc.) utilize for the transaction (see 116b), and the dependence of the transaction risk level of a transaction risk type associated with the transaction request on the familiarity of the GSS with the geographic location of the originator of the transaction (see 116b). Other parameters to which such familiarity-based transaction risk assessment may extend include, without limitation: user ID; merchant ID; product type; product ID; transaction cost; payment mechanism (e.g., account numbers); geographical location; payment currency; combinations thereof and/or the like. In some embodiments, the GSS may determine that the familiarity of a transaction parameter is such that the transaction risk contribution of that parameter may be neglected in the calculation of transaction risk. Such a parameters may be determined to be “seasoned” 115, whereas parameters that the GSS may determine may not (yet) be neglected in the calculation of transaction risk may be considered “unseasoned” 114. In some embodiments, the GSS may utilize different seasoning thresholds 113 to determine the seasoning of different parameters in the calculation of transaction risk. Further, in various embodiments, the calculation of transaction risk may depend on numerous factors besides the seasoning levels of the parameters of the transaction request.

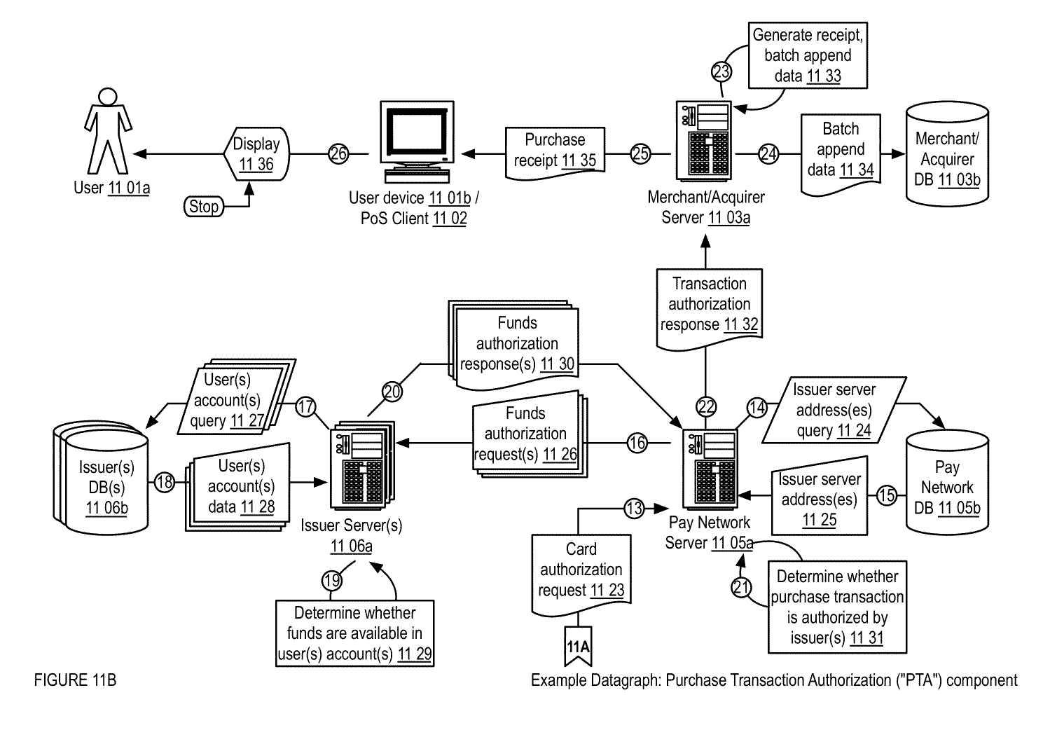

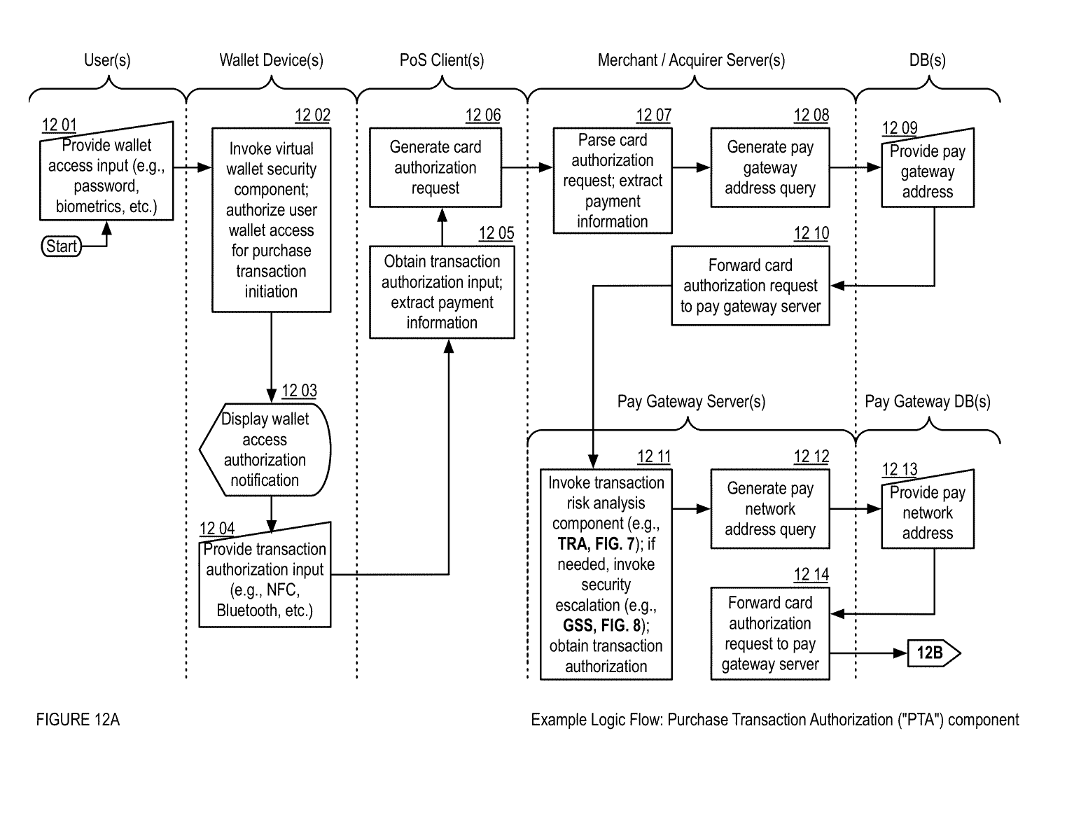

Accordingly, in some embodiments of the GSS, authentication of a transaction can be done separately from authorization/payment, in any environment (e.g., electronic commerce, mobile payments, person-to-person, etc.). In some embodiments, authentication may be integrated into the authorization flow, e.g., as illustrated in FIG. 11A. In some embodiments, consumer credentials as well as device credentials may be evaluated for risk and fraud management. In general, the GSS may apply graduated authentication and fraud review appropriate to the action being taken and the actual risk of loss or data compromise. The GSS may utilize non-invasive technologies where possible. Examples of risks that the GSS may eliminate or mitigate using graduated authentication during scenarios including, without limitation: merchant on-boarding and authentication; merchant transaction processing (e.g., platform review of merchant activity); merchant login, and maintenance; merchant pay-out/deposit changes, user creation etc.; consumer registration; consumer login; consumer maintenance (e.g., updating preferences, reviewing transactions, rewards, etc.); adding cards, shipping address, payment methods, etc.; reviewing transactions; and/or the like. In all such activites, the GSS may provide gradated, escalatable, initial evaluations and requirements, and may have customized authenticated decision trees applied to them using a variety of data elements including, without limitation: federated IDs; username/account alias; password; IP address; device fingerprint-issuer record comparison; device fingerprint-wallet record comparison; address verification services; identification challenge questions; merchant IP address; merchant device; merchant BIN; merchant card number; merchant-stored shipping address; email address; phone number; CVV; and/or the like. In some embodiments of the GSS, a failure of authentication may result not in a full denial of the transaction, but in an escalation of the challenge presented to the entity taking the action. The risk in such transaction may be assessed using indicators available in data fields including, without limitation: category of action; type of action; user history; merchant history; device intelligence data elements; merchant category; product category; product quantity; product price point; and/or the like. The GSS may also utilize device fingerprinting data in real-time risk assessment/security protocol graduation for online and/or mobile transactions. Authentication challenges during protocol escalation may include calls to third-party identification services (e.g., Idology, Experian, Accurint, 192.com, Dunn & Bradstreet, etc.). Such third-party calls may be saved for the highest risk events, such as merchant automated underwriting or high risk/high price consumer initiated events.

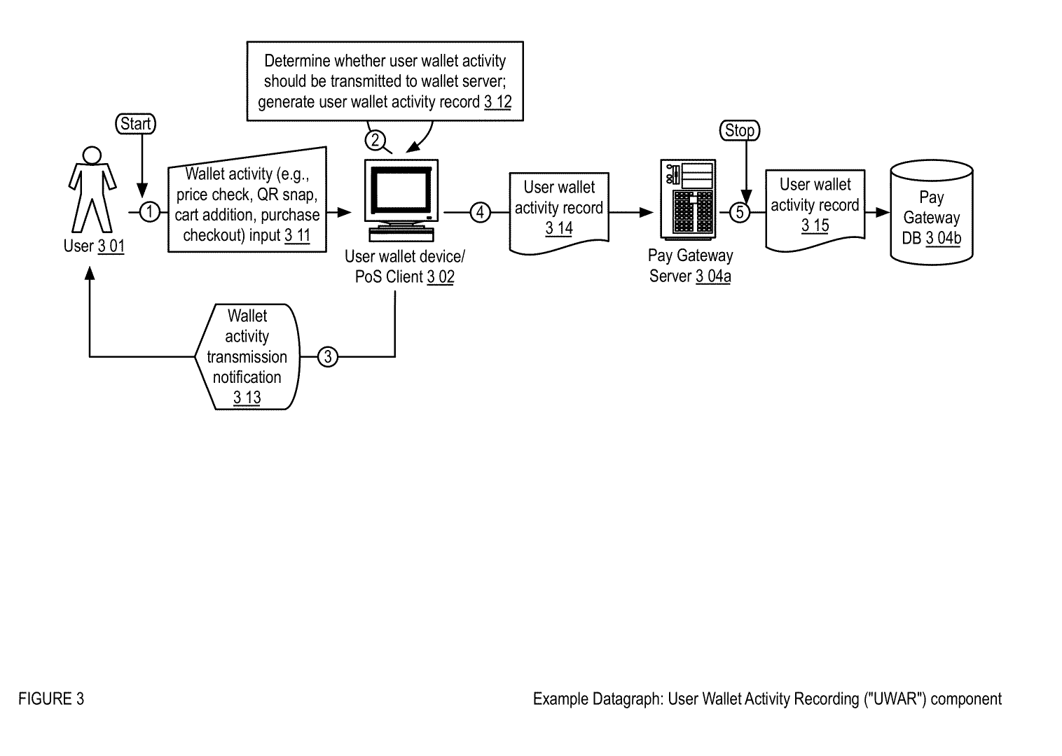

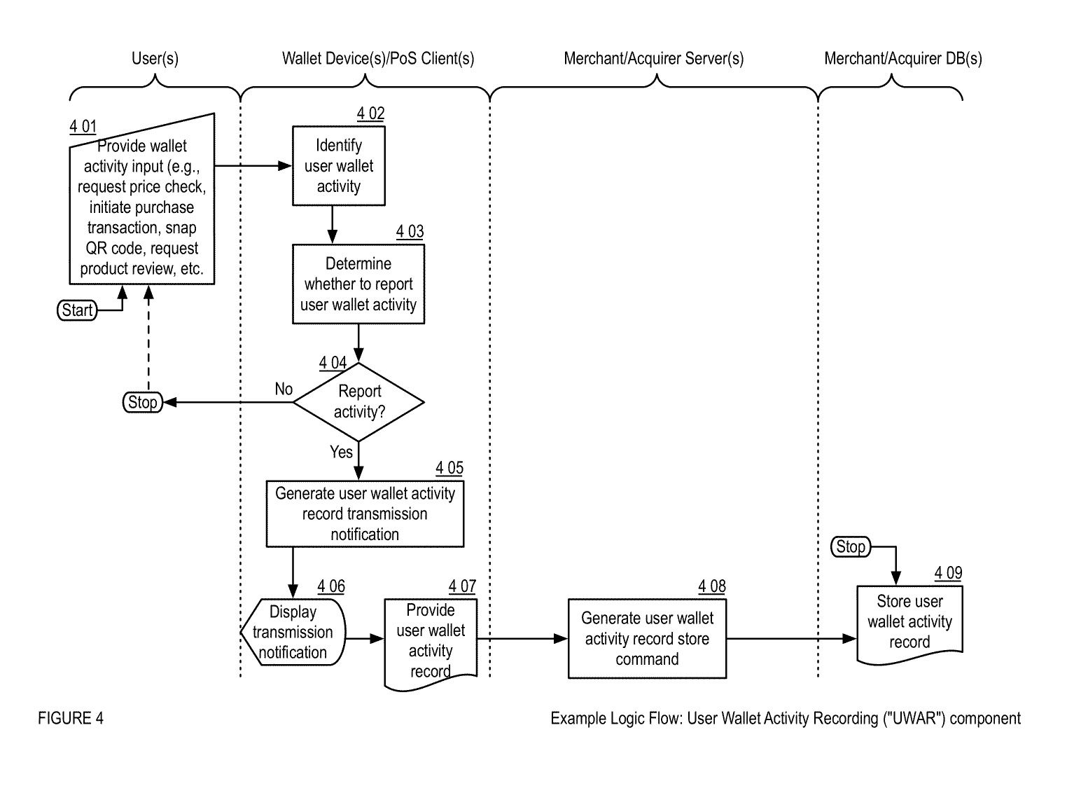

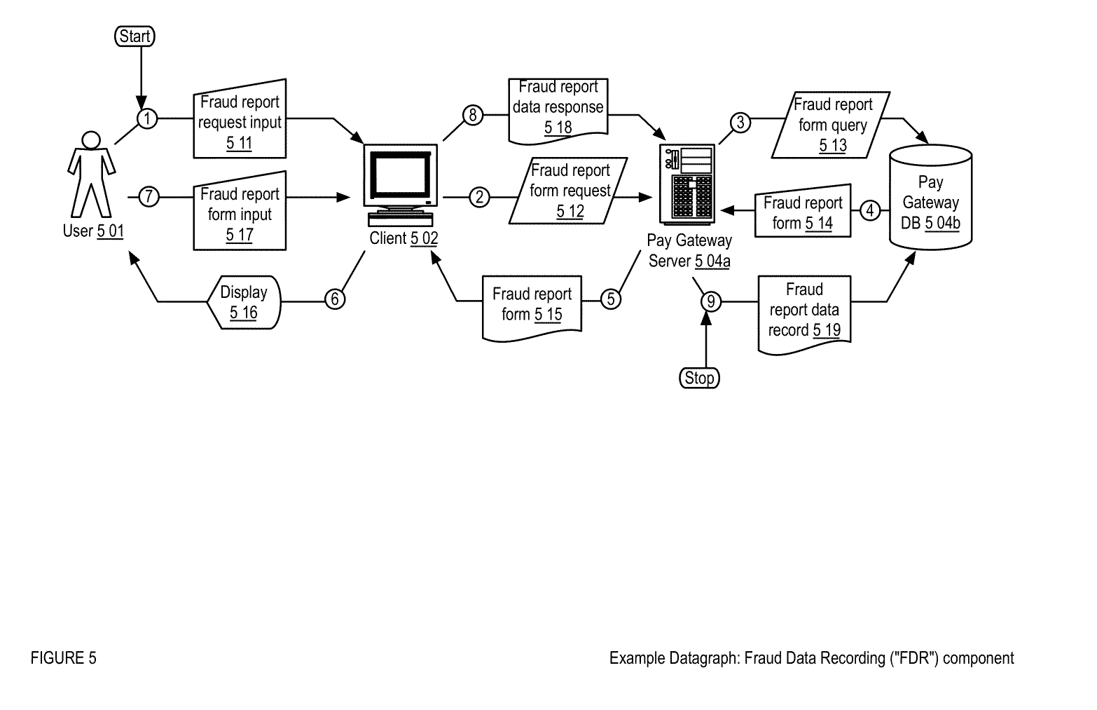

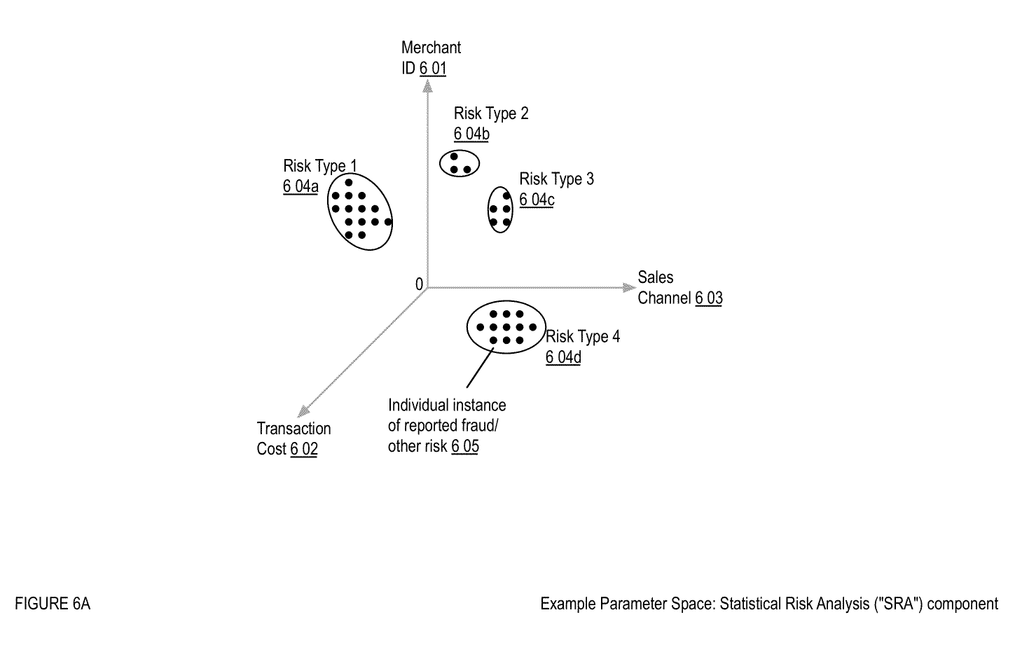

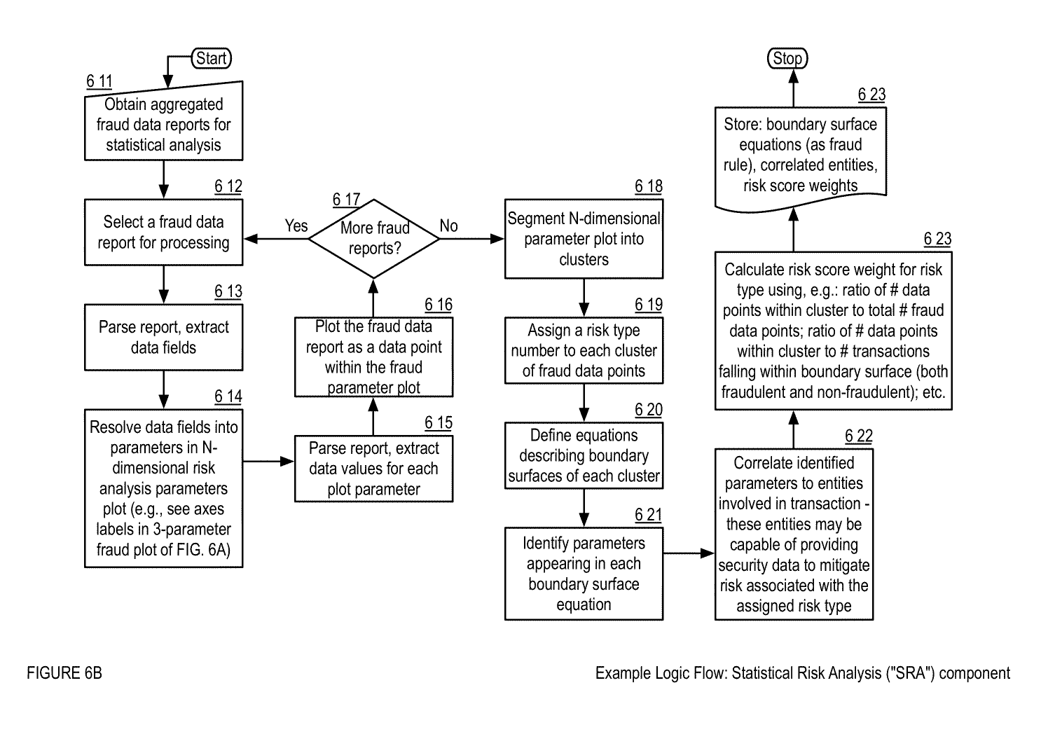

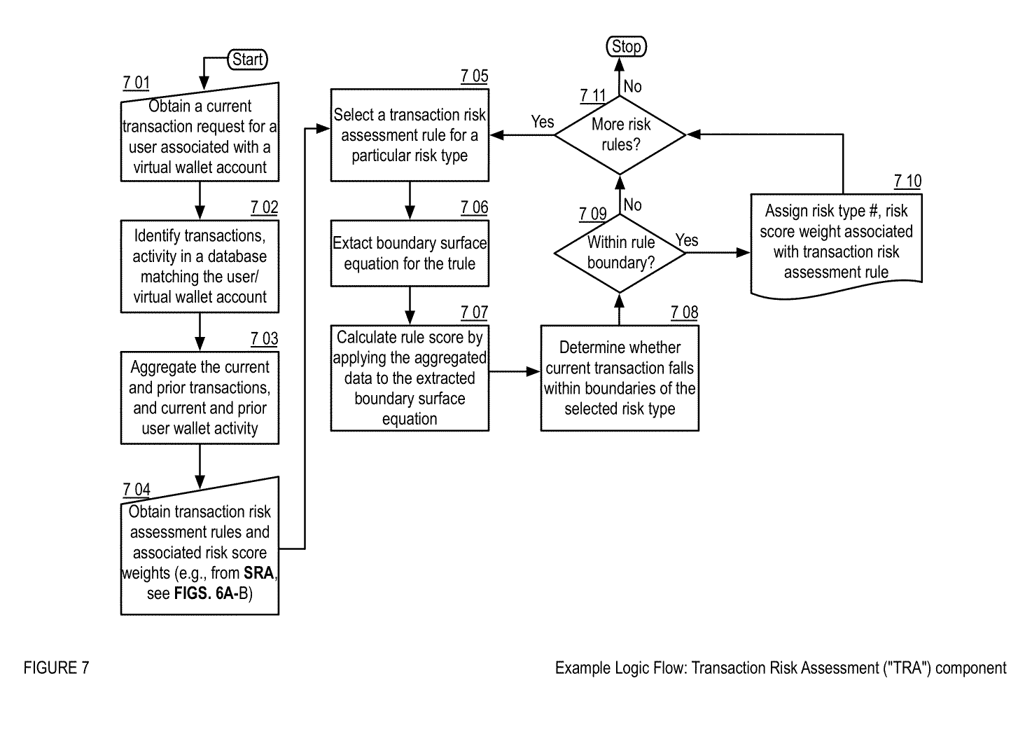

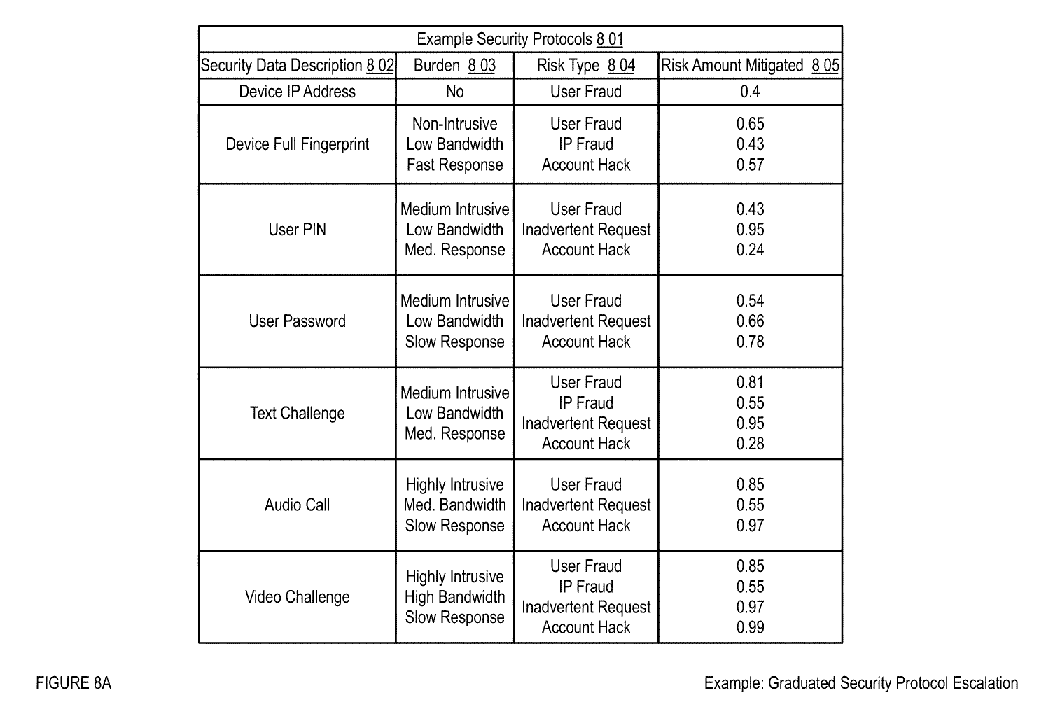

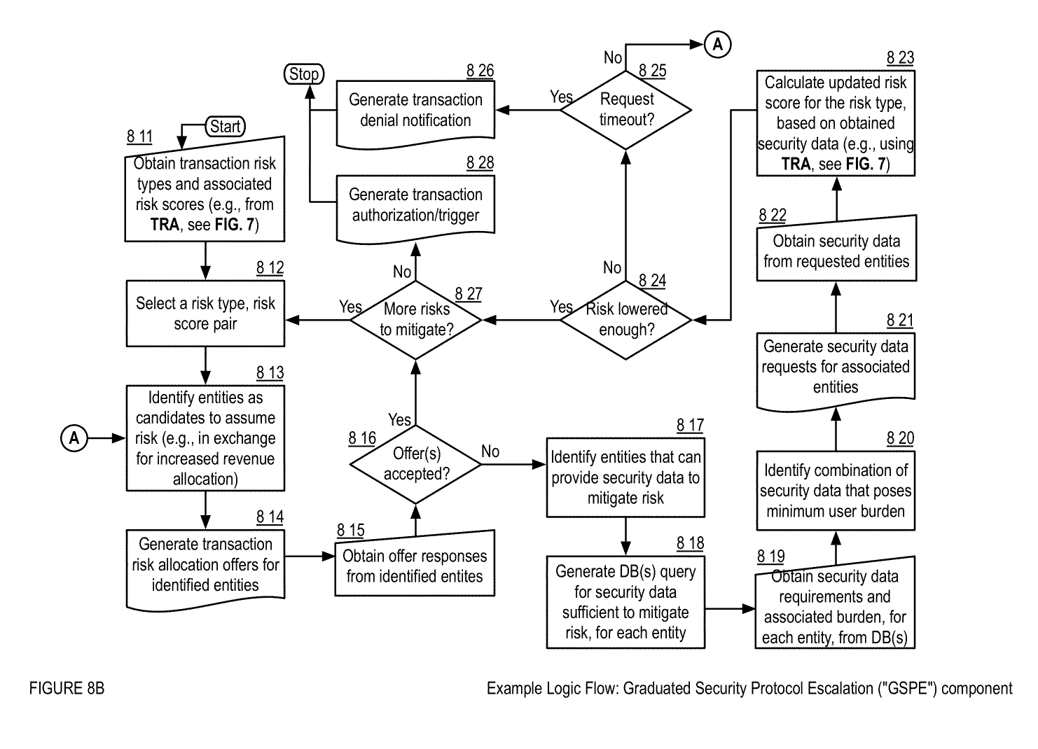

FIG. 2 shows a block diagram illustrating an example GSS logic flow and component configuration. In some embodiments, a user, a merchant, a user device, etc. may request the GSS to authorize a purchase transaction, e.g., 211. For example, the request may take the form of a card authorization request, such as that card authorization request 1116, depicted in the example purchase transaction authorization (“PTA”) component of FIG. 11. The GSS may obtain historical data on user's activity (including recent or real-time user behavior in the virtual wallet) in the user's (or user-related) virtual wallet from a database, e.g., 212. For example, the GSS may utilize a component such as the example user wallet activity recording (“UWAR”) component of FIGS. 3-4 to generate historical user wallet activity data records that are stored in the database. In some embodiments, the GSS may also obtain historical virtual wallet fraud data reports, e.g., 213, to inform transaction risk analysis. For example, the GSS may utilize a component such as the example fraud data recording (“FDR”) component of FIG. 5 to generate historical (virtual wallet) fraud data records that are stored in a database. The GSS may perform a Statistical Risk Analysis, e.g., 214, on the historical fraud data records to generate transaction risk assessment reference data points, rules, score weights, etc., e.g., 215. For example, the GSS may utilize a component such as the example Statistical Risk Analysis (“SRA”) component of FIGS. 6A-B to generate the transaction risk assessment reference data points, rules, score weights, etc. Using the current transaction request data, the user's historical virtual wallet activity, and historical fraud data-based transaction risk assessment reference data points, rules, score weights, etc., the GSS may identify a set of transaction risk types associated with the current transaction request, and may calculate a risk score associated with each of the transaction risk types, e.g., 216. For example, the GSS may utilize a component such as the example transaction risk assessment (“TRA”) component of FIG. 7, to identify a set of transaction risk types associated with the current transaction request, and calculate risk scores associated with each of the transaction risk types.

In some embodiments, the GSS may attempt to allocate the transaction risks associated with the current transaction request to one or more entities involved in the current transaction (e.g., user, merchant, issuer, acquirer, payment service processor, payment network, etc.). For example, the GSS may provide an offer to one or more of the entities to assume (a portion of) the risk type associated with the transaction, e.g., 219. For example, the GSS may offer a discount, rewards, incentive, bonus, future payout, reduced transaction fees, etc., in exchange for the entity assuming the risk specified in the offer. If any of the entities accept the offer to assume (a portion of) the risk type, then the GSS may recalculate the risk score associated with the risk type. If the risk score is acceptable, see 221, (e.g., lower than a maximum allowable risk threshold value for the risk type for the current transaction), then the GSS may authorize the transaction (assuming no other transaction risks are present that need to be mitigated). If the risk score is not at an acceptably low level, then the GSS may select a set of security protocols for the entities involved in the transaction to engage in before authorizing the transaction, e.g., 222. For example, the GSS may utilize a component such as the example graduated security protocol escalation (“GSPE”) component of FIGS. 8A-B, to select a set of security protocols for the entities involved in the transaction to engage in before authorizing the transaction. If there are no security protocols that can be engaged in to mitigate the transaction risks (see 223), the GSS may deny the transaction, e.g., 225. If, however, there are security protocols that may mitigate the risk if successfully completed, then the GSS may request the entities involved in the transaction (e.g., user, user device, merchant, merchant device, issuer, acquirer, etc.) to provide security data, e.g., 224, 219. The entities may provide the rquested security data, otherwise the GSS may deny the transaction request. The GSS may utilize the new security data, in addition to the previously mentioned adat, to re-assess the risk(s) involved in the transaction, and if needed, re-apply the above-mentioned procedure until the level of each transaction risk type is reduced to acceptable levels, or the risks are assumed by one of the entities involved in the transaction. Upon obtaining confirmation that the risk types are all at acceptable levels, the GSS may authorize the transaction for execution, e.g., 226.

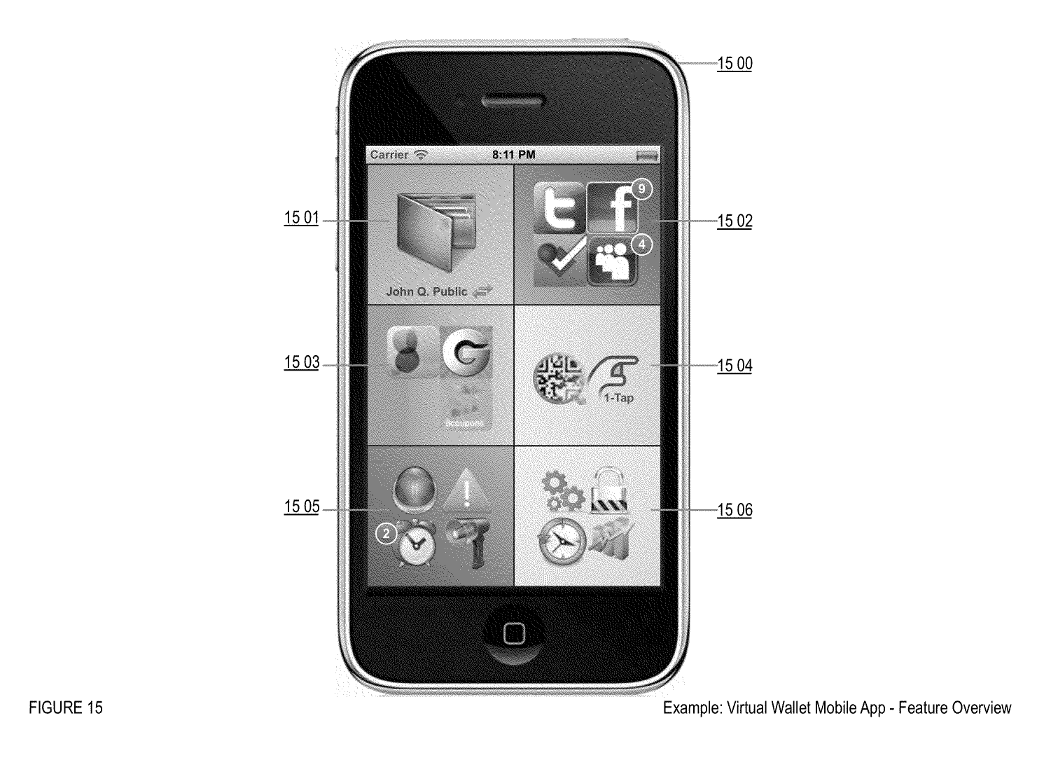

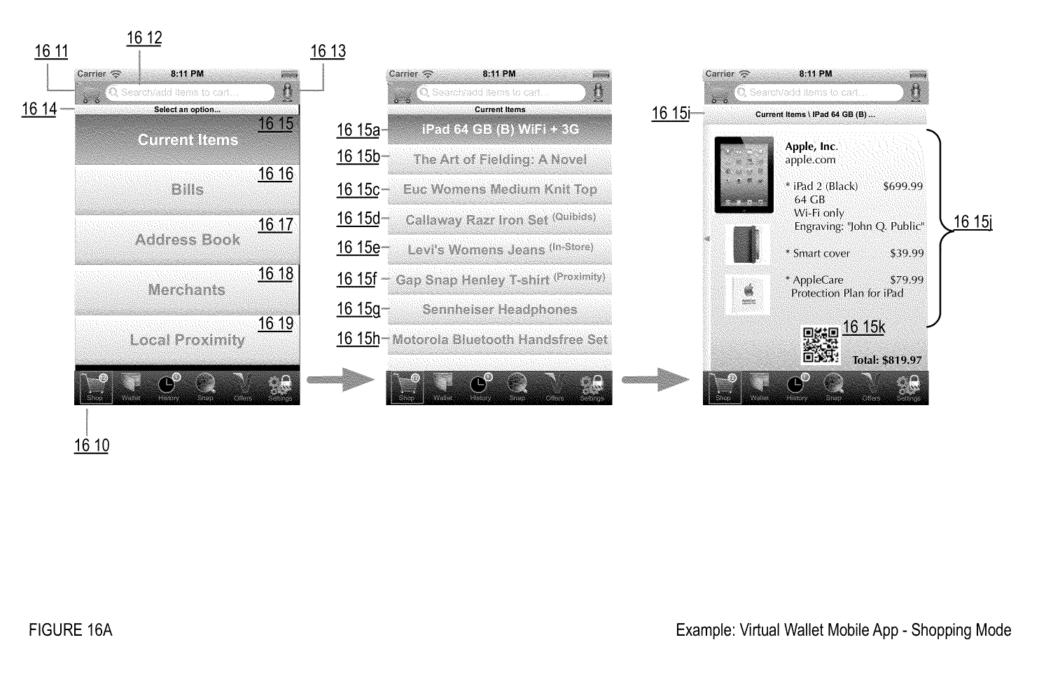

FIG. 3 shows a datagraph diagram illustrating examples of transforming user virtual wallet activity via a User Wallet Activity Recording (“UWAR”) component into stored user wallet activity records. In some embodiments, a user, e.g., 301, may provide inputs into a user wallet device or point-of-sale terminal (“device”), e.g., 302, representing user actions within a virtual wallet of the user. In various implementations, the user input may include, but not be limited to: a single tap (e.g., a one-tap mobile app purchasing embodiment) of a touchscreen interface, keyboard entry, card swipe, activating a RFID/NFC enabled hardware device (e.g., electronic card having multiple accounts, smartphone, tablet, etc.) within the user device, mouse clicks, depressing buttons on a joystick/game console, voice commands, single/multi-touch gestures on a touch-sensitive interface, touching user interface elements on a touch-sensitive display, and/or the like. Such physical user input may be representative of the user's desire to perform an action within the virtual wallet. For example, the user may desire to perform a price check for a product (e.g., by scanning the product's barcode using the user device), snap a QR code, add a product to an electronic shopping cart, request a purchase, select payment options, etc. FIGS. 15-21 depict various features that avirtual wallet application may provide to a user; thus, any of the features described herein, and any like features, may be activated by the user, and such user actions may be recorded. The device may determine whether the user wallet activity should be transmitted to a wallet server for recording, e.g., 312. Upon determining that the user action should be recorded at a server, the device may present a wallet activity transmission notification, e.g., 313, to the user. In some embodiments, the user may be able to set (e.g., via privacy control settings), the type, amount, detail, etc. of user wallet activity that may be provided by the device to the server. The device may generate a user wallet activity record, and provide the user wallet activity record to the wallet server. For example, the record may include a batch of user actions aggregated together, and sent as a single message, or the record may include a single user action sent per message. For example, the device may provide the user wallet activity record 314 to a pay gateway server, e.g., 304a, as a HTTP(S) POST message including XML-formatted data, substantially in the form of the example below:

POST /walletactivityrecord.php HTTP/1.1
Host: www.paygateway.com
Content-Type: Application/XML
Content-Length: 1283
<?XML version = “1.0” encoding = “UTF-8”?>
<activity_record>

<user_ID>john.q.public</user_ID>
<timestamp>2052-11-12 09:33:43</timestamp>
<action>

<type>scan</type>
<target>QR</target>
<detail>

<merchant_params>

<merchant_id>54TBRELF8</merchant_id>
<merchant_name>BARNES, Inc.</merchant_name>
<merchant_auth_key>TMN45GER98</merchant_auth_key>

</merchant_params>
<product_type>book</product_type>
<product_params>

<product_title>XML for dummies</product_title>
<ISBN>938-2-14-168710-0</ISBN>
<edition>2nd ed.</edition>
<cover>hardbound</cover>

</product_params>
<quantity>2</quantity>
<unit_cost>$14.46</unit_cost>
<coupon_id>AY34567</coupon_id>
<social_flag>ON</social_flag>
<social_message>Look what I bought today!</social_message>
<social_networks>facebook twitter</social_networks>

</detail>

</datatype1>

<!--optional parameters-->

<device_fingerprint>

<device_IP>192.168.23.126</device_IP>
<device_MAC>0123.4567.89ab</device_MAC>
<device_serial>312456768798765432</device_serial>
<device_ECID>00000AEBCDF12345</device_ECID>
<device_identifier>jqp_air</device_identifier>
<device_UDID>21343e34-14f4-8jn4-7yfe-124578632134</device_UDID>
<device_browser>firefox 2.2</device_browser>
<device_type>smartphone</device_type>
<device_model>HTC Hero</device_model>
<OS>Android 2.2</OS>
<wallet_app_installed_flag>true</wallet_app_installed_flag>

</device_fingerprint>

</activity_record>

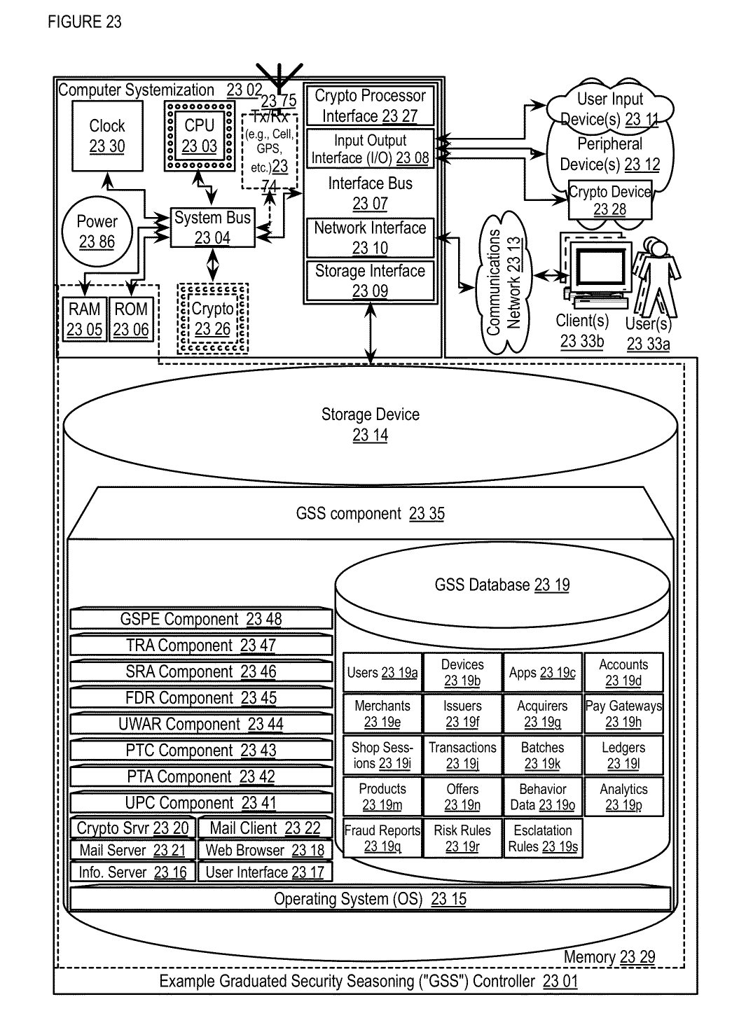

In some embodiments, the pay gateway server may obtain the user wallet activity record from the device, and may parse the user wallet activity record to extact the data field and their associated values. The pay gateway server may store, e.g., 315, the extracted fields and data values in a pay gateway database, e.g., 304b. For example, the pay gateway server may issue hypertext preprocessor/structured query language (“PHP/SQL”) commands to store the data to a database table (such as FIG. 23, Behavior Data 2319n). An example user wallet activity record store command 315, substantially in the form of PHP/SQL commands, is provided below:

<?PHP
header(′Content-Type: text/plain′);
mysql_connect(″254.92.185.103”,$DBserver,$password); // access
database server
mysql_select(″GSS_DB.SQL″); // select database to append
mysql_query(“INSERT INTO BehaviorDataTable (user_id, timestamp,
action_data)
VALUES ($userid, time( ), $actdata_xml)”); // add data to table in
database
mysql_close(″GSS_DB.SQL″); // close connection to database
?>

FIG. 4 shows a logic flow diagram illustrating examples of transforming user virtual wallet activity via a User Wallet Activity Recording (“UWAR”) component into stored user wallet activity records. In some embodiments, a user may provide inputs, e.g., 401, into a user wallet device or point-of-sale terminal (“device”), representing user actions within a virtual wallet of the user. In various implementations, the user input may include, but not be limited to: a single tap (e.g., a one-tap mobile app purchasing embodiment) of a touchscreen interface, keyboard entry, card swipe, activating a RFID/NFC enabled hardware device (e.g., electronic card having multiple accounts, smartphone, tablet, etc.) within the user device, mouse clicks, depressing buttons on a joystick/game console, voice commands, single/multi-touch gestures on a touch-sensitive interface, touching user interface elements on a touch-sensitive display, and/or the like. Such physical user input may be representative of the user's desire to perform an action within the virtual wallet. For example, the user may desire to perform a price check for a product (e.g., by scanning the product's barcode using the user device), snap a QR code, add a product to an electronic shopping cart, request a purchase, select payment options, etc. FIGS. 15-21 depict various features that avirtual wallet application may provide to a user; thus, any of the features described herein, and like features, may be activated by the user, and such user actions may be recorded. The device may identify the user activity, e.g., 402. For example, the device may utilize the gesture-identification features of the operating system of the device, and combine that information with the virtual wallet interface features to identify the user action. The device may determine whether the user wallet activity should be transmitted to a wallet server for recording, e.g., 403. For example, the device may compare the recorded user activity to a list of actions (e.g., in a lookup table) to determine whether the recorded user activity is present in the list. Upon determining that the user action should be recorded at a server (404, option “Yes”), the device may generate a wallet activity transmission notification, e.g., 405, for the user, and present the wallet activity transmission notification for the user via a display of the device, e.g., 406. In some embodiments, the user may be able to set (e.g., via privacy control settings), the type, amount, detail, etc. of user wallet activity that may be provided by the device to the server. The device may generate a user wallet activity record, and provide the user wallet activity record to the wallet server, e.g., 407. For example, the record may include a batch of user actions aggregated together, and sent as a single message, or the record may include a single user action sent per message. In some embodiments, the pay gateway server may obtain the user wallet activity record from the device, and may parse the user wallet activity record to extract the data field and their associated values. For example, the pay gateway server may utilize a parser such as the example parsers described below in the discussion with reference to FIG. 23, to extract the data field and their associated values. The pay gateway server may store, e.g., 408-409, the extracted fields and data values in a pay gateway database.

FIG. 5 shows a datagraph diagram illustrating examples of transforming user fraud reporting inputs via a Fraud Data Recording (“FDR”) component into stored fraud report data records. In some embodiments, a user, e.g., 501, may wish to report a fraudulent acitivty involving the user's virtual wallet. For example, the fraudulent activity may include missing (or unintended additional) accounts within the user's virtual wallet, missing (or unintended additional) transactions using the virtual wallet account, etc. The user may provide a fraud report request input into a client, e.g., 502. In various implementations, the user input may include, but not be limited to: a single tap (e.g., a one-tap mobile app purchasing embodiment) of a touchscreen interface, keyboard entry, card swipe, activating a RFID/NFC enabled hardware device (e.g., electronic card having multiple accounts, smartphone, tablet, etc.) within the user device, mouse clicks, depressing buttons on a joystick/game console, voice commands, single/multi-touch gestures on a touch-sensitive interface, touching user interface elements on a touch-sensitive display, and/or the like. In response, the client may generate and provide a fraud report form request, e.g., 512, to a pay gateway server, e.g., 504a. For example, the client may provide the fraud report form request 512 as a HTTP(S) GET message, substantially in the form of the example below:

GET /fraudreportform.html HTTP/1.1
From: jqp@mail.com
User-Agent: Firefox/1.0

The pay gateway server may query a database, e.g., 504b, for the fraud report form, e.g., 513-514, and may provide the fraud report form, e.g., 515, to the client. For example, the pay gateway server may provide a HTML input form to the client. The client may display, e.g., 516, the fraud report form for the user. In some implementations, the user may provide fraud report form input into the client, e.g., 517, and the client may generate a fraud report data response, e.g., 518, for the pay gateway server. The pay gateway server may parse the fraud report data response and extract the data fields and their associated values, and generate a record for storage, e.g., 519, in a database.

FIGS. 6A-B shows a logic flow diagram illustrating examples of transforming historical virtual wallet fraud reports via a Statistical Risk Analysis (“SRA”) component into transaction risk assessment data and rules. FIG. 6A depicts a 3-dimensional risk parameter plot space, which may be utilized to extract fraud detection rules using aggregated fraud reports from individual users. For example, in FIG. 6A, each dot, e.g., 605, represents an individual instance of a fraudulent transaction reported by a user. In this example, the fraudulent transaction may be defined by a sales channel 603 through which it occurred, a transaction cost 602, and a merchant ID 601. It is to be understood, however, that any parameter of a current or prior transaction, user action, or event may be utilized as a parameter in an N-dimensional plot, where N may be as large as necessary to accurately represent the fraudulent or otherwise risky transactions. Example parameters may include, without limitation: user type, user ID, geographical region, issuer ID, merchant ID, account type, transaction cost, sales channel, product type, number of products, number of accounts used to pay for the transaction, terminal device type, transaction origination geo-political region, social messaging settings, privacy settings for the transaction, type of transaction (e.g., enrollment, purchase, etc.), in-store/online, prior user wallet activity, prior user purchases, real-time user behavior, recent price scans, etc.

In the example of FIG. 6A, the risk data points fall into four clusters 604a-d. Thus, the GSS may define four risk types—one associated with each of the clusters. The GSS may identify a boundary surface in the N-dimensional space (in FIG. 6A, N=3), and may generate an equation that defines the boundary surface. Thus, the boundary surface equation may serve as a rule to determine whether a transaction falls into a risk type defined by a cluster of risk data points. The number of data points within each cluster may serve as an indicator of the magnitude of risk associated with the risk cluster, e.g., a risk score weight. The GSS may normalize a risk score weight for a cluster/risk type (e.g., by dividing the number of risk data points in a cluster) by: a total number of risk data points, a total number of transaction (non-risky, as well as risky), a total number of non-risky transactions that would also fall within the boundary surface of the cluster, etc. Thus, the boundary surface equations and the risk score weights for each cluster/risk type may be utilized by the GSS to assess the risk of a current transaction.

Accordingly, with reference to FIG. 6B, in some embodiments, the GSS may obtain aggregated fraud (or other forms of risk) data reports for statistical analysis, e.g., 611. The GSS may select a fraud data report for processing, e.g., 612, and may parse the report to extract the data fields from the report, e.g., 613. The GSS may resolve the data fields from the fraud report into the parameters of the N-dimensional risk analysis plot parameters being used to plot the fraud reports as data points in the risk analysis, e.g., 614. The GSS may parse the report to extract the data values for each plot parameters, from the report, e.g., 615. Using the data values, the GSS may plot a data point reporesenting the fraud report within the N-dimensional risk analysis plot, e.g., 616. The GSS may plot a data point for each of the fraud reports in the aggregated fraud data reports, see 617. Upon completion of the plotting, the GSS may segment the N-dimensional parameter plot into clusters, e.g., 618, such as the clusters in the plot of FIG. 6A. The GSS may assign a risk type number (e.g., risk type 1, risk type 2, etc.) for each cluster in the risk analysis plot, e.g., 619. For each cluster, the GSS may identify an equation (e.g., a polynomial equation that results in a least mean square-error) that defines the boundary of the cluster, e.g., 620. The GSS may identify the parameters that appear as variables in the boundary surface equation, e.g., 621, such as, e.g., issuer routing number, user device type, etc. The GSS may correlate each of the identified parameters to entities involved in the transaction, so that these entities may be requested to either assume the risk of transactions having risk of these types, or request security data from these entities to mitigate the risk of these types of risk, e.g., 622. Also, the GSS may calculate a risk score weight for each risk type (i.e., each cluster) using, e.g., ratio of the number of data points within cluster to the total number of fraud data points; ratio of the number of data points within cluster to the number of transactions falling within boundary surface (both fraudulent and non-fraudulent); etc. The GSS may store the boundary surface equations and the risk score weights, as well as the identified entities that can either assume or mitigate the risk type, in a database.

FIG. 7 shows a logic flow diagram illustrating examples of transforming transaction requests, security inputs, historical wallet activity data, and transaction risk assessment data/rules via a Transaction Risk Assessment (“TRA”) component into transaction risk assessment type/score signals. In some embodiments, the GSS may obtain a current transaction request for a user associated with a virtual wallet account, e.g., 701. The GSS may identify all other transactions (current, recent or historical), as well as all user wallet activity (current, recent, or historical), matching the user, or the virtual wallet account, e.g., 702. The GSS may aggregate the identified data for analysis, e.g., 703. The GSS may also obtain transaction risk assessment rules for specific risk types and their associated risk score weights, e.g., 704. For example, the GSS may obtain such rules using components such as the example statistical rsk analysis (“SRA”) component of FIGS. 6A-B. The GSS may select a transaction risk assessment rule for processing, for a particular risk type, e.g., 705. The GSS may extract the boundary surface equation for the transaction risk assessment rule (see the discussion of FIGS. 6A-B), e.g., 706, and calculate a rule score by apply the aggregated data to the extracted boundary surface equation corresponding to the transaction risk assessment rule, e.g., 707. The GSS may determine whether the current transaction falls within the boundaries of the surface defining the cluster of risk data points representing transaction risk of a particular type within the N-dimensional risk analysis plot, e.g., 708. If the current transaction falls within the boundary surface of the cluster, e.g., 709, option “Yes,” then it may be suspectible to the same type of transaction risk. The GSS may assign the risk type number, and risk score weight associated with the transaction risk assessment rule, to the current transaction, e.g., 710. The GSS may perform such a procedure on the current transaction request for all transaction risk assessment rules, see 711. Upon completing the rule processing, the GSS may return the assigned risk types and their associated risk scores (e.g., for graduated security protocol escalation, see, e.g., FIG. 8).

FIG. 8 shows block and logic flow diagrams illustrating examples of transforming transaction risk type and score assessments, security data, and transaction risk allocation offer responses via a Graduated Security Escalation (“GSE”) component into transaction authorization notifications/triggers and transaction denial notifications. FIG. 8A shows an example security protocol stack 801, wherein each security protocol provides different amount of risk mitigation for different types of risk, if the security protocol is successfully completed. For example, each protocol may have a protocol description, 802, burden level indicator(s) (e.g., intrusiveness into user experience, response time, bandwidth requirements, etc.), 803, a list of risk types the security protocol may mitigate, 804, and an amount of the risk type that the security protocol is capable of mitigating upon successfully completion, 805. Example security protocols include, without limitation: obtaining a device IP address, obtaining a full device fingerprint, obtaining a user PIN from the user, obtaining a user password, providing a text message challenge, placing an audio call to the user, placing a video call to the user.

With reference to FIG. 8B, in some embodiments, the GSS may obtain a set of transaction risk types and associated transaction risk scores, e.g., 811. For example, the risk types and scores may be generated by a component such as the example Transaction Risk Assessment (“TRA”) component for FIG. 7. The GSS may select a risk type, risk score pair to attempt to mitigate, e.g., 812. The GSS may identify a set of candidiate entities who may be able to assume the risk, e.g., in exchange for consideration. For example, the GSS may provide an offer to one or more of the entities to assume (a portion of) the risk type associated with the transaction. For example, the GSS may offer a discount, rewards, incentive, bonus, future payout, reduced transaction fees, etc., in exchange for the entity assuming the risk specified in the offer. If any of the entities accept the offer to assume (a portion of) the risk type, then the GSS may recalculate the risk score associated with the risk type. For example, the user may be able to bear a risk that the merchant is fraudulent, in exchange for a discount on the purchase, or for a discount in payment processing fees for the payment network. As another example, the merchant may be able to bear the risk that the user is fraudulent, which may result in a refund request by the actual user at a later date. As an alternative, the payment network, issuer, or acquirer may be able to bear such risk.

In some embodiments, upon identifying a list of entities who may be able to bear the risk type, e.g., 813, the GSS may generate transaction risk allocation offers for the identified entities, e.g., 814. The GSS may provide the offers and obtain the responses from the solicited entities, e.g., 815. If the risk is accepted in its entirety (or to an amount sufficient for the GSS to continue the transaction), e.g., 816, option “Yes,” the GSS may move on to the next transaction risk to mitigate (see 827).

If the transaction risk is not assumed to a sufficient degree (e.g., as compared to a pre-defined maximum acceptable risk threshold value for the risk type in the current transaction, and stored in a database) by any of the solicited entities, e.g., 816, option “No,” the GSS may identify entities that can provide security data to mitigate risk. For example, a mobile merchant can provide seller digital certificate credentials to assure the GSS that the mobile merchant may be trusted in the transaction, and can be traced should any problems arise from the transaction in the future. As another example, a user suspected of being fraudulent may be asked to engage in any of the security protocols listed in FIG. 8A. The GSS may obtain, from a database, a pre-determined maximum acceptable threshold risk value for the risk type, as well as a list of security protocols, e.g., 818, available that, if completed successfully by the identified entities that can provide security data to mitigate the risk, would sufficiently mitigate the risk to continue transaction processing of the current transaction. The GSS may also obtain the associated security burdens and risk mitigation score capabilities of each of the identified security protocols, e.g., 819. In some embodiments, the GSS may identify the combination of security protocols (and associated entities that will have to engage the security protocols) that poses the minimum burden to a user experience, e.g., 82o. In alternate embodiments, the GSS may seek to minimize: the number of security protocols used, number of entities solicited for security data, security protocol processing time, security protocol processing overhead (e.g., cost, computational complexity), and/or the like.

The GSS may generate security data requests for the identified entities, e.g., 821, and obtain security data from the entities, e.g., 822. Using the security data, the GSS may calculate an updated risk score for the transaction risk type, e.g., 823. For example, the GSS may utilize a component such as the example Transaction Risk Assessment (“TRA”) component of FIG. 7. The GSS may compare the updated risk score to the predetermined maximum acceptable threshold risk value for the risk type in the current transaction, and determine whether the risk score has been lowered below the threshold. If the risk has been lowered enough, e.g., 824, option “Yes,” the GSS may move on to the next transaction risk to mitigate, see 827. If the risk score has not been lowered below the threshold, e.g., 824, option “No,” then the GSS may determine whether the number of security data requests, security protocol processing time, transaction authorization attempts, etc. have exceeded a predetermined value, e.g., 825. If the timeout has occurred, the GSS may generate a transaction denial notification, e.g., 826. Otherwise, the GSS may iteratively perform the above-mentioned procedure for the risk type, until the risk type is sufficiently mitigated (below the risk threshold), or the transaction is denied (see 813-826). The GSS may perform such a transaction risk allocation and graduated security protocol escalation procedure for each transaction risk type involved in the current transaction (see 827), until the transaction is either authorized, see 828, or denied, see 827.

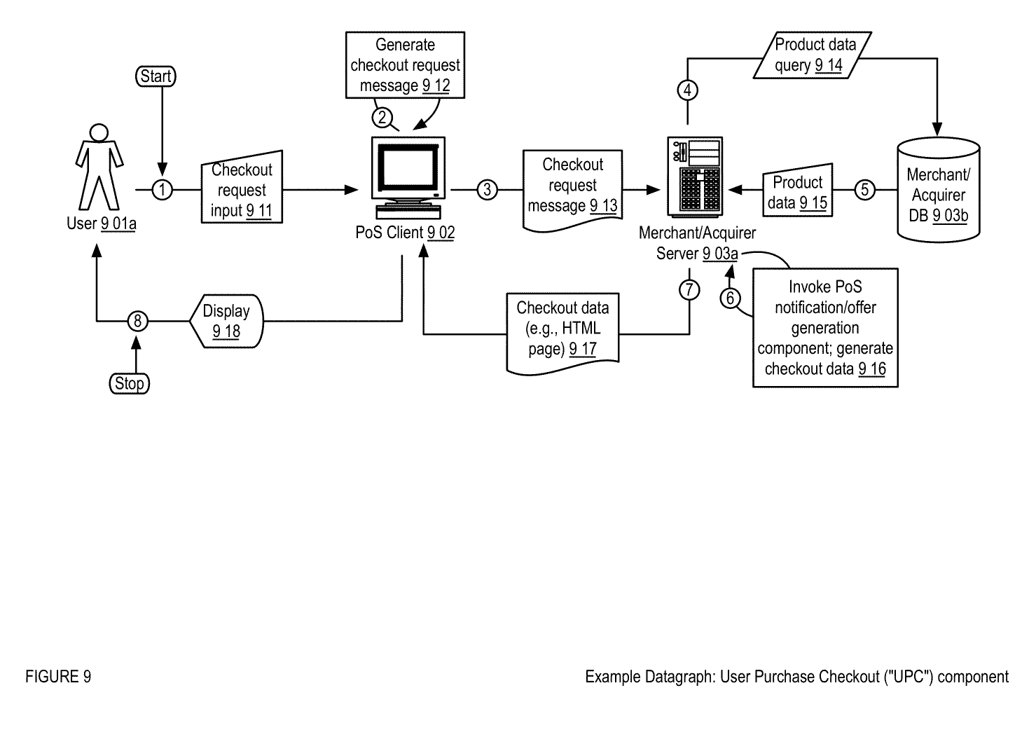

FIG. 9 shows a datagraph diagram illustrating example aspects of transforming a user checkout request input via a User Purchase Checkout (“UPC”) component into a checkout data display. In some embodiments, a user, e.g., 901a, may desire to purchase a product, service, offering, and/or the like (“product”), from a merchant via a merchant online site or in the merchant's store. The user may communicate with a merchant/acquirer (“merchant”) server, e.g., 903a, via a client such as, but not limited to: a personal computer, mobile device, television, point-of-sale terminal, kiosk, ATM, and/or the like (e.g., 902). For example, the user may provide user input, e.g., checkout input 911, into the client indicating the user's desire to purchase the product. In various embodiments, the user input may include, but not be limited to: a single tap (e.g., a one-tap mobile app purchasing embodiment) of a touchscreen interface, keyboard entry, card swipe, activating a RFID/NFC equipped hardware device (e.g., electronic card having multiple accounts, smartphone, tablet, etc.) within the user device, mouse clicks, depressing buttons on a joystick/game console, voice commands, single/multi-touch gestures on a touch-sensitive interface, touching user interface elements on a touch-sensitive display, and/or the like. As an example, a user in a merchant store may scan a product barcode of the product via a barcode scanner at a point-of-sale terminal. As another example, the user may select a product from a webpage catalog on the merchant's website, and add the product to a virtual shopping cart on the merchant's website. The user may then indicate the user's desire to checkout the items in the (virtual) shopping cart. For example, the user may activate a user interface element provided by the client to indicate the user's desire to complete the user purchase checkout. The client may generate a checkout request, e.g., 912, and provide the checkout request, e.g., 913, to the merchant server. For example, the client may provide a (Secure) Hypertext Transfer Protocol (“HTTP(S)”) POST message including the product details for the merchant server in the form of data formatted according to the eXtensible Markup Language (“XML”). An example listing of a checkout request 912, substantially in the form of a HTTP(S) POST message including XML-formatted data, is provided below:

POST /checkoutrequest.php HTTP/1.1
Host: www.merchant.com
Content-Type: Application/XML
Content-Length: 667
<?XML version = “1.0” encoding = “UTF-8”?>
<checkout_request>

<session_ID>4NFU4RG94</session_ID>

<!--optional parameters-->

<timestamp>2011-02-22 15:22:41</timestamp>
<user_ID>john.q.public@gmail.com</user_ID>
<device_fingerprint>

<device_IP>192.168.23.126</device_IP>
<device_MAC>0123.4567.89ab</device_MAC>
<device_serial>312456768798765432</device_serial>
<device_ECID>00000AEBCDF12345</device_ECID>
<device_identifier>jqp_air</device_identifier>
<device_UDID>21343e34-14f4-8jn4-7yfe-124578632134</device_UDID>
<device_browser>firefox 2.2</device_browser>
<device_type>smartphone</device_type>
<device_model>HTC Hero</device_model>
<OS>Android 2.2</OS>
<wallet_app_installed_flag>true</wallet_app_installed_flag>

</device_fingerprint>

</checkout_request>

In some embodiments, the merchant server may obtain the checkout request from the client, and extract the checkout detail (e.g., XML data) from the checkout request. For example, the merchant server may utilize a parser such as the example parsers described below in the discussion with reference to FIG. 23. Based on parsing the checkout request 912, the merchant server may extract product data (e.g., product identifiers), as well as available PoS client data, from the checkout request. In some embodiments, using the product data, the merchant server may query, e.g., 914, a merchant/acquirer (“merchant”) database, e.g., 903b, to obtain product data, e.g., 915, such as product information, product pricing, sales tax, offers, discounts, rewards, and/or other information to process the purchase transaction and/or provide value-added services for the user. For example, the merchant database may be a relational database responsive to Structured Query Language (“SQL”) commands. The merchant server may execute a hypertext preprocessor (“PHP”) script including SQL commands to query a database table (such as FIG. 23, Products 2319I) for product data. An example product data query 914, substantially in the form of PHP/SQL commands, is provided below:

<?PHP
header(′Content-Type: text/plain′);
mysql_connect(“254.93.179.112”,$DBserver,$password); // access
database server
mysql_select_db(“GSS_DB.SQL”); // select database table to search
//create query
$query = “SELECT product_title product_attributes_list product_price

tax_info_list related_products_list offers_list discounts_list
rewards_list
merchants_list merchant_availability_list FROM ProductsTable
WHERE
product_ID LIKE ′%′ $prodID”;

$result = mysql_query($query); // perform the search query
mysql_close(“GSS_DB.SQL”); // close database access
?>

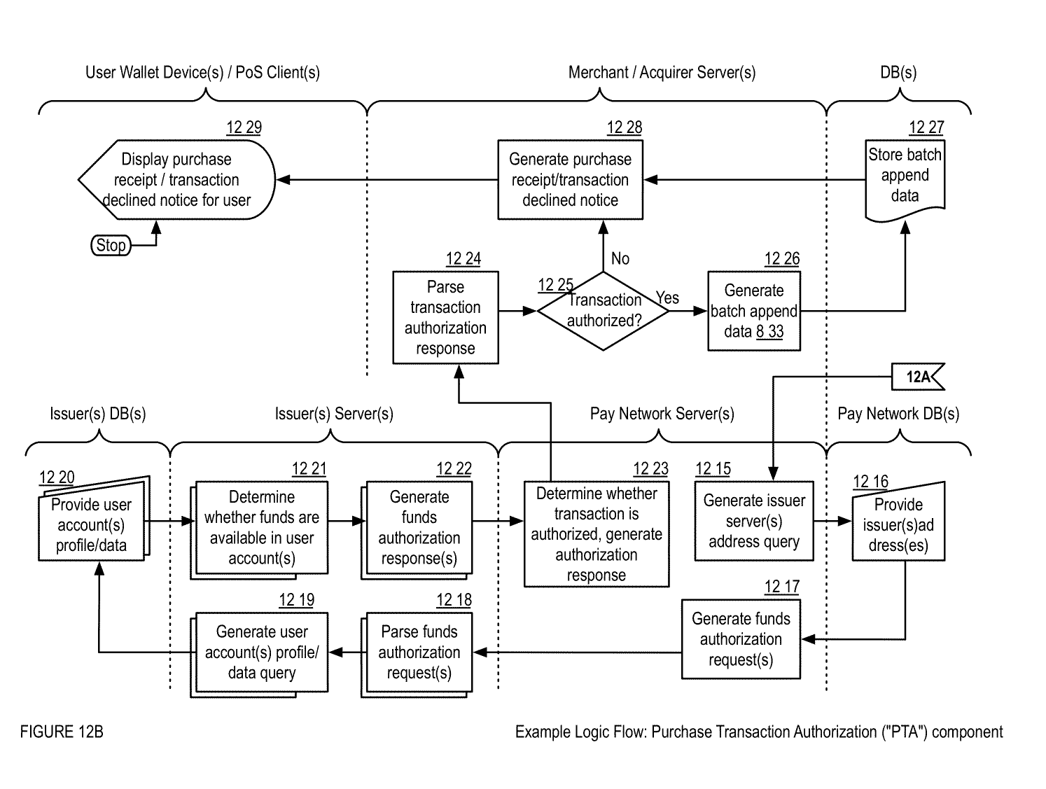

In some embodiments, in response to obtaining the product data, the merchant server may generate, e.g., 916, checkout data to provide for the PoS client. In some embodiments, such checkout data, e.g., 917, may be embodied, in part, in a HyperText Markup Language (“HTML”) page including data for display, such as product detail, product pricing, total pricing, tax information, shipping information, offers, discounts, rewards, value-added service information, etc., and input fields to provide payment information to process the purchase transaction, such as account holder name, account number, billing address, shipping address, tip amount, etc. In some embodiments, the checkout data may be embodied, in part, in a Quick Response (“QR”) code image that the PoS client can display, so that the user may capture the QR code using a user's device to obtain merchant and/or product data for generating a purchase transaction processing request. In some embodiments, a user alert mechanism may be built into the checkout data. For example, the merchant server may embed a URL specific to the transaction into the checkout data. In some embodiments, the alerts URL may further be embedded into optional level 3 data in card authorization requests, such as those discussed further below with reference to FIGS. 11-12. The URL may point to a webpage, data file, executable script, etc., stored on the merchant's server dedicated to the transaction that is the subject of the card authorization request. For example, the object pointed to by the URL may include details on the purchase transaction, e.g., products being purchased, purchase cost, time expiry, status of order processing, and/or the like. Thus, the merchant server may provide to the payment network the details of the transaction by passing the URL of the webpage to the payment network. In some embodiments, the payment network may provide notifications to the user, such as a payment receipt, transaction authorization confirmation message, shipping notification and/or the like. In such messages, the payment network may provide the URL to the user device. The user may navigate to the URL on the user's device to obtain alerts regarding the user's purchase, as well as other information such as offers, coupons, related products, rewards notifications, and/or the like. An example listing of a checkout data 917, substantially in the form of XML-formatted data, is provided below:

<?XML version = “1.0” encoding = “UTF-8”?>
<checkout_data>

<session_ID>4NFU4RG94</session_ID>
<!--optional data-->
<timestamp>2011-02-22 15:22:43</timestamp>
<expiry_lapse>00:00:30</expiry_lapse>
<total_cost>$121.49</total_cost>
<alerts_URL>www.merchant.com/shopcarts.php?sessionID=4NFU4RG94</alerts_URL>
<user_ID>john.q.public@gmail.com</user_ID>
<user_device_fingerprint>

<device_IP>192.168.23.126</device_IP>
<device_MAC>0123.4567.89ab</device_MAC>
<device_serial>312456768798765432</device_serial>
<device_ECID>00000AEBCDF12345</device_ECID>
<device_identifier>jqp_air</device_identifier>
<device_UDID>21343e34-14f4-8jn4-7yfe-124578632134</device_UDID>
<device_browser>firefox 2.2</device_browser>
<device_type>smartphone</device_type>
<device_model>HTC Hero</device_model>
<OS>Android 2.2</OS>
<wallet_app_installed_flag>true</wallet_app_installed_flag>

</user_device_fingerprint>
<purchase_detail>

<cart>

<product>

<merchant_params>

<merchant_id>54TBRELF8</merchant_id>
<merchant_name>BARNES, Inc.</merchant_name>
<merchant_auth_key>TMN45GER98</merchant_auth_key>

</merchant_params>
<product_type>book</product_type>
<product_params>

<product_title>XML for dummies</product_title>
<ISBN>938-2-14-168710-0</ISBN>
<edition>2nd ed.</edition>
<cover>hardbound</cover>

</product_params>
<quantity>2</quantity>
<unit_cost>$14.46</unit_cost>
<coupon_id>AY34567</coupon_id>

<social_flag>ON</social_flag>
<social_message>Look what I bought today!</social_message>
<social_networks>facebook twitter</social_networks>
</product>
<product>

<merchant_params>

<merchant_id>3FBCR4INC</merchant_id>
<merchant_name>Books, Inc.</merchant_name>
<merchant_auth_key>1N484MCP</merchant_auth_key>

</merchant_params>
<product_type>book</product_type>
<product_params>

<product_title>Sophie's World</product_title>
<ISBN>955-2-14-112310-0</ISBN>
<edition>NULL</edition>
<cover>hardbound</cover>

</product_params>
<quantity>1</quantity>
<unit_cost>$34.78</unit_cost>
<coupon_id>null</coupon_id>

<social_flag>OFF</social_flag>
</product>

</cart>
<cart>

<product>

<merchant_params>

<merchant_id>RFH5IB4FT</merchant_id>
<merchant_name>Amzn, Inc.</merchant_name>
<merchant_auth_key>44543DSJFG</merchant_auth_key>

</merchant_params>
<product_type>book</product_type>
<product_params>

<product_title>XML - a primer</product_title>
<ISBN>938-2-14-1436710-0</ISBN>
<edition>2nd ed.</edition>
<cover>hardbound</cover>

</product_params>
<quantity>1</quantity>
<unit_cost>$12.93</unit_cost>
<coupon_id>AY34567</coupon_id>

<social_flag>ON</social_flag>
<social_message>Look what I bought today!</social_message>
<social_networks>facebook twitter</social_networks>
</product>
<product>

<merchant_params>

<merchant_id>3FBCR4INC</merchant_id>
<merchant_name>BestBooks, Inc.</merchant_name>
<merchant_auth_key>1N484MCP</merchant_auth_key>

</merchant_params>
<product_type>book</product_type>
<product_params>

<product_title>Sophie's Choice</product_title>
<ISBN>938-2-14-168710-0</ISBN>
<edition>1st ed.</edition>

</product_params>
<quantity>1</quantity>
<unit_cost>$44.86</unit_cost>
<coupon_id>null</coupon_id>

<social_flag>OFF</social_flag>
</product>

</cart>

</purchase_detail>

<checkout_data>

Upon obtaining the checkout data, e.g., 917, the PoS client may render and display, e.g., 918, the checkout data for the user.

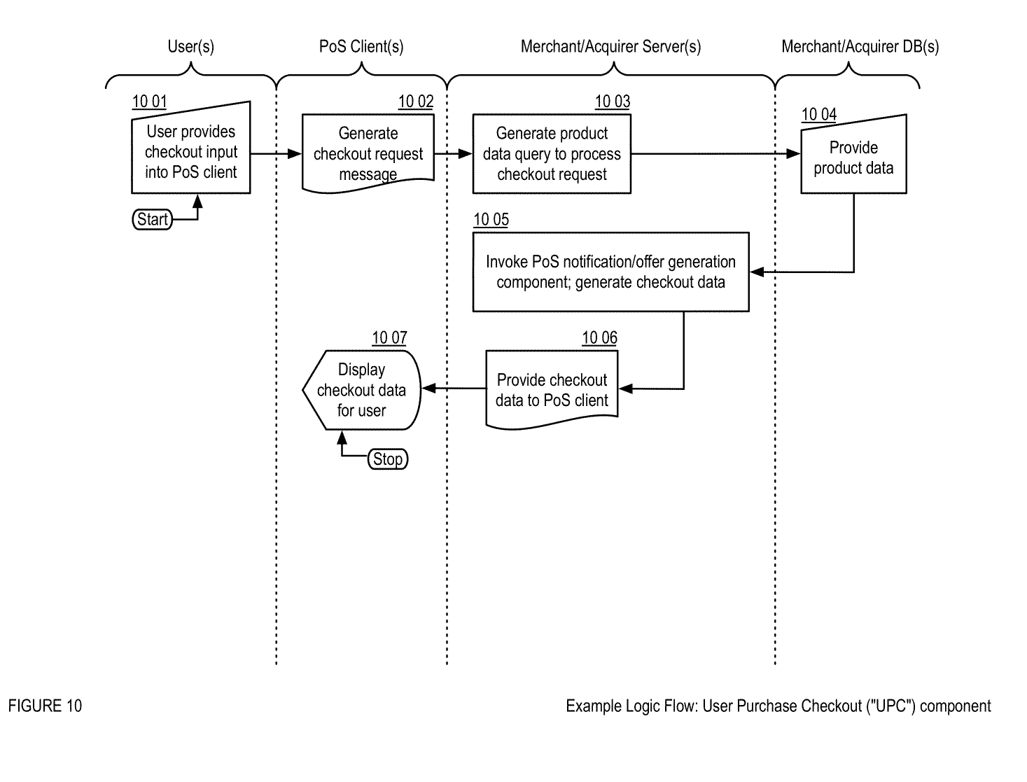

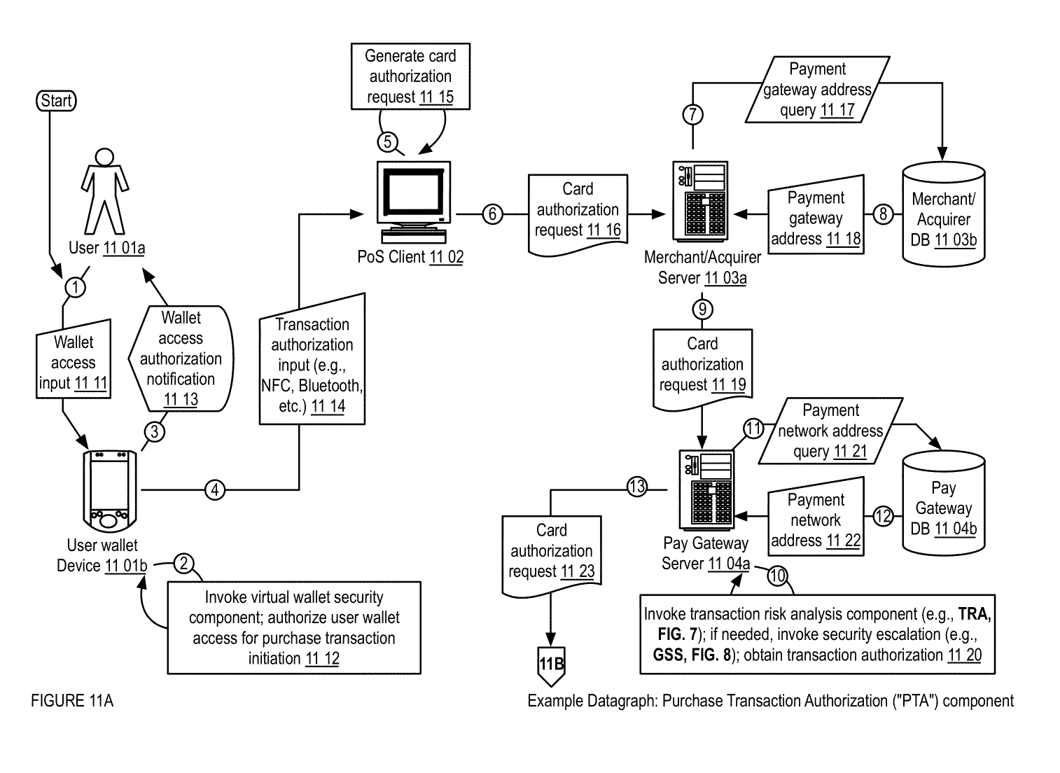

FIG. 10 shows a logic flow diagram illustrating example aspects of transforming a user checkout request input via a User Purchase Checkout (“UPC”) component into a checkout data display. In some embodiments, a user may desire to purchase a product, service, offering, and/or the like (“product”), from a merchant via a merchant online site or in the merchant's store. The user may communicate with a merchant/acquirer (“merchant”) server via a PoS client. For example, the user may provide user input, e.g., 1001, into the client indicating the user's desire to purchase the product. The client may generate a checkout request, e.g., 1002, and provide the checkout request to the merchant server. In some embodiments, the merchant server may obtain the checkout request from the client, and extract the checkout detail (e.g., XML data) from the checkout request. For example, the merchant server may utilize a parser such as the example parsers described below in the discussion with reference to FIG. 23. Based on parsing the checkout request, the merchant server may extract product data (e.g., product identifiers), as well as available PoS client data, from the checkout request. In some embodiments, using the product data, the merchant server may query, e.g., 1003, a merchant/acquirer (“merchant”) database to obtain product data, e.g., 1004, such as product information, product pricing, sales tax, offers, discounts, rewards, and/or other information to process the purchase transaction and/or provide value-added services for the user. In some embodiments, in response to obtaining the product data, the merchant server may generate, e.g., 1005, checkout data to provide, e.g., 1006, for the PoS client. Upon obtaining the checkout data, the PoS client may render and display, e.g., low, the checkout data for the user.

FIGS. 11A-B show datagraph diagrams illustrating example aspects of transforming a user virtual wallet access input via a Purchase Transaction Authorization (“PTA”) component into a purchase transaction receipt notification. With reference to FIG. 11A, in some embodiments, a user, e.g., nom, may wish to utilize a virtual wallet account to purchase a product, service, offering, and/or the like (“product”), from a merchant via a merchant online site or in the merchant's store. The user may utilize a physical card, or a user wallet device, e.g., limb, to access the user's virtual wallet account. For example, the user wallet device may be a personal/laptop computer, cellular telephone, smartphone, tablet, eBook reader, netbook, gaming console, and/or the like. The user may provide a wallet access input, e.g., 1111 into the user wallet device. In various embodiments, the user input may include, but not be limited to: a single tap (e.g., a one-tap mobile app purchasing embodiment) of a touchscreen interface, keyboard entry, card swipe, activating a RFID/NFC equipped hardware device (e.g., electronic card having multiple accounts, smartphone, tablet, etc.) within the user device, mouse clicks, depressing buttons on a joystick/game console, voice commands, single/multi-touch gestures on a touch-sensitive interface, touching user interface elements on a touch-sensitive display, and/or the like. In some embodiments, the user wallet device may authenticate the user based on the user's wallet access input, and provide virtual wallet features for the user.

In some embodiments, upon authenticating the user for access to virtual wallet features, the user wallet device may provide a transaction authorization input, e.g., 1114, to a point-of-sale (“PoS”) client, e.g., 1102. For example, the user wallet device may communicate with the PoS client via Bluetooth, Wi-Fi, cellular communication, one- or two-way near-field communication (“NFC”), and/or the like. In embodiments where the user utilizes a plastic card instead of the user wallet device, the user may swipe the plastic card at the PoS client to transfer information from the plastic card into the PoS client. For example, the PoS client may obtain, as transaction authorization input 1114, track 1 data from the user's plastic card (e.g., credit card, debit card, prepaid card, charge card, etc.), such as the example track 1 data provided below:

%B123456789012345\hat{ }PUBLIC/J.Q.\hat{ }99011200000000000000**901******?*
(wherein ‘123456789012345’ is the card number of ‘J.Q. Public’ and has a CVV

number of 901. ‘990112’ is a service code, and *** represents decimal digits
which change randomly each time the card is used.)

In embodiments where the user utilizes a user wallet device, the user wallet device may provide payment information to the PoS client, formatted according to a data formatting protocol appropriate to the communication mechanism employed in the communication between the user wallet device and the PoS client. An example listing of transaction authorization input 1114, substantially in the form of XML-formatted data, is provided below:

```
<?XML version = “1.0” encoding = “UTF-8”?>
<transaction_authorization_input>
  <payment_data>
      <account>
          <charge_priority>1</charge_priority>
          <charge_ratio>40%</charge_ratio>
          <account_type>debit</account_type>
          <value_exchange_symbol>USD</value_exchange_symbol>
          <account_number>123456789012345</account_number>
          <account_name>John Q. Public</account_name>
          <bill_add>987 Green St #456,  Chicago,  IL 94652</bill_add>
          <ship_add>987 Green St #456,  Chicago,  IL 94652</ship_add>
          <CVV_type>dynamic<CVV_type>
          <CVV>http://www.paynet.com/dcvv.php?sessionID=4NFU4RG94</CVV>
          <cloak_flag>ON</cloak_flag>
          <alert_rules>tar1 tar4 tar12</alert_rules>
          <mode>NFC</mode>
      </account>
      <account>
          <charge_priority>1</charge_priority>
          <charge_ratio>60%</charge_ratio>
          <account_type>rewards</account_type>
          <value_exchange_symbol>VME</value_exchange_symbol>
          <account_number>234567890123456</account_number>
          <account_name>John Q. Public</account_name>
          <bill_add>987 Green St #456,  Chicago,  IL 94652</bill_add>
          <ship_add>987 Green St #456,  Chicago,  IL 94652</ship_add>
          <CVV_type>static<CVV_type>
          <CVV>173</CVV>
          <cloak_flag>ON</cloak_flag>
          <alert_rules>tar1 tar4 tar12</alert_rules>
          <mode>Bluetooth</mode>
      </account>
      <account>
          <charge_priority>2</charge_priority>
          <charge_ratio>100%</charge_ratio>
          <account_number>345678901234567</account_number>
          <account_type>credit</account_type>
          <value_exchange_symbol>USD</value_exchange_symbol>
          <account_name>John Q. Public</account_name>
          <bill_add>987 Green St #456,  Chicago,  IL 94652</bill_add>
          <ship_add>987 Green St #456,  Chicago,  IL 94652</ship_add>
          <CVV_type>static<CVV_type>
          <CVV>173</CVV>
          <cloak_flag>ON</cloak_flag>
          <alert_rules>tar1 tar4 tar12</alert_rules>
          <mode>NFC</mode>
      </account>
  </payment_data>
  <!--optional data-->
  <timestamp>2011-02-22 15:22:43</timestamp>
  <expiry_lapse>00:00:30</expiry_lapse>
  <secure_key>0445329070598623487956543322</secure_key>
  <alerts_track_flag>TRUE</alerts_track_flag>
  <device_fingerprint>
      <device_IP>192.168.23.126</device_IP>
      <device_MAC>0123.4567.89ab</device_MAC>
      <device_serial>312456768798765432</device_serial>
      <device_ECID>00000AEBCDF12345</device_ECID>
      <device_identifier>jqp_air</device_identifier>
      <device_UDID>21343e34-14f4-8jn4-7yfe-124578632134</device_UDID>
      <device_browser>firefox 2.2</device_browser>
      <device_type>smartphone</device_type>
      <device_model>HTC Hero</device_model>
      <OS>Android 2.2</OS>
      <wallet_app_installed_flag>true</wallet_app_installed_flag>
  </device_fingerprint>
</transaction_authorization_input>
```

In some embodiments, the PoS client may generate a card authorization request, e.g., 1115, using the obtained transaction authorization input from the user wallet device, and/or product/checkout data (see, e.g., FIG. 9, 915-917). An example listing of a card authorization request 1115-1116, substantially in the form of a HTTP(S) POST message including XML-formatted data, is provided below:

```
POST /authorizationrequests.php HTTP/1.1
Host: www.acquirer.com
Content-Type: Application/XML
Content-Length: 1306
<?XML version = “1.0” encoding = “UTF-8”?>
<card_authorization_request>
  <session_ID>4NFU4RG94</order_ID>
  <!--optional data-->
  <timestamp>2011-02-22 15:22:43</timestamp>
  <expiry>00:00:30</expiry>
  <alerts_URL>www.merchant.com/shopcarts.php?sessionID=AEBB4356</alerts_URL>
  <user_ID>john.q.public@gmail.com</user_ID>
  <device_fingerprint>
      <device_IP>192.168.23.126</device_IP>
      <device_MAC>0123.4567.89ab</device_MAC>
      <device_serial>312456768798765432</device_serial>
      <device_ECID>00000AEBCDF12345</device_ECID>
      <device_identifier>jqp_air</device_identifier>
      <device_UDID>21343e34-14f4-8jn4-7yfe-124578632134</device_UDID>
      <device_browser>firefox 2.2</device_browser>
      <device_type>smartphone</device_type>
      <device_model>HTC Hero</device_model>
      <OS>Android 2.2</OS>
      <wallet_app_installed_flag>true</wallet_app_installed_flag>
  </device_fingerprint>
  <purchase_details>
      <total_cost>$121.49</total_cost>
      <cart>
          <product>
              <merchant_params>
                  <merchant_id>54TBRELF8</merchant_id>
                  <merchant_name>BARNES, Inc.</merchant_name>
                  <merchant_auth_key>TMN45GER98</merchant_auth_key>
              </merchant_params>
              <product_type>book</product_type>
              <product_params>
                  <product_title>XML for dummies</product_title>
                  <ISBN>938-2-14-168710-0</ISBN>
                  <edition>2nd ed.</edition>
                  <cover>hardbound</cover>
              </product_params>
              <quantity>2</quantity>
              <unit_cost>$14.46</unit_cost>
              <coupon_id>AY34567</coupon_id>
          <social_flag>ON</social_flag>
          <social_message>Look what I bought today!</social_message>
          <social_networks>facebook twitter</social_networks>
          </product>
          <product>
              <merchant_params>
                  <merchant_id>3FBCR4INC</merchant_id>
                  <merchant_name>Books, Inc.</merchant_name>
                  <merchant_auth_key>1N484MCP</merchant_auth_key>
              </merchant_params>
              <product_type>book</product_type>
              <product_params>
                  <product_title>Sophie's World</product_title>
                  <ISBN>955-2-14-112310-0</ISBN>
                  <edition>NULL</edition>
                  <cover>hardbound</cover>
              </product_params>
              <quantity>1</quantity>
              <unit_cost>$34.78</unit_cost>
              <coupon_id>null</coupon_id>
          <social_flag>OFF</social_flag>
          </product>
      </cart>
      <cart>
          <product>
              <merchant_params>
                  <merchant_id>RFH5IB4FT</merchant_id>
                  <merchant_name>Amzn, Inc.</merchant_name>
                  <merchant_auth_key>44543DSJFG</merchant_auth_key>
              </merchant_params>
              <product_type>book</product_type>
              <product_params>
                  <product_title>XML - a primer</product_title>
                  <ISBN>938-2-14-1436710-0</ISBN>
                  <edition>2nd ed.</edition>
                  <cover>hardbound</cover>
              </product_params>
              <quantity>1</quantity>
              <unit_cost>$12.93</unit_cost>
              <coupon_id>AY34567</coupon_id>
          <social_flag>ON</social_flag>
          <social_message>Look what I bought today!</social_message>
          <social_networks>facebook twitter</social_networks>
          </product>
          <product>
              <merchant_params>
                  <merchant_id>3FBCR4INC</merchant_id>
                  <merchant_name>BestBooks, Inc.</merchant_name>
                  <merchant_auth_key>1N484MCP</merchant_auth_key>
              </merchant_params>
              <product_type>book</product_type>
              <product_params>
                  <product_title>Sophie's Choice</product_title>
                  <ISBN>938-2-14-168710-0</ISBN>
                  <edition>1st ed.</edition>
              </product_params>
              <quantity>1</quantity>
              <unit_cost>$44.86</unit_cost>
              <coupon_id>null</coupon_id>
          <social_flag>OFF</social_flag>
          </product>
      </cart>
  </purchase_details>
  <account_params>
      <account>
          <charge_priority>1</charge_priority>
          <charge_ratio>40%</charge_ratio>
          <account_type>debit</account_type>
          <value_exchange_symbol>USD</value_exchange_symbol>
          <account_number>123456789012345</account_number>
          <account_name>John Q. Public</account_name>
          <bill_add>987 Green St #456,  Chicago,  IL 94652</bill_add>
          <ship_add>987 Green St #456,  Chicago,  IL 94652</ship_add>
          <CVV_type>dynamic<CVV_type>
          <CVV>http://www.paynet.com/dcvv.php?sessionID=4NFU4RG94</CVV>
          <cloak_flag>ON</cloak_flag>
          <alert_rules>tar1 tar4 tar12</alert_rules>
          <mode>NFC</mode>
      </account>
      <account>
          <charge_priority>1</charge_priority>
          <charge_ratio>60%</charge_ratio>
          <account_type>rewards</account_type>
          <value_exchange_symbol>VME</value_exchange_symbol>
          <account_number>234567890123456</account_number>
          <account_name>John Q. Public</account_name>
          <bill_add>987 Green St #456,  Chicago,  IL 94652</bill_add>
          <ship_add>987 Green St #456,  Chicago,  IL 94652</ship_add>
          <CVV_type>static<CVV_type>
          <CVV>173</CVV>
          <cloak_flag>ON</cloak_flag>
          <alert_rules>tar1 tar4 tar12</alert_rules>
          <mode>Bluetooth</mode>
      </account>
      <account>
          <charge_priority>2</charge_priority>
          <charge_ratio>100%</charge_ratio>
          <account_number>345678901234567</account_number>
          <account_type>credit</account_type>
          <value_exchange_symbol>USD</value_exchange_symbol>
          <account_name>John Q. Public</account_name>
          <bill_add>987 Green St #456,  Chicago,  IL 94652</bill_add>
          <ship_add>987 Green St #456,  Chicago,  IL 94652</ship_add>
          <CVV_type>static<CVV_type>
          <CVV>173</CVV>
          <cloak_flag>ON</cloak_flag>
          <alert_rules>tar1 tar4 tar12</alert_rules>
          <mode>NFC</mode>
      </account>
  </account_params>
  <shipping_info>
      <shipping_adress>#ref-ANON-123-45-678</shipping_address>
      <ship_type>expedited</ship_type>
      <ship_carrier>FedEx</ship_carrier>
      <ship_account>ANON-123-45-678</ship_account>
      <tracking_flag>true</tracking_flag>
      <sign_flag>false</sign_flag>
  </shipping_info>
</card_authorization_request>
```

In some embodiments, the card authorization request generated by the user device may include a minimum of information required to process the purchase transaction. For example, this may improve the efficiency of communicating the purchase transaction request, and may also advantageously improve the privacy protections provided to the user and/or merchant. For example, in some embodiments, the card authorization request may include at least a session ID for the user's shopping session with the merchant. The session ID may be utilized by any component and/or entity having the appropriate access authority to access a secure site on the merchant server to obtain alerts, reminders, and/or other data about the transaction(s) within that shopping session between the user and the merchant. In some embodiments, the PoS client may provide the generated card authorization request to the merchant server, e.g., 1116. The merchant server may forward the card authorization request to a pay gateway server, e.g., 1104a, for routing the card authorization request to the appropriate payment network for payment processing. For example, the pay gateway server may be able to select from payment networks, such as Visa, Mastercard, American Express, Paypal, etc., to process various types of transactions including, but not limited to: credit card, debit card, prepaid card, B2B and/or like transactions. In some embodiments, the merchant server may query a database, e.g., merchant/acquirer database 1103b, for a network address of the payment gateway server, for example by using a portion of a user payment card number, or a user ID (such as an email address) as a keyword for the database query. For example, the merchant server may issue PHP/SQL commands to query a database table (such as FIG. 23, Pay Gateways 2319h) for a URL of the pay gateway server. An example payment gateway address query 1117, substantially in the form of PHP/SQL commands, is provided below:

```
<?PHP
header(‘Content-Type: text/plain’);
mysql_connect(“254.93.179.112”,$DBserver,$password); // access
database server
mysql_select_db(“GSS_DB.SQL”); // select database table to search
//create query
$query = “SELECT paygate_id paygate_address paygate_URL
  paygate_name FROM PayGatewayTable WHERE
  card_num LIKE ‘%’ $cardnum”;
$result = mysql_query($query); // perform the search query
mysql_close(“GSS_DB.SQL”); // close database access
?>
```

In response, the merchant/acquirer database may provide the requested payment gateway address, e.g., 1118. The merchant server may forward the card authorization request to the pay gateway server using the provided address, e.g., 1119. In some embodiments, upon receiving the card authorization request from the merchant server, the pay gateway server may invoke a component to provide one or more services associated with purchase transaction authorization. For example, the pay gateway server may invoke components for fraud prevention, loyalty and/or rewards, and/or other services for which the user-merchant combination is authorized. The pay gateway server may forward the card authorization request to a pay network server, e.g., 1105a, for payment processing. For example, the pay gateway server may be able to select from payment networks, such as Visa, Mastercard, American Express, Paypal, etc., to process various types of transactions including, but not limited to: credit card, debit card, prepaid card, B2B and/or like transactions. In some embodiments, the pay gateway server may query a database, e.g., pay gateway database 1104b, for a network address of the payment network server, for example by using a portion of a user payment card number, or a user ID (such as an email address) as a keyword for the database query. For example, the pay gateway server may issue PHP/SQL commands to query a database table (such as FIG. 23, Pay Gateways 2319h) for a URL of the pay network server. An example payment network address query 1121, substantially in the form of PHP/SQL commands, is provided below:

```
<?PHP
header(‘Content-Type: text/plain’);
mysql_connect(“254.93.179.112”,$DBserver,$password); // access
database server
mysql_select_db(“GSS_DB.SQL”); // select database table to search
//create query
$query = “SELECT payNET_id payNET_address payNET_URL
  payNET_name FROM PayGatewayTable WHERE
  card_num LIKE ‘%’ $cardnum”;
$result = mysql_query($query); // perform the search query
mysql_close(“GSS_DB.SQL”); // close database access
?>
```

In response, the payment gateway database may provide the requested payment network address, e.g., 1122. The pay gateway server may forward the card authorization request to the pay network server using the provided address, e.g., 1123.

With reference to FIG. 11B, in some embodiments, the pay network server may process the transaction so as to transfer funds for the purchase into an account stored on an acquirer of the merchant. For example, the acquirer may be a financial institution maintaining an account of the merchant. For example, the proceeds of transactions processed by the merchant may be deposited into an account maintained by at a server of the acquirer.

In some embodiments, the pay network server may generate a query, e.g., 1124, for issuer server(s) corresponding to the user-selected payment options. For example, the user's account may be linked to one or more issuer financial institutions (“issuers”), such as banking institutions, which issued the account(s) for the user. For example, such accounts may include, but not be limited to: credit card, debit card, prepaid card, checking, savings, money market, certificates of deposit, stored (cash) value accounts and/or the like. Issuer server(s), e.g., 1106a, of the issuer(s) may maintain details of the user's account(s). In some embodiments, a database, e.g., pay network database 1105b, may store details of the issuer server(s) associated with the issuer(s). In some embodiments, the pay network server may query a database, e.g., pay network database 1105b, for a network address of the issuer(s) server(s), for example by using a portion of a user payment card number, or a user ID (such as an email address) as a keyword for the database query. For example, the merchant server may issue PHP/SQL commands to query a database table (such as FIG. 23, Issuers 23190 for network address(es) of the issuer(s) server(s). An example issuer server address(es) query 1124, substantially in the form of PHP/SQL commands, is provided below:

```
<?PHP
header(‘Content-Type: text/plain’);
mysql_connect(“254.93.179.112”,$DBserver,$password); // access
database server
mysql_select_db(“GSS_DB.SQL”); // select database table to search
//create query
$query = “SELECT issuer_id issuer_address issuer_URL
  issuer_name FROM IssuersTable WHERE card_num
  LIKE ‘%’ $cardnum”;
$result = mysql_query($query); // perform the search query
mysql_close(“GSS_DB.SQL”); // close database access
?>
```

In response to obtaining the issuer server query, e.g., 1124, the pay network database may provide, e.g., 1125, the requested issuer server data to the pay network server. In some embodiments, the pay network server may utilize the issuer server data to generate funds authorization request(s), e.g., 1126, for each of the issuer server(s) selected based on the pre-defined payment settings associated with the user's virtual wallet, and/or the user's payment options input, and provide the funds authorization request(s) to the issuer server(s). In some embodiments, the funds authorization request(s) may include details such as, but not limited to: the costs to the user involved in the transaction, card account details of the user, user billing and/or shipping information, and/or the like. An example listing of a funds authorization request 1126, substantially in the form of a HTTP(S) POST message including XML-formatted data, is provided below:

```
POST /fundsauthorizationrequest.php HTTP/1.1
Host: www.issuer.com
Content-Type: Application/XML
Content-Length: 624
<?XML version = “1.0” encoding = “UTF-8”?>
<funds_authorization_request>
    <request_ID>VNEI39FK</request_ID>
    <timestamp>2011-02-22 15:22:44</timestamp>
    <debit_amount>$72.89</debit_amount>
    <account_params>
        <account>
            <account_type>debit</account_type>
            <value_exchange_symbol>USD</value_exchange_symbol>
            <account_number>123456789012345</account_number>
            <account_name>John Q. Public</account_name>
            <bill_add>987 Green St #456,  Chicago,  IL 94652</bill_add>
            <ship_add>987 Green St #456,  Chicago,  IL 94652</ship_add>
            <CVV>1234</CVV>
        </account>
    </account_params>
    <!--optional parameters-->
    <user_device_fingerprint>
        <device_IP>192.168.23.126</device_IP>
        <device_MAC>0123.4567.89ab</device_MAC>
        <device_serial>312456768798765432</device_serial>
        <device_ECID>00000AEBCDF12345</device_ECID>
        <device_identifier>jqp_air</device_identifier>
        <device_UDID>21343e34-14f4-8jn4-7yfe-124578632134</device_UDID>
        <device_browser>firefox 2.2</device_browser>
        <device_type>smartphone</device_type>
        <device_model>HTC Hero</device_model>
        <OS>Android 2.2</OS>
        <wallet_app_installed_flag>true</wallet_app_installed_flag>
    </user_device_fingerprint>
</funds_authorization_request>
```

In some embodiments, an issuer server may parse the authorization request(s), and based on the request details may query a database, e.g., user profile database 1106b, for data associated with an account linked to the user. For example, the merchant server may issue PHP/SQL commands to query a database table (such as FIG. 23, Accounts 2319d) for user account(s) data. An example user account(s) query 1127, substantially in the form of PHP/SQL commands, is provided below:

```
<?PHP
header(‘Content-Type: text/plain’);
mysql_connect(“254.93.179.112”,$DBserver,$password); // access
database server
mysql_select_db(“GSS_DB.SQL”); // select database table to search
//create query
$query = “SELECT issuer user_id user_name user_balance
  account_type FROM AccountsTable WHERE account_num
  LIKE ‘%’ $accountnum”;
$result = mysql_query($query); // perform the search query
mysql_close(“GSS_DB.SQL”); // close database access
?>
```

In some embodiments, on obtaining the user account(s) data, e.g., 1128, the issuer server may determine whether the user can pay for the transaction using funds available in the account, 1129. For example, the issuer server may determine whether the user has a sufficient balance remaining in the account, sufficient credit associated with the account, and/or the like. Based on the determination, the issuer server(s) may provide a funds authorization response, e.g., 113o, to the pay network server. For example, the issuer server(s) may provide a HTTP(S) POST message similar to the examples above. In some embodiments, if at least one issuer server determines that the user cannot pay for the transaction using the funds available in the account, the pay network server may request payment options again from the user (e.g., by providing an authorization fail message to the user device and requesting the user device to provide new payment options), and re-attempt authorization for the purchase transaction. In some embodiments, if the number of failed authorization attempts exceeds a threshold, the pay network server may abort the authorization process, and provide an “authorization fail” message to the merchant server, user device and/or client.

In some embodiments, the pay network server may obtain the funds authorization response including a notification of successful authorization, and parse the message to extract authorization details. Upon determining that the user possesses sufficient funds for the transaction, e.g., 1131, the pay network server may invoke a component to provide value-add services for the user.

In some embodiments, the pay network server may generate a transaction data record from the authorization request and/or authorization response, and store the details of the transaction and authorization relating to the transaction in a transactions database. For example, the pay network server may issue PHP/SQL commands to store the data to a database table (such as FIG. 23, Transactions 2319i). An example transaction store command, substantially in the form of PHP/SQL commands, is provided below:

```
<?PHP
header(‘Content-Type: text/plain’);
mysql_connect(“254.92.185.103”,$DBserver,$password); // access database server
mysql_select(“GSS_DB.SQL”); // select database to append
mysql_query(“INSERT INTO TransactionsTable (PurchasesTable (timestamp,
  purchase_summary_list, num_products, product_summary, product_quantity,
  transaction_cost, account_params_list, account_name, account_type,
  account_num, billing_addres, zipcode, phone, sign, merchant_params_list,
  merchant_id, merchant_name, merchant_auth_key)
VALUES (time( ), $purchase_summary_list, $num_products, $product_summary,
  $product_quantity, $transaction_cost, $account_params_list, $account_name,
  $account_type, $account_num, $billing_addres, $zipcode, $phone, $sign,
  $merchant_params_list, $merchant_id, $merchant_name, $merchant_auth_key)”);
  // add data to table in database
mysql_close(“GSS_DB.SQL”); // close connection to database
?>
```

In some embodiments, the pay network server may forward a transaction authorization response, e.g., 1132, to the user wallet device, PoS client, and/or merchant server. The merchant may obtain the transaction authorization response, and determine from it that the user possesses sufficient funds in the card account to conduct the transaction. The merchant server may add a record of the transaction for the user to a batch of transaction data relating to authorized transactions. For example, the merchant may append the XML data pertaining to the user transaction to an XML data file comprising XML data for transactions that have been authorized for various users, e.g., 1133, and store the XML data file, e.g., 1134, in a database, e.g., merchant database 404. For example, a batch XML data file may be structured similar to the example XML data structure template provided below:

```
<?XML version = “1.0” encoding = “UTF-8”?>
<merchant_data>
  <merchant_id>3FBCR4INC</merchant_id>
  <merchant_name>Books & Things, Inc.</merchant_name>
  <merchant_auth_key>1NNF484MCF59CHB27365
  </merchant_auth_key>
  <account_number>123456789</account_number>
</merchant_data>
<transaction_data>
  <transaction 1>
        ...
  </transaction 1>
  <transaction 2>
        ...
  </transaction 2>
        .
        .
        .
  <transaction n>
        ...
  </transaction n>
</transaction_data>
```

In some embodiments, the server may also generate a purchase receipt, e.g., 1133, and provide the purchase receipt to the client, e.g., 1135. The client may render and display, e.g., 1136, the purchase receipt for the user. In some embodiments, the user's wallet device may also provide a notification of successful authorization to the user. For example, the PoS client/user device may render a webpage, electronic message, text/SMS message, buffer a voicemail, emit a ring tone, and/or play an audio message, etc., and provide output including, but not limited to: sounds, music, audio, video, images, tactile feedback, vibration alerts (e.g., on vibration-capable client devices such as a smartphone etc.), and/or the like.

FIGS. 12A-B show logic flow diagrams illustrating example aspects of transforming a user virtual wallet access input via a Purchase Transaction Authorization (“PTA”) component into a purchase transaction receipt notification. With reference to FIG. 12A, in some embodiments, a user may wish to utilize a virtual wallet account to purchase a product, service, offering, and/or the like (“product”), from a merchant via a merchant online site or in the merchant's store. The user may utilize a physical card, or a user wallet device to access the user's virtual wallet account. For example, the user wallet device may be a personal/laptop computer, cellular telephone, smartphone, tablet, eBook reader, netbook, gaming console, and/or the like. The user may provide a wallet access input, e.g., 1201, into the user wallet device. In various embodiments, the user input may include, but not be limited to: a single tap (e.g., a one-tap mobile app purchasing embodiment) of a touchscreen interface, keyboard entry, card swipe, activating a RFID/NFC equipped hardware device (e.g., electronic card having multiple accounts, smartphone, tablet, etc.) within the user device, mouse clicks, depressing buttons on a joystick/game console, voice commands, single/multi-touch gestures on a touch-sensitive interface, touching user interface elements on a touch-sensitive display, and/or the like. In some embodiments, the user wallet device may authenticate the user based on the user's wallet access input, and provide virtual wallet features for the user, e.g., 1202-1203.

In some embodiments, upon authenticating the user for access to virtual wallet features, the user wallet device may provide a transaction authorization input, e.g., 1204, to a point-of-sale (“PoS”) client. For example, the user wallet device may communicate with the PoS client via Bluetooth, Wi-Fi, cellular communication, one- or two-way near-field communication (“NFC”), and/or the like. In embodiments where the user utilizes a plastic card instead of the user wallet device, the user may swipe the plastic card at the PoS client to transfer information from the plastic card into the PoS client. In embodiments where the user utilizes a user wallet device, the user wallet device may provide payment information to the PoS client, formatted according to a data formatting protocol appropriate to the communication mechanism employed in the communication between the user wallet device and the PoS client.

In some embodiments, the PoS client may obtain the transaction authorization input, and parse the input to extract payment information from the transaction authorization input, e.g., 1205. For example, the PoS client may utilize a parser, such as the example parsers provided below in the discussion with reference to FIG. 23. The PoS client may generate a card authorization request, e.g., 1206, using the obtained transaction authorization input from the user wallet device, and/or product/checkout data (see, e.g., FIG. 9, 915-917).

In some embodiments, the PoS client may provide the generated card authorization request to the merchant server. The merchant server may forward the card authorization request to a pay gateway server, for routing the card authorization request to the appropriate payment network for payment processing. For example, the pay gateway server may be able to select from payment networks, such as Visa, Mastercard, American Express, Paypal, etc., to process various types of transactions including, but not limited to: credit card, debit card, prepaid card, B2B and/or like transactions. In some embodiments, the merchant server may query a database, e.g., 1208, for a network address of the payment gateway server, for example by using a portion of a user payment card number, or a user ID (such as an email address) as a keyword for the database query. In response, the merchant/acquirer database may provide the requested payment gateway address, e.g., 1210. The merchant server may forward the card authorization request to the pay gateway server using the provided address. In some embodiments, upon receiving the card authorization request from the merchant server, the pay gateway server may invoke a component to provide one or more service associated with purchase transaction authorization, e.g., 1211. For example, the pay gateway server may invoke components for fraud prevention (see e.g., VerifyChat, FIG. 3E), loyalty and/or rewards, and/or other services for which the user-merchant combination is authorized.

The pay gateway server may forward the card authorization request to a pay network server for payment processing, e.g., 1214. For example, the pay gateway server may be able to select from payment networks, such as Visa, Mastercard, American Express, Paypal, etc., to process various types of transactions including, but not limited to: credit card, debit card, prepaid card, B2B and/or like transactions. In some embodiments, the pay gateway server may query a database, e.g., 1212, for a network address of the payment network server, for example by using a portion of a user payment card number, or a user ID (such as an email address) as a keyword for the database query. In response, the payment gateway database may provide the requested payment network address, e.g., 1213. The pay gateway server may forward the card authorization request to the pay network server using the provided address, e.g., 1214.

With reference to FIG. 12B, in some embodiments, the pay network server may process the transaction so as to transfer funds for the purchase into an account stored on an acquirer of the merchant. For example, the acquirer may be a financial institution maintaining an account of the merchant. For example, the proceeds of transactions processed by the merchant may be deposited into an account maintained by at a server of the acquirer. In some embodiments, the pay network server may generate a query, e.g., 1215, for issuer server(s) corresponding to the user-selected payment options. For example, the user's account may be linked to one or more issuer financial institutions (“issuers”), such as banking institutions, which issued the account(s) for the user. For example, such accounts may include, but not be limited to: credit card, debit card, prepaid card, checking, savings, money market, certificates of deposit, stored (cash) value accounts and/or the like. Issuer server(s) of the issuer(s) may maintain details of the user's account(s). In some embodiments, a database, e.g., a pay network database, may store details of the issuer server(s) associated with the issuer(s). In some embodiments, the pay network server may query a database, e.g., 1215, for a network address of the issuer(s) server(s), for example by using a portion of a user payment card number, or a user ID (such as an email address) as a keyword for the database query.

In response to obtaining the issuer server query, the pay network database may provide, e.g., 1216, the requested issuer server data to the pay network server. In some embodiments, the pay network server may utilize the issuer server data to generate funds authorization request(s), e.g., 1217, for each of the issuer server(s) selected based on the pre-defined payment settings associated with the user's virtual wallet, and/or the user's payment options input, and provide the funds authorization request(s) to the issuer server(s). In some embodiments, the funds authorization request(s) may include details such as, but not limited to: the costs to the user involved in the transaction, card account details of the user, user billing and/or shipping information, and/or the like. In some embodiments, an issuer server may parse the authorization request(s), e.g., 1218, and based on the request details may query a database, e.g., 1219, for data associated with an account linked to the user.

In some embodiments, on obtaining the user account(s) data, e.g., 1220, the issuer server may determine whether the user can pay for the transaction using funds available in the account, e.g., 1221. For example, the issuer server may determine whether the user has a sufficient balance remaining in the account, sufficient credit associated with the account, and/or the like. Based on the determination, the issuer server(s) may provide a funds authorization response, e.g., 1222, to the pay network server. In some embodiments, if at least one issuer server determines that the user cannot pay for the transaction using the funds available in the account, the pay network server may request payment options again from the user (e.g., by providing an authorization fail message to the user device and requesting the user device to provide new payment options), and re-attempt authorization for the purchase transaction. In some embodiments, if the number of failed authorization attempts exceeds a threshold, the pay network server may abort the authorization process, and provide an “authorization fail” message to the merchant server, user device and/or client.

In some embodiments, the pay network server may obtain the funds authorization response including a notification of successful authorization, and parse the message to extract authorization details. Upon determining that the user possesses sufficient funds for the transaction, e.g., 1223, the pay network server may invoke a component to provide value-add services for the user, e.g., 1223.

In some embodiments, the pay network server may forward a transaction authorization response to the user wallet device, PoS client, and/or merchant server. The merchant may parse, e.g., 1224, the transaction authorization response, and determine from it that the user possesses sufficient funds in the card account to conduct the transaction, e.g., 1225, option“Yes.” The merchant server may add a record of the transaction for the user to a batch of transaction data relating to authorized transactions. For example, the merchant may append the XML data pertaining to the user transaction to an XML data file comprising XML data for transactions that have been authorized for various users, e.g., 1226, and store the XML data file, e.g., 1227, in a database. In some embodiments, the server may also generate a purchase receipt, e.g., 1228, and provide the purchase receipt to the client. The client may render and display, e.g., 1229, the purchase receipt for the user. In some embodiments, the user's wallet device may also provide a notification of successful authorization to the user. For example, the PoS client/user device may render a webpage, electronic message, text/SMS message, buffer a voicemail, emit a ring tone, and/or play an audio message, etc., and provide output including, but not limited to: sounds, music, audio, video, images, tactile feedback, vibration alerts (e.g., on vibration-capable client devices such as a smartphone etc.), and/or the like.

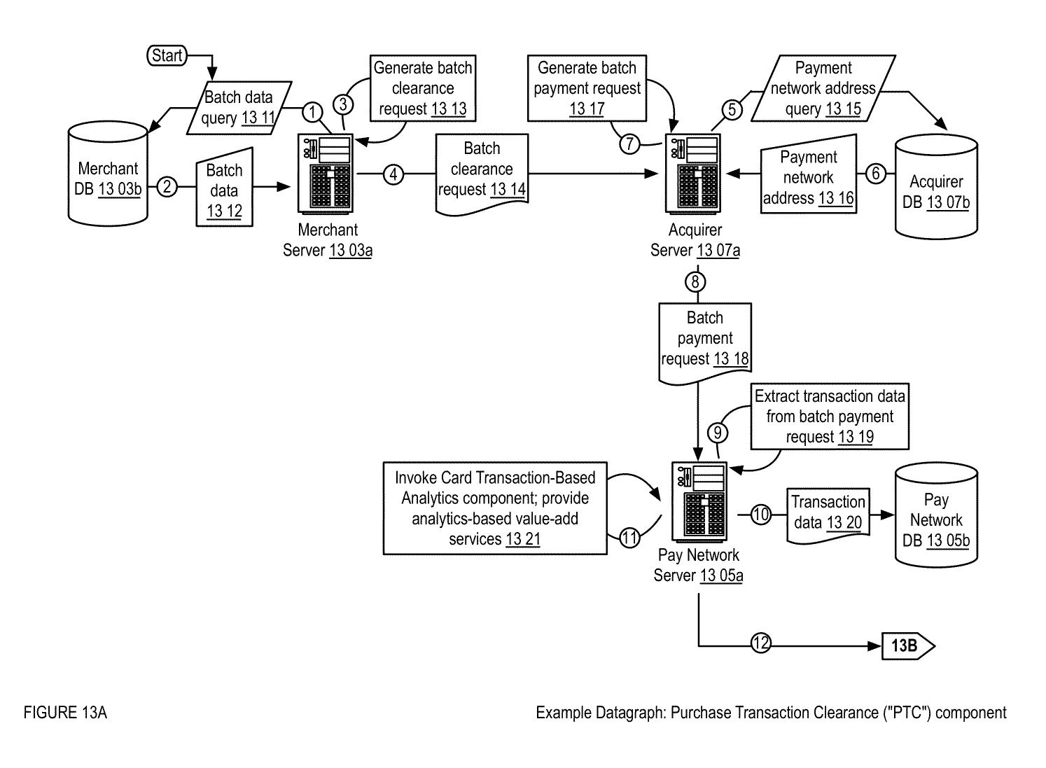

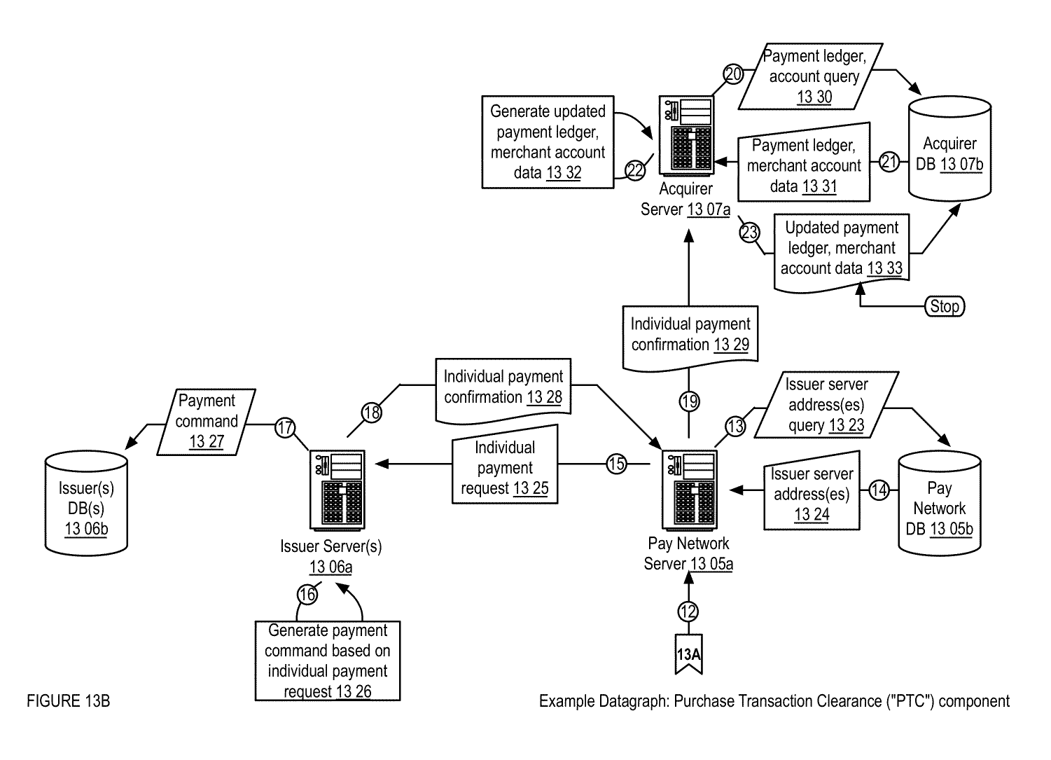

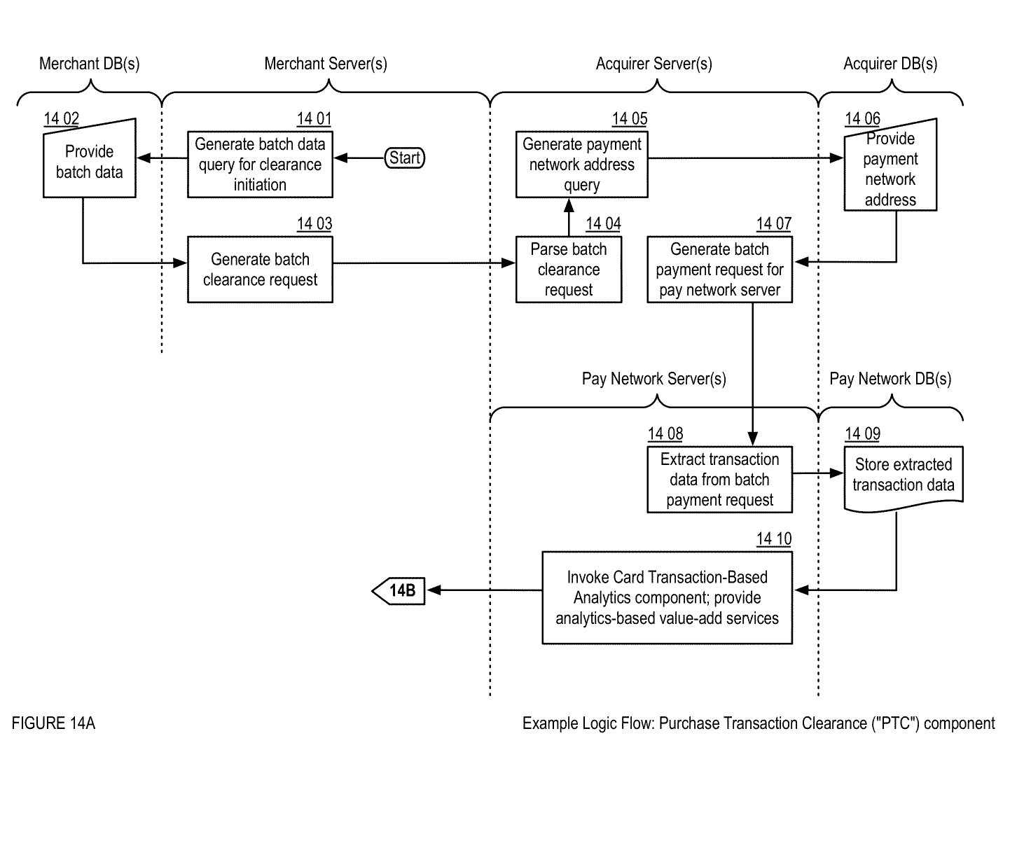

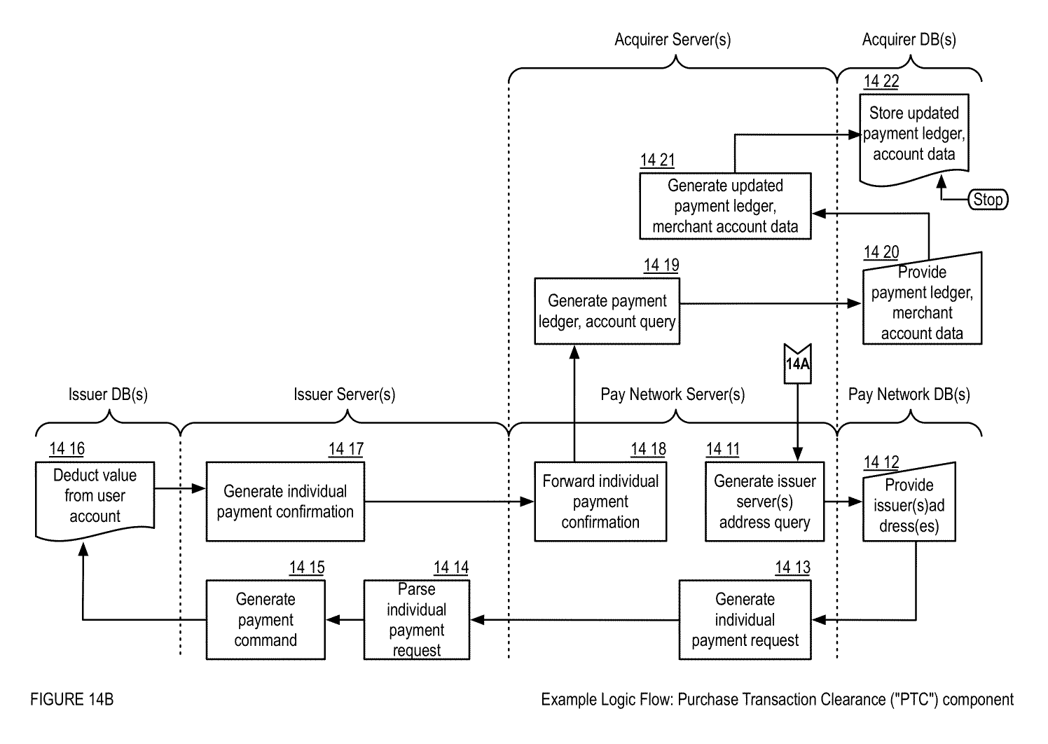

FIGS. 13A-B show data flow diagrams illustrating example aspects of transforming a merchant transaction batch data query via a Purchase Transaction Clearance (“PTC”) component into an updated payment ledger record. With reference to FIG. 13A, in some embodiments, a merchant server, e.g., 1303a, may initiate clearance of a batch of authorized transactions. For example, the merchant server may generate a batch data request, e.g., 1311, and provide the request, to a merchant database, e.g., 1303b. For example, the merchant server may utilize PHP/SQL commands similar to the examples provided above to query a relational database. In response to the batch data request, the database may provide the requested batch data, e.g., 1312. The server may generate a batch clearance request, e.g., 1313, using the batch data obtained from the database, and provide, e.g., 1314, the batch clearance request to an acquirer server, e.g., 1307a. For example, the merchant server may provide a HTTP(S) POST message including XML-formatted batch data in the message body for the acquirer server. The acquirer server may generate, e.g., 1315, a batch payment request using the obtained batch clearance request, and provide, e.g., 1318, the batch payment request to the pay network server, e.g., 1305a. The pay network server may parse the batch payment request, and extract the transaction data for each transaction stored in the batch payment request, e.g., 1319. The pay network server may store the transaction data, e.g., 1320, for each transaction in a database, e.g., pay network database 1305b. In some embodiments, the pay network server may invoke a component to provide value-add analytics services based on analysis of the transactions of the merchant for whom the GSS is clearing purchase transactions. Thus, in some embodiments, the pay network server may provide analytics-based value-added services for the merchant and/or the merchant's users.

With reference to FIG. 13B, in some embodiments, for each extracted transaction, the pay network server may query, e.g., 1323, a database, e.g., pay network database 1305b, for an address of an issuer server. For example, the pay network server may utilize PHP/SQL commands similar to the examples provided above. The pay network server may generate an individual payment request, e.g., 1325, for each transaction for which it has extracted transaction data, and provide the individual payment request, e.g., 1325, to the issuer server, e.g., 1306a. For example, the pay network server may provide an individual payment request to the issuer server(s) as a HTTP(S) POST message including XML-formatted data. An example listing of an individual payment request 1325, substantially in the form of a HTTP(S) POST message including XML-formatted data, is provided below:

```
POST /paymentrequest.php HTTP/1.1
Host: www.issuer.com
Content-Type: Application/XML
Content-Length: 788
<?XML version = “1.0” encoding = “UTF-8”?>
<pay_request>
  <request_ID>CNI4ICNW2</request_ID>
  <timestamp>2011-02-22 17:00:01</timestamp>
  <pay_amount>$72.89</pay_amount>
  <account_params>
      <account>
          <account_type>debit</account_type>
          <value_exchange_symbol>USD</value_exchange_symbol>
          <account_number>123456789012345</account_number>
          <account_name>John Q. Public</account_name>
          <bill_add>987 Green St #456,  Chicago,  IL 94652
          </bill_add>
          <ship_add>987 Green St #456,  Chicago,  IL 94652
          </ship_add>
          <CVV>1234</CVV>
      </account>
  </account_params>
</pay_request>
```

In some embodiments, the issuer server may generate a payment command, e.g., 1327. For example, the issuer server may issue a command to deduct funds from the user's account (or add a charge to the user's credit card account). The issuer server may issue a payment command, e.g., 1327, to a database storing the user's account information, e.g., user profile database 1306b. The issuer server may provide an individual payment confirmation, e.g., 1328, to the pay network server, which may forward, e.g., 1329, the funds transfer message to the acquirer server. An example listing of an individual payment confirmation 1328, substantially in the form of a HTTP(S) POST message including XML-formatted data, is provided below:

```
POST /clearance.php HTTP/1.1
Host: www.acquirer.com
Content-Type: Application/XML
Content-Length: 206
<?XML version = “1.0” encoding = “UTF-8”?>
<deposit_ack>
  <request_ID>CNI4ICNW2</request_ID>
  <clear_flag>true</clear_flag>
  <timestamp>2011-02-22 17:00:02</timestamp>
  <deposit_amount>$72.89</deposit_amount>
</deposit_ack>
```

In some embodiments, the acquirer server may parse the individual payment confirmation, and correlate the transaction (e.g., using the request ID field in the example above) to the merchant. The acquirer server may then transfer the funds specified in the funds transfer message to an account of the merchant. For example, the acquirer server may query, e.g. 1330, an acquirer database 1307b for payment ledger and/or merchant account data, e.g., 1331. The acquirer server may utilize payment ledger and/or merchant account data from the acquirer database, along with the individual payment confirmation, to generate updated payment ledger and/or merchant account data, e.g., 1332. The acquirer server may then store, e.g., 1333, the updated payment ledger and/or merchant account data to the acquire database.

FIGS. 14A-B show logic flow diagrams illustrating example aspects of transforming a merchant transaction batch data query via a Purchase Transaction Clearance (“PTC”) component into an updated payment ledger record. With reference to FIG. 14A, in some embodiments, a merchant server may initiate clearance of a batch of authorized transactions. For example, the merchant server may generate a batch data request, e.g., 1401, and provide the request to a merchant database. In response to the batch data request, the database may provide the requested batch data, e.g., 1402. The server may generate a batch clearance request, e.g., 1403, using the batch data obtained from the database, and provide the batch clearance request to an acquirer server. The acquirer server may parse, e.g., 1404, the obtained batch clearance request, and generate, e.g., 1407, a batch payment request using the obtained batch clearance request to provide, the batch payment request to a pay network server. For example, the acquirer server may query, e.g., 1405, an acquirer database for an address of a payment network server, and utilize the obtained address, e.g., 1406, to forward the generated batch payment request to the pay network server.

The pay network server may parse the batch payment request obtained from the acquirer server, and extract the transaction data for each transaction stored in the batch payment request, e.g., 1408. The pay network server may store the transaction data, e.g., 1409, for each transaction in a pay network database. In some embodiments, the pay network server may invoke a component, e.g., 141o, to provide analytics based on the transactions of the merchant for whom purchase transaction are being cleared.

With reference to FIG. 14B, in some embodiments, for each extracted transaction, the pay network server may query, e.g., 1411, a pay network database for an address of an issuer server. The pay network server may generate an individual payment request, e.g., 1413, for each transaction for which it has extracted transaction data, and provide the individual payment request to the issuer server. In some embodiments, the issuer server may parse the individual payment request, e.g., 1414, and generate a payment command, e.g., 1415, based on the parsed individual payment request. For example, the issuer server may issue a command to deduct funds from the user's account (or add a charge to the user's credit card account). The issuer server may issue a payment command, e.g., 1415, to a database storing the user's account information, e.g., a user profile database. The issuer server may provide an individual payment confirmation, e.g., 1417, to the pay network server, which may forward, e.g., 1418, the individual payment confirmation to the acquirer server.

In some embodiments, the acquirer server may parse the individual payment confirmation, and correlate the transaction (e.g., using the request ID field in the example above) to the merchant. The acquirer server may then transfer the funds specified in the funds transfer message to an account of the merchant. For example, the acquirer server may query, e.g. 1419, an acquirer database for payment ledger and/or merchant account data, e.g., 1420. The acquirer server may utilize payment ledger and/or merchant account data from the acquirer database, along with the individual payment confirmation, to generate updated payment ledger and/or merchant account data, e.g., 1421. The acquirer server may then store, e.g., 1422, the updated payment ledger and/or merchant account data to the acquire database.

FIG. 15 shows a user interface diagram illustrating an overview of example features of virtual wallet applications in some embodiments of the GSS. FIG. 15 shows an illustration of various exemplary features of a virtual wallet mobile application 1500. Some of the features displayed include a wallet 1501, social integration via TWITTER, FACEBOOK, etc., offers and loyalty 1503, snap mobile purchase 1504, alerts 1505 and security, setting and analytics 1596. These features are explored in further detail below.

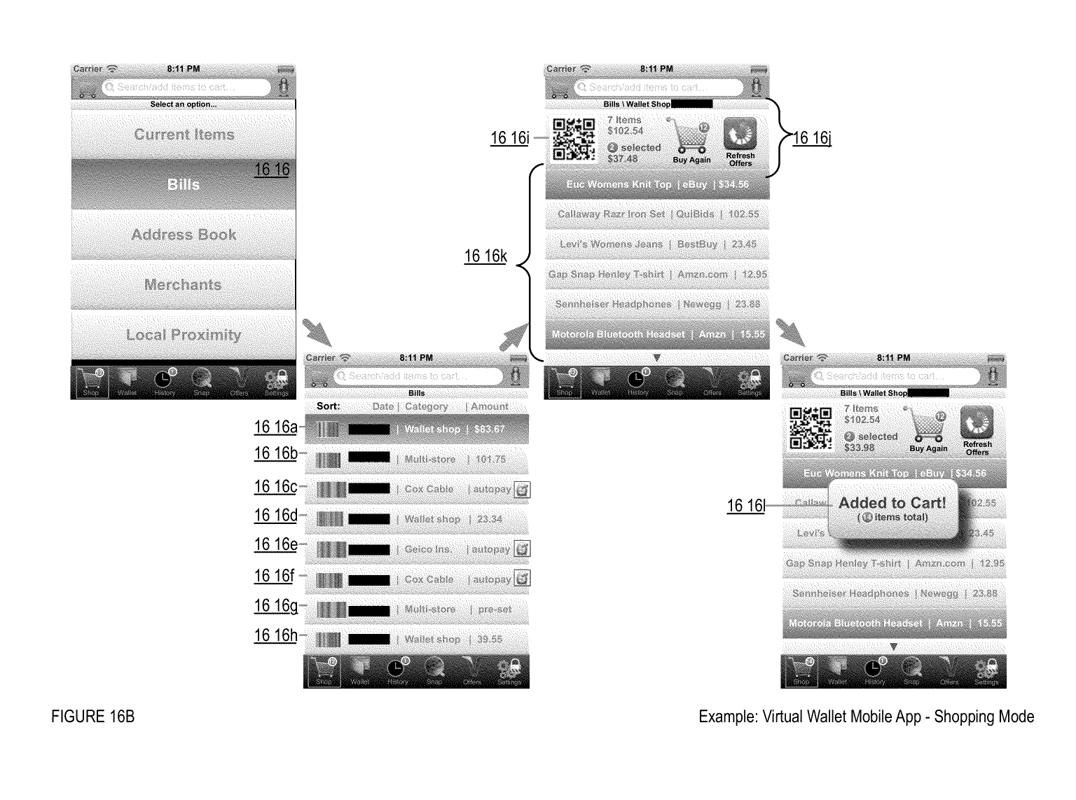

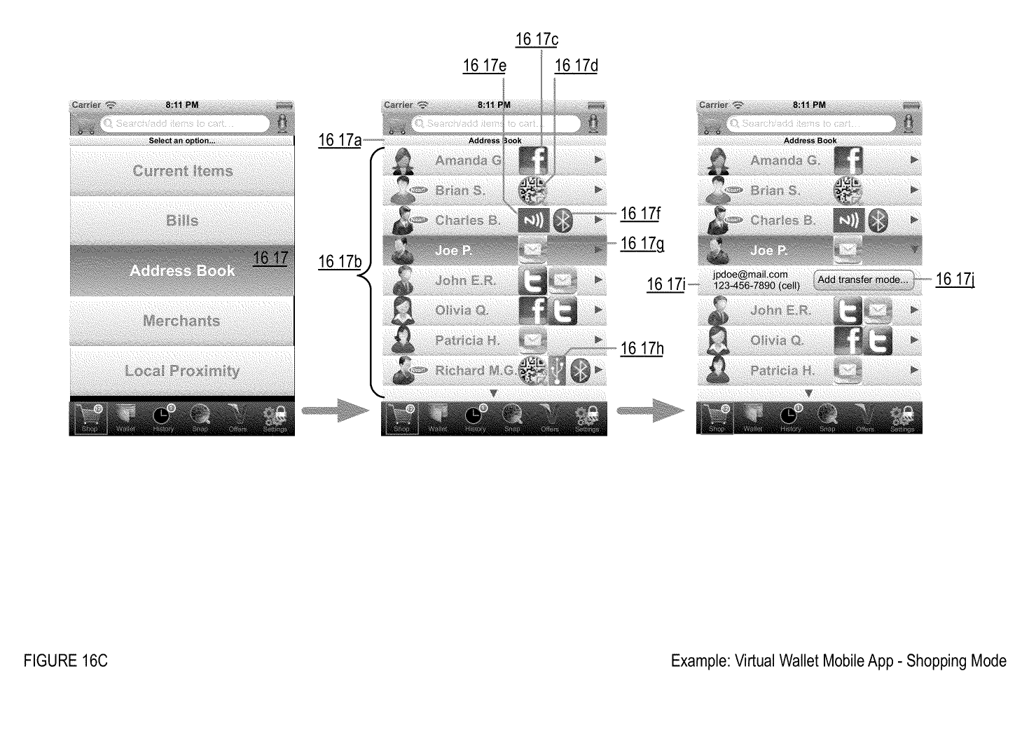

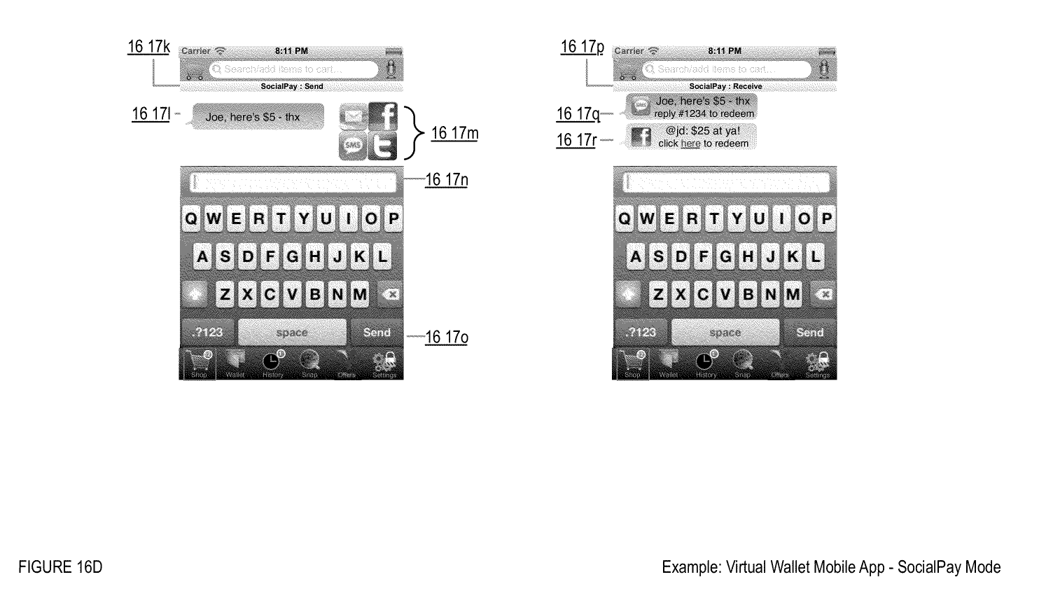

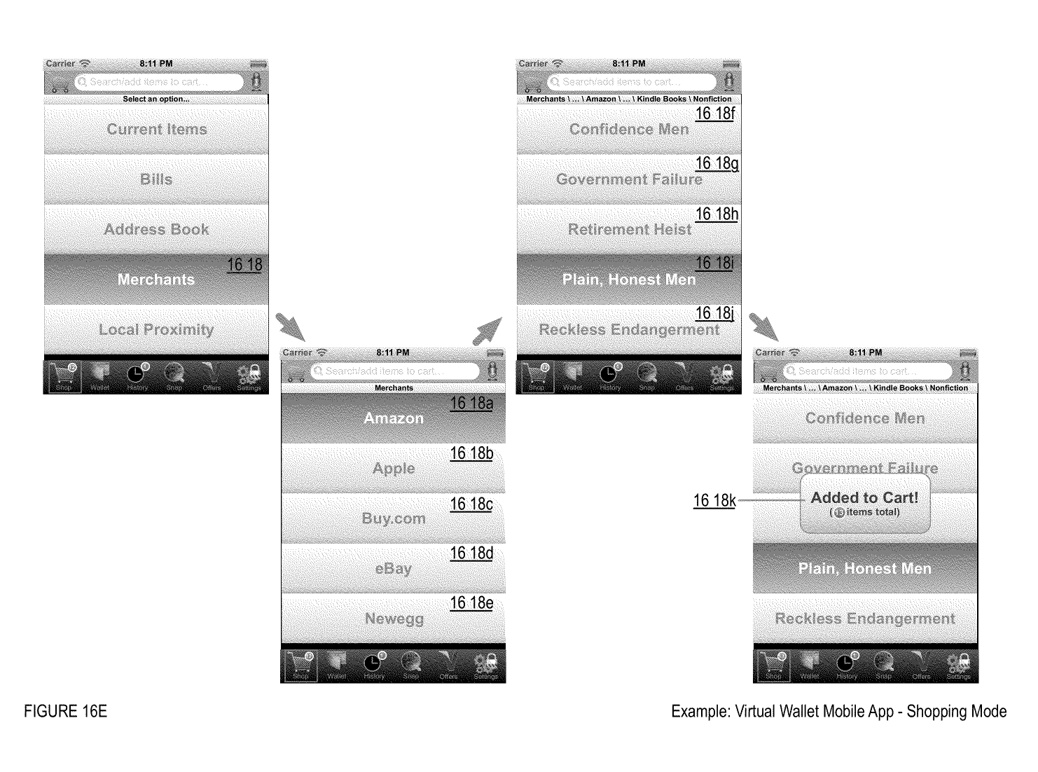

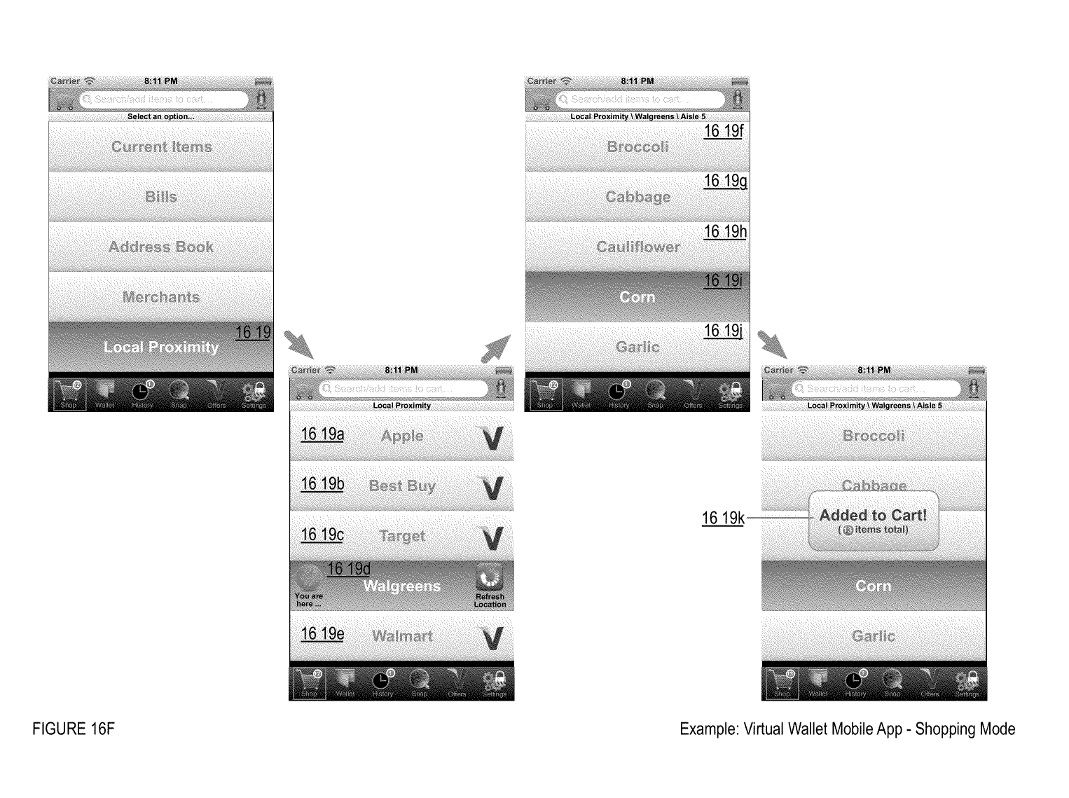

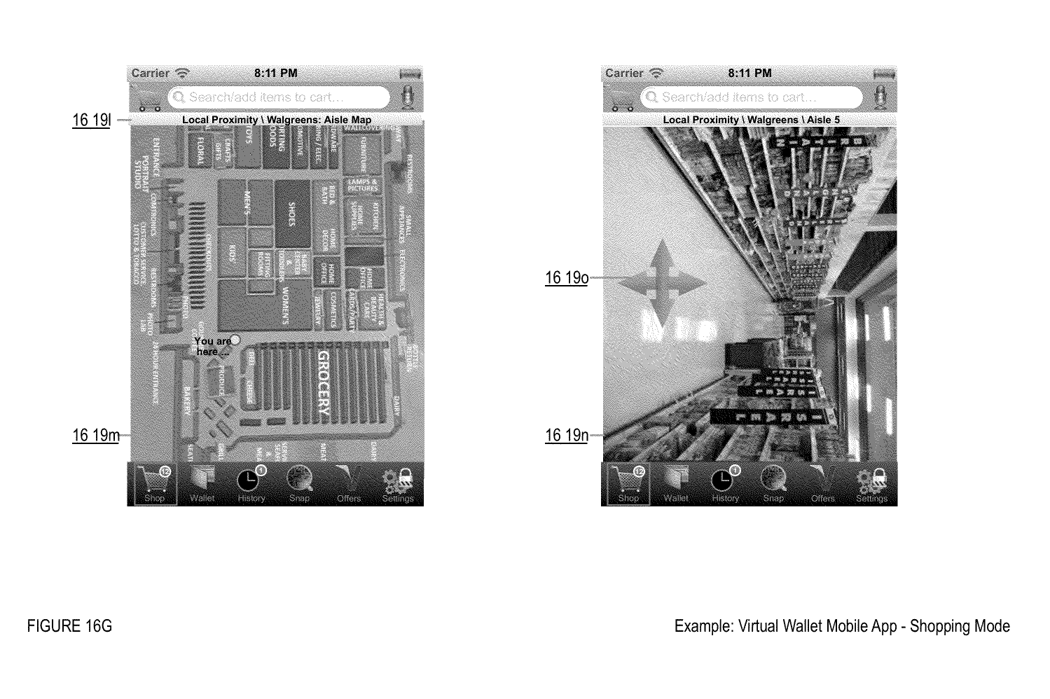

FIGS. 16A-G show user interface diagrams illustrating example features of virtual wallet applications in a shopping mode, in some embodiments of the GSS. With reference to FIG. 16A, some embodiments of the virtual wallet mobile app facilitate and greatly enhance the shopping experience of consumers. A variety of shopping modes, as shown in FIG. 16A, may be available for a consumer to peruse. In one implementation, for example, a user may launch the shopping mode by selecting the shop icon 1610 at the bottom of the user interface. A user may type in an item in the search field 1612 to search and/or add an item to a cart 1611. A user may also use a voice activated shopping mode by saying the name or description of an item to be searched and/or added to the cart into a microphone 1613. In a further implementation, a user may also select other shopping options 1614 such as current items 1615, bills 1616, address book 1617, merchants 1618 and local proximity 1619.

In one embodiment, for example, a user may select the option current items 1615, as shown in the left most user interface of FIG. 16A. When the current items 1615 option is selected, the middle user interface may be displayed. As shown, the middle user interface may provide a current list of items 1615a-h in a user's shopping cart 1611. A user may select an item, for example item 1615a, to view product description 1615j of the selected item and/or other items from the same merchant. The price and total payable information may also be displayed, along with a QR code 1615k that captures the information necessary to effect a snap mobile purchase transaction.

With reference to FIG. 16B, in another embodiment, a user may select the bills 1616 option. Upon selecting the bills 1616 option, the user interface may display a list of bills and/or receipts 1616a-h from one or more merchants. Next to each of the bills, additional information such as date of visit, whether items from multiple stores are present, last bill payment date, auto-payment, number of items, and/or the like may be displayed. In one example, the wallet shop bill 1616a dated Jan. 20, 2011 may be selected. The wallet shop bill selection may display a user interface that provides a variety of information regarding the selected bill. For example, the user interface may display a list of items 1616k purchased, <<1616i>>, a total number of items and the corresponding value. For example, 7 items worth $102.54 were in the selected wallet shop bill. A user may now select any of the items and select buy again to add purchase the items. The user may also refresh offers 1616j to clear any invalid offers from last time and/or search for new offers that may be applicable for the current purchase. As shown in FIG. 16B, a user may select two items for repeat purchase. Upon addition, a message 16161 may be displayed to confirm the addition of the two items, which makes the total number of items in the cart 14.

With reference to FIG. 16C, in yet another embodiment, a user may select the address book option 1617 to view the address book 1617a which includes a list of contacts 1617b and make any money transfers or payments. In one embodiment, the address book may identify each contact using their names and available and/or preferred modes of payment. For example, a contact Amanda G. may be paid via social pay (e.g., via FACEBOOK) as indicated by the icon 1617c. In another example, money may be transferred to Brian S. via QR code as indicated by the QR code icon 1617d. In yet another example, Charles B. may accept payment via near field communication 1617e, Bluetooth 1617f and email 1617g. Payment may also be made via USB 1617h (e.g., by physically connecting two mobile devices) as well as other social channels such as TWITTER.

In one implementation, a user may select Joe P. for payment. Joe P., as shown in the user interface, has an email icon 1617g next to his name indicating that Joe P. accepts payment via email. When his name is selected, the user interface may display his contact information such as email, phone, etc. If a user wishes to make a payment to Joe P. by a method other than email, the user may add another transfer mode 1617j to his contact information and make a payment transfer. With reference to FIG. 16D, the user may be provided with a screen 1617k where the user can enter an amount to send Joe, as well as add other text to provide Joe with context for the payment transaction 16171. The user can choose modes (e.g., SMS, email, social networking) via which Joe may be contacted via graphical user interface elements, 1617m. As the user types, the text entered may be provided for review within a GUI element 1617n. When the user has completed entering in the necessary information, the user can press the send button 16170 to send the social message to Joe. If Joe also has a virtual wallet application, Joe may be able to review 1617p social pay message within the app, or directly at the website of the social network (e.g., for Twitter', Facebook®, etc.). Messages may be aggregated from the various social networks and other sources (e.g., SMS, email). The method of redemption appropriate for each messaging mode may be indicated along with the social pay message. In the illustration in FIG. 16D, the SMS 1617q Joe received indicates that Joe can redeem the $5 obtained via SMS by replying to the SMS and entering the hash tag value ‘#1234’. In the same illustration, Joe has also received a message 1617r via Facebook®, which includes a URL link that Joe can activate to initiate redemption of the $25 payment.

With reference to FIG. 16E, in some other embodiments, a user may select merchants 1618 from the list of options in the shopping mode to view a select list of merchants 1618a-e. In one implementation, the merchants in the list may be affiliated to the wallet, or have affinity relationship with the wallet. In another implementation, the merchants may include a list of merchants meeting a user-defined or other criteria. For example, the list may be one that is curated by the user, merchants where the user most frequently shops or spends more than an x amount of sum or shopped for three consecutive months, and/or the like. In one implementation, the user may further select one of the merchants, Amazon 1618a for example. The user may then navigate through the merchant's listings to find items of interest such as 1618f-j. Directly through the wallet and without visiting the merchant site from a separate page, the user may make a selection of an item 1618j from the catalog of Amazon 1618a. As shown in the right most user interface of FIG. 16D, the selected item may then be added to cart. The message 1618k indicates that the selected item has been added to the cart, and updated number of items in the cart is now 13.

With reference to FIG. 16F, in one embodiment, there may be a local proximity option 1619 which may be selected by a user to view a list of merchants that are geographically in close proximity to the user. For example, the list of merchants 1619a-e may be the merchants that are located close to the user. In one implementation, the mobile application may further identify when the user in a store based on the user's location. For example, position icon 1619d may be displayed next to a store (e.g., Walgreens) when the user is in close proximity to the store. In one implementation, the mobile application may refresh its location periodically in case the user moved away from the store (e.g., Walgreens). In a further implementation, the user may navigate the offerings of the selected Walgreens store through the mobile application. For example, the user may navigate, using the mobile application, to items 1619f-j available on aisle 5 of Walgreens. In one implementation, the user may select corn 1619i from his or her mobile application to add to cart 1619k.

With reference to FIG. 16G, in another embodiment, the local proximity option 1619 may include a store map and a real time map features among others. For example, upon selecting the Walgreens store, the user may launch an aisle map 16191 which displays a map 1619m showing the organization of the store and the position of the user (indicated by a yellow circle). In one implementation, the user may easily configure the map to add one or more other users (e.g., user's kids) to share each other's location within the store. In another implementation, the user may have the option to launch a “store view” similar to street views in maps. The store view 1619n may display images/video of the user's surrounding. For example, if the user is about to enter aisle 5, the store view map may show the view of aisle 5. Further the user may manipulate the orientation of the map using the navigation tool 16190 to move the store view forwards, backwards, right, left as well clockwise and counterclockwise rotation

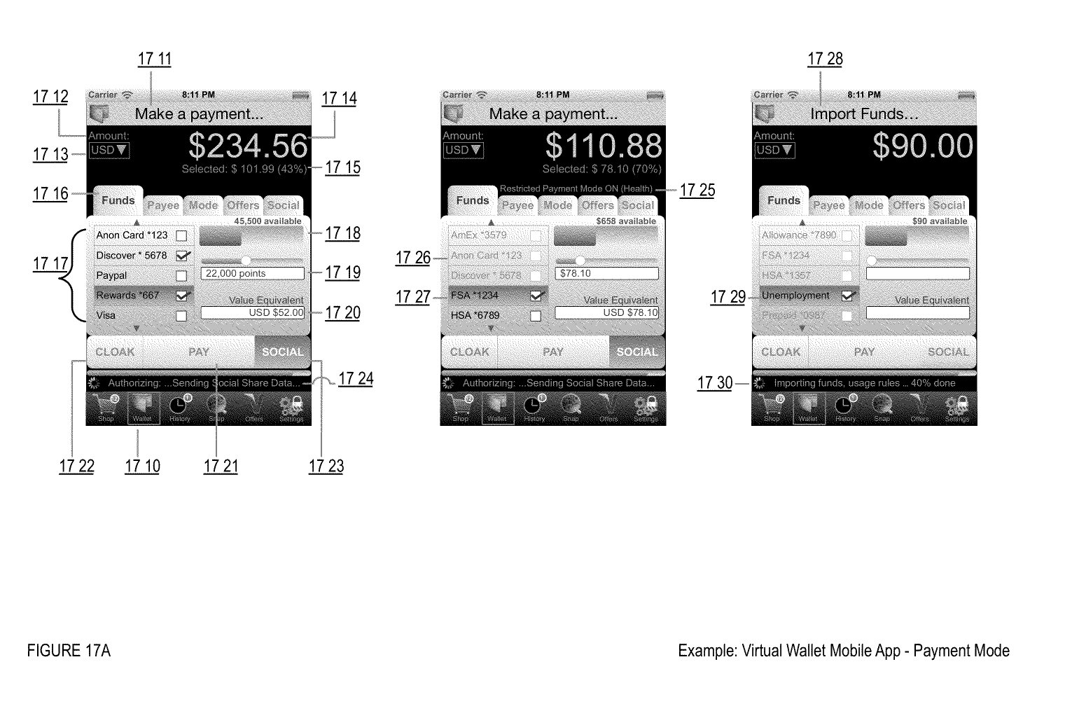

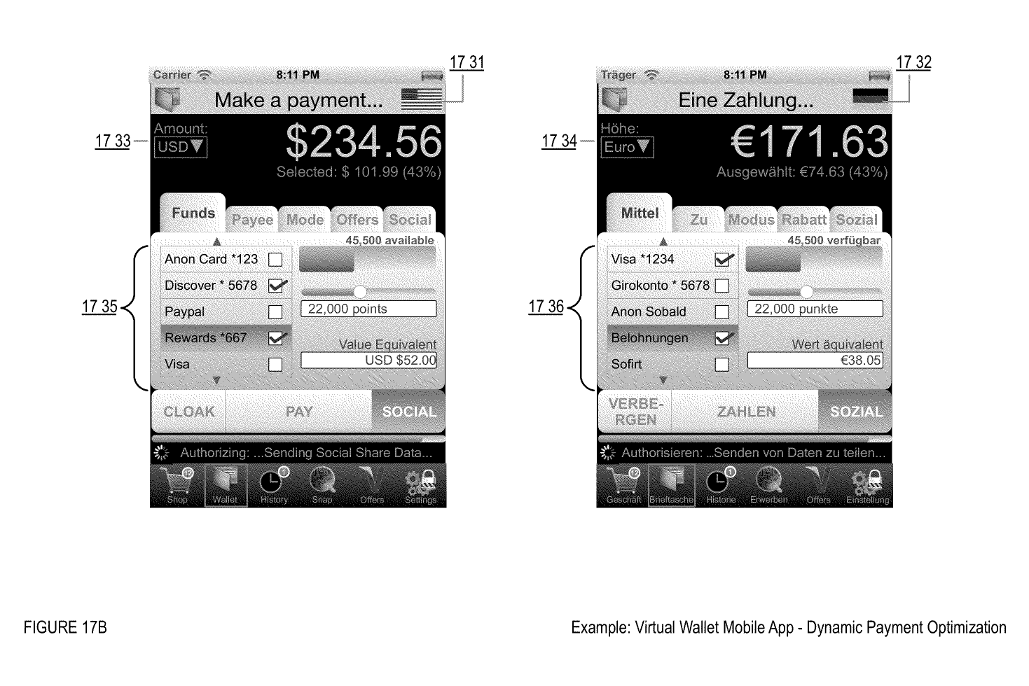

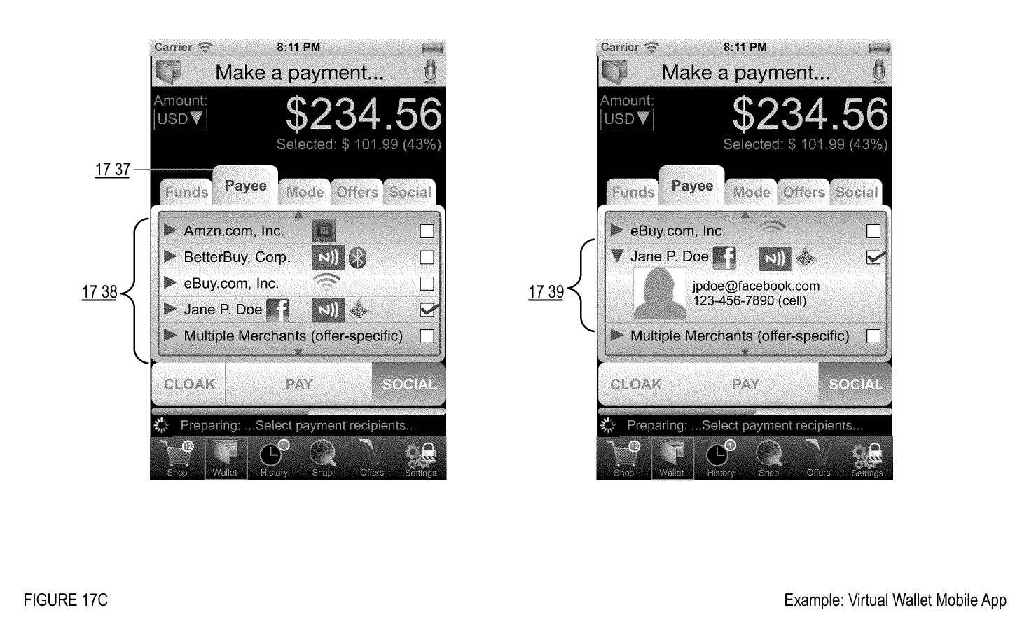

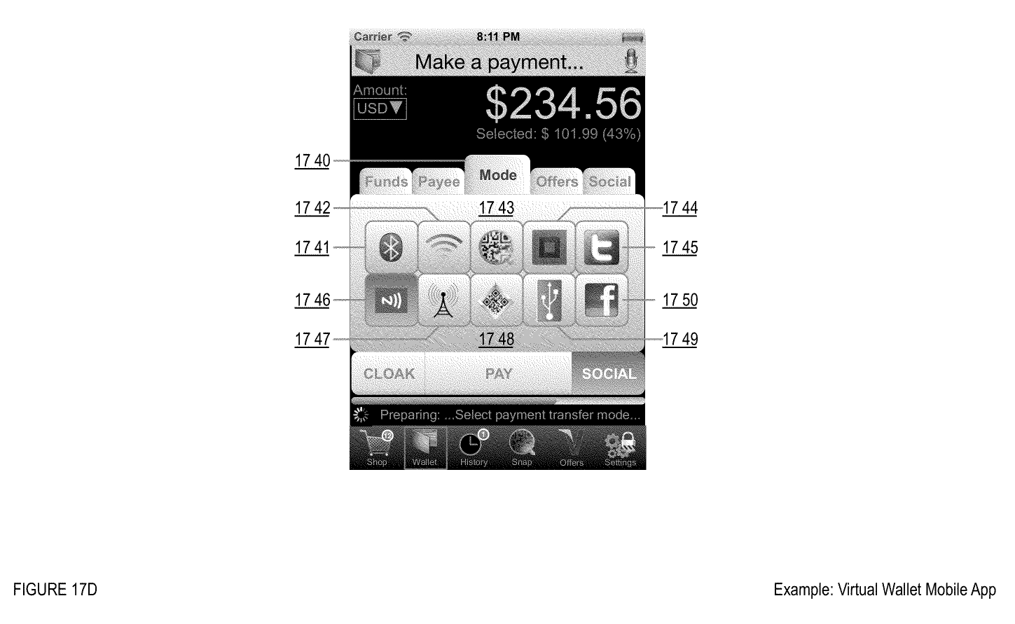

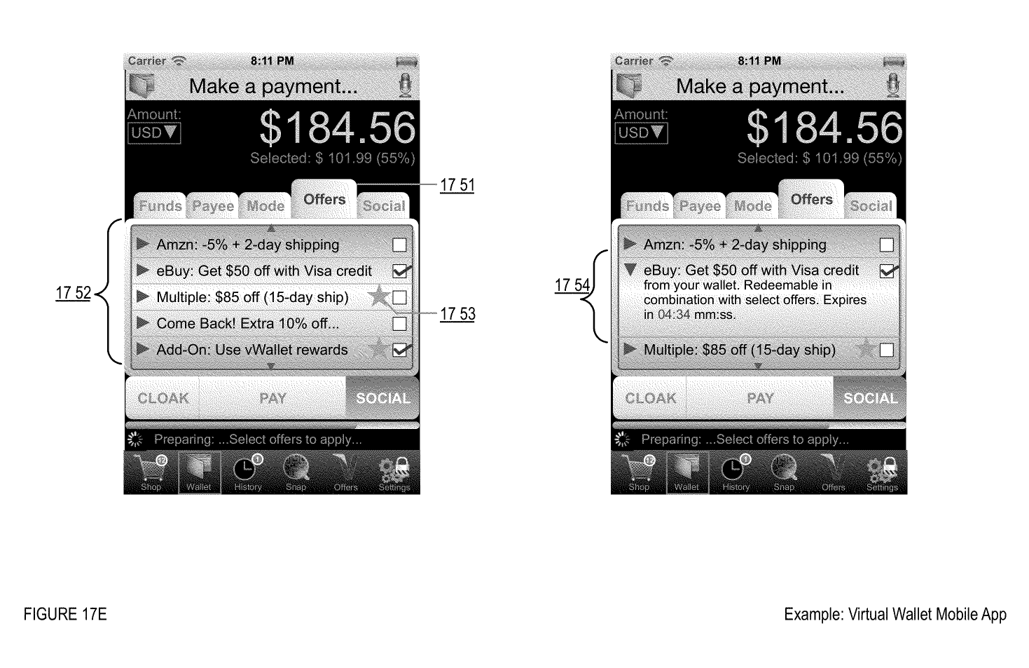

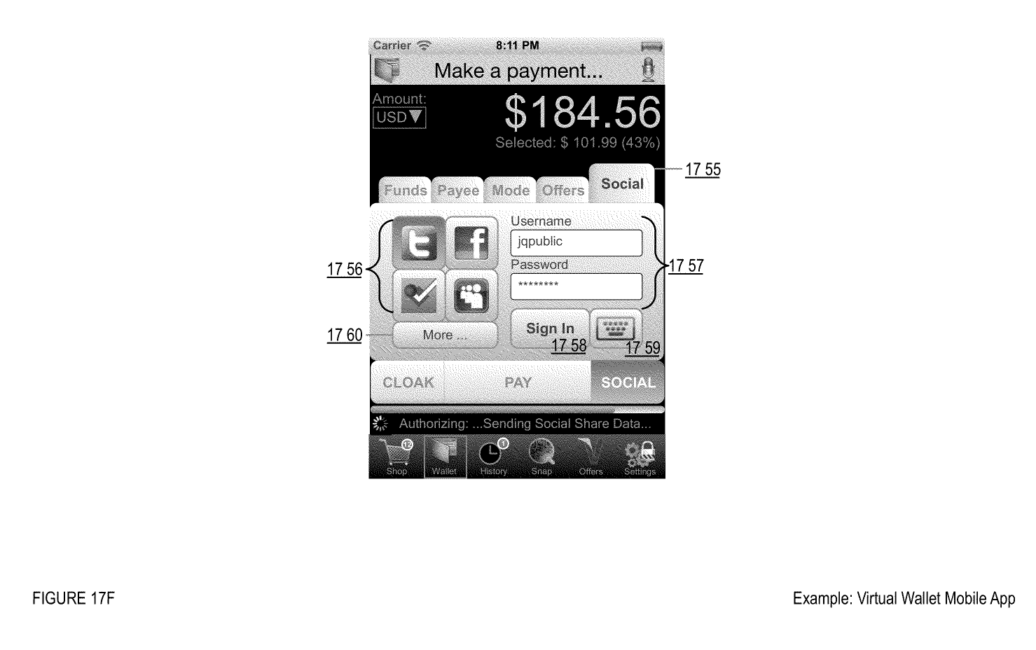

FIGS. 17A-F show user interface diagrams illustrating example features of virtual wallet applications in a payment mode, in some embodiments of the GSS. With reference to FIG. 17A, in one embodiment, the wallet mobile application may provide a user with a number of options for paying for a transaction via the wallet mode 1710. In one implementation, an example user interface 1711 for making a payment is shown. The user interface may clearly identify the amount 1712 and the currency 1713 for the transaction. The amount may be the amount payable and the currency may include real currencies such as dollars and euros, as well as virtual currencies such as reward points. The amount of the transaction 1714 may also be prominently displayed on the user interface. The user may select the funds tab 1716 to select one or more forms of payment 1717, which may include various credit, debit, gift, rewards and/or prepaid cards. The user may also have the option of paying, wholly or in part, with reward points. For example, the graphical indicator 1718 on the user interface shows the number of points available, the graphical indicator 1719 shows the number of points to be used towards the amount due 234.56 and the equivalent 1720 of the number of points in a selected currency (USD, for example).

In one implementation, the user may combine funds from multiple sources to pay for the transaction. The amount 1715 displayed on the user interface may provide an indication of the amount of total funds covered so far by the selected forms of payment (e.g., Discover card and rewards points). The user may choose another form of payment or adjust the amount to be debited from one or more forms of payment until the amount 1715 matches the amount payable 1714. Once the amounts to be debited from one or more forms of payment are finalized by the user, payment authorization may begin.

In one implementation, the user may select a secure authorization of the transaction by selecting the cloak button 1722 to effectively cloak or anonymize some (e.g., pre-configured) or all identifying information such that when the user selects pay button 1721, the transaction authorization is conducted in a secure and anonymous manner. In another implementation, the user may select the pay button 1721 which may use standard authorization techniques for transaction processing. In yet another implementation, when the user selects the social button 1723, a message regarding the transaction may be communicated to one of more social networks (set up by the user) which may post or announce the purchase transaction in a social forum such as a wall post or a tweet. In one implementation, the user may select a social payment processing option 1723. The indicator 1724 may show the authorizing and sending social share data in progress.

In another implementation, a restricted payment mode 1725 may be activated for certain purchase activities such as prescription purchases. The mode may be activated in accordance with rules defined by issuers, insurers, merchants, payment processor and/or other entities to facilitate processing of specialized goods and services. In this mode, the user may scroll down the list of forms of payments 1726 under the funds tab to select specialized accounts such as a flexible spending account (FSA) 1727, health savings account (HAS), and/or the like and amounts to be debited to the selected accounts. In one implementation, such restricted payment mode 1725 processing may disable social sharing of purchase information.

In one embodiment, the wallet mobile application may facilitate importing of funds via the import funds user interface 1728. For example, a user who is unemployed may obtain unemployment benefit fund 1729 via the wallet mobile application. In one implementation, the entity providing the funds may also configure rules for using the fund as shown by the processing indicator message 1730. The wallet may read and apply the rules prior, and may reject any purchases with the unemployment funds that fail to meet the criteria set by the rules. Example criteria may include, for example, merchant category code (MCC), time of transaction, location of transaction, and/or the like. As an example, a transaction with a grocery merchant having MCC 5411 may be approved, while a transaction with a bar merchant having an MCC 5813 may be refused.

With reference to FIG. 17B, in one embodiment, the wallet mobile application may facilitate dynamic payment optimization based on factors such as user location, preferences and currency value preferences among others. For example, when a user is in the United States, the country indicator 1731 may display a flag of the United States and may set the currency 1733 to the United States. In a further implementation, the wallet mobile application may automatically rearrange the order in which the forms of payments 1735 are listed to reflect the popularity or acceptability of various forms of payment. In one implementation, the arrangement may reflect the user's preference, which may not be changed by the wallet mobile application.

Similarly, when a German user operates a wallet in Germany, the mobile wallet application user interface may be dynamically updated to reflect the country of operation 1732 and the currency 1734. In a further implementation, the wallet application may rearrange the order in which different forms of payment 1736 are listed based on their acceptance level in that country. Of course, the order of these forms of payments may be modified by the user to suit his or her own preferences.

With reference to FIG. 17C, in one embodiment, the payee tab 1737 in the wallet mobile application user interface may facilitate user selection of one or more payees receiving the funds selected in the funds tab. In one implementation, the user interface may show a list of all payees 1738 with whom the user has previously transacted or available to transact. The user may then select one or more payees. The payees 1738 may include larger merchants such as Amazon.com Inc., and individuals such as Jane P. Doe. Next to each payee name, a list of accepted payment modes for the payee may be displayed. In one implementation, the user may select the payee Jane P. Doe 1739 for receiving payment. Upon selection, the user interface may display additional identifying information relating to the payee.

With reference to FIG. 17D, in one embodiment, the mode tab 1740 may facilitate selection of a payment mode accepted by the payee. A number of payment modes may be available for selection. Example modes include, blue tooth 1741, wireless 1742, snap mobile by user-obtained QR code 1743, secure chip 1744, TWITTER 1745, near-field communication (NFC) 1746, cellular 1747, snap mobile by user-provided QR code 1748, USB 1749 and FACEBOOK 1750, among others. In one implementation, only the payment modes that are accepted by the payee may be selectable by the user. Other non-accepted payment modes may be disabled.

With reference to FIG. 17E, in one embodiment, the offers tab 1751 may provide real-time offers that are relevant to items in a user's cart for selection by the user. The user may select one or more offers from the list of applicable offers 1752 for redemption. In one implementation, some offers may be combined, while others may not. When the user selects an offer that may not be combined with another offer, the unselected offers may be disabled. In a further implementation, offers that are recommended by the wallet application's recommendation engine may be identified by an indicator, such as the one shown by 1753. In a further implementation, the user may read the details of the offer by expanding the offer row as shown by 1754 in the user interface.

With reference to FIG. 17F, in one embodiment, the social tab 1755 may facilitate integration of the wallet application with social channels 1756. In one implementation, a user may select one or more social channels 1756 and may sign in to the selected social channel from the wallet application by providing to the wallet application the social channel user name and password 1757 and signing in 1758. The user may then use the social button 1759 to send or receive money through the integrated social channels. In a further implementation, the user may send social share data such as purchase information or links through integrated social channels. In another embodiment, the user supplied login credentials may allow GSS to engage in interception parsing.

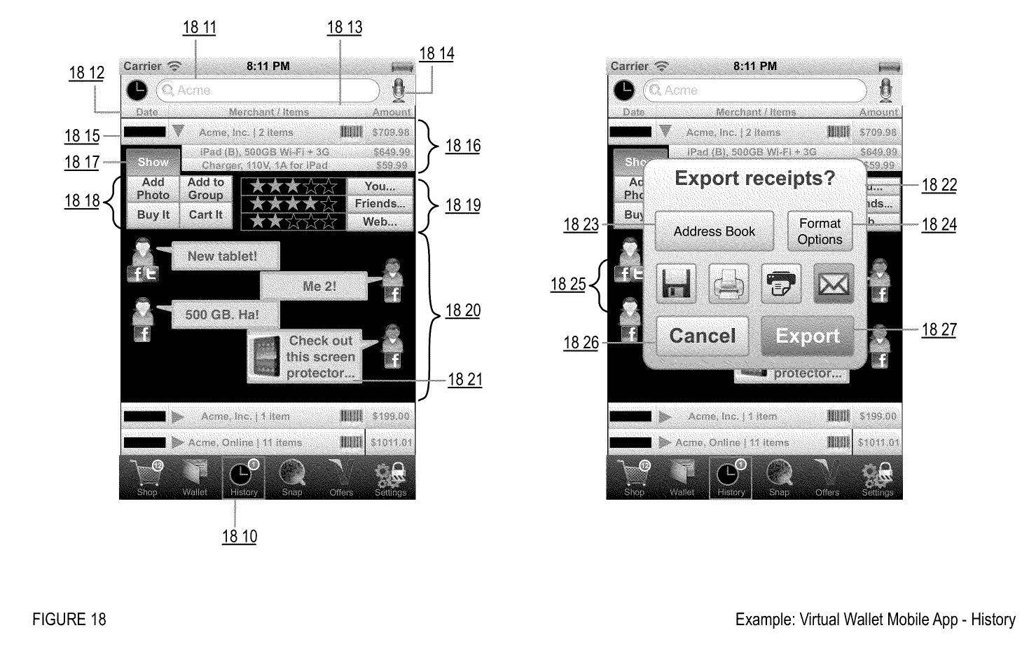

FIG. 18 shows a user interface diagram illustrating example features of virtual wallet applications, in a history mode, in some embodiments of the GSS. In one embodiment, a user may select the history mode 1810 to view a history of prior purchases and perform various actions on those prior purchases. For example, a user may enter a merchant identifying information such as name, product, MCC, and/or the like in the search bar 1811. In another implementation, the user may use voice activated search feature by clicking on the microphone icon 1814. The wallet application may query the storage areas in the mobile device or elsewhere (e.g., one or more databases and/or tables remote from the mobile device) for transactions matching the search keywords. The user interface may then display the results of the query such as transaction 1815. The user interface may also identify the date 1812 of the transaction, the merchants and items 1813 relating to the transaction, a barcode of the receipt confirming that a transaction was made, the amount of the transaction and any other relevant information.

In one implementation, the user may select a transaction, for example transaction 1815, to view the details of the transaction. For example, the user may view the details of the items associated with the transaction and the amounts 1816 of each item. In a further implementation, the user may select the show option 1817 to view actions 1818 that the user may take in regards to the transaction or the items in the transaction. For example, the user may add a photo to the transaction (e.g., a picture of the user and the iPad the user bought). In a further implementation, if the user previously shared the purchase via social channels, a post including the photo may be generated and sent to the social channels for publishing. In one implementation, any sharing may be optional, and the user, who did not share the purchase via social channels, may still share the photo through one or more social channels of his or her choice directly from the history mode of the wallet application. In another implementation, the user may add the transaction to a group such as company expense, home expense, travel expense or other categories set up by the user. Such grouping may facilitate year-end accounting of expenses, submission of work expense reports, submission for value added tax (VAT) refunds, personal expenses, and/or the like. In yet another implementation, the user may buy one or more items purchased in the transaction. The user may then execute a transaction without going to the merchant catalog or site to find the items. In a further implementation, the user may also cart one or more items in the transaction for later purchase.

The history mode, in another embodiment, may offer facilities for obtaining and displaying ratings 1819 of the items in the transaction. The source of the ratings may be the user, the user's friends (e.g., from social channels, contacts, etc.), reviews aggregated from the web, and/or the like. The user interface in some implementations may also allow the user to post messages to other users of social channels (e.g., TWITTER or FACEBOOK). For example, the display area 1820 shows FACEBOOK message exchanges between two users. In one implementation, a user may share a link via a message 1821. Selection of such a message having embedded link to a product may allow the user to view a description of the product and/or purchase the product directly from the history mode.

In one embodiment, the history mode may also include facilities for exporting receipts. The export receipts pop up 1822 may provide a number of options for exporting the receipts of transactions in the history. For example, a user may use one or more of the options 1825, which include save (to local mobile memory, to server, to a cloud account, and/or the like), print to a printer, fax, email, and/or the like. The user may utilize his or her address book 1823 to look up email or fax number for exporting. The user may also specify format options 1824 for exporting receipts. Example format options may include, without limitation, text files (.doc, .txt, .rtf, iif, etc.), spreadsheet (.csv, .xls, etc.), image files (.jpg, .tff, .png, etc.), portable document format (.pdf), postscript (.ps), and/or the like. The user may then click or tap the export button 1827 to initiate export of receipts.

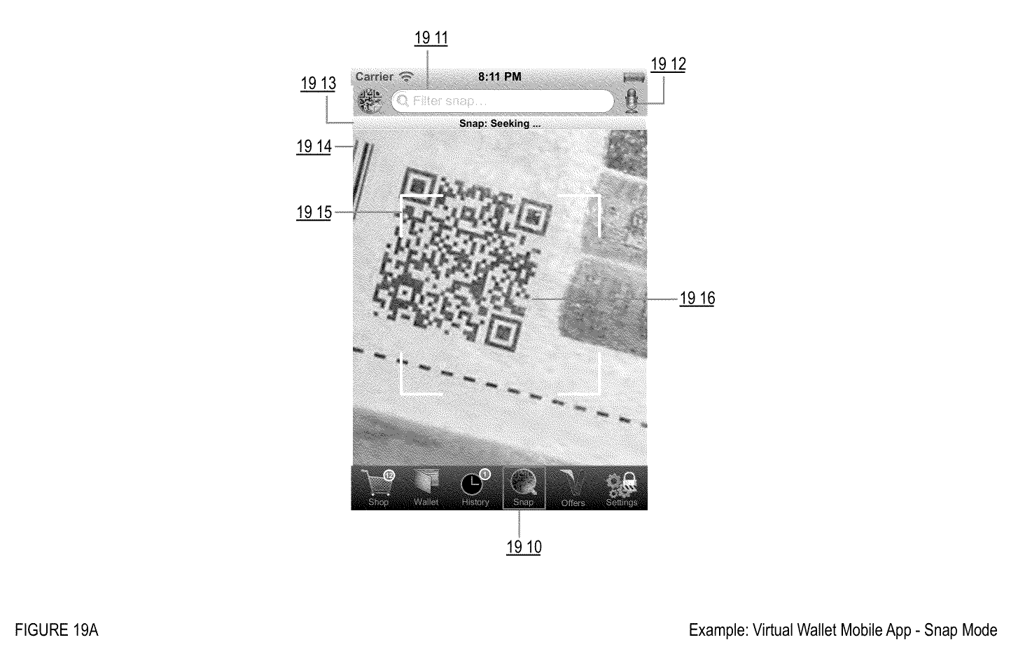

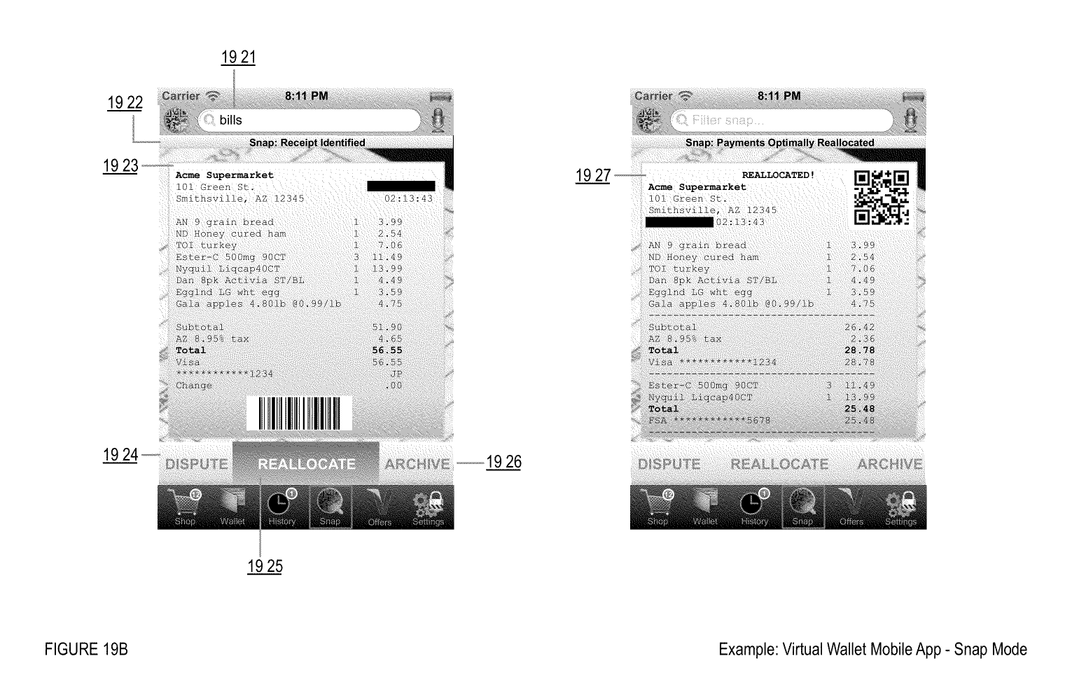

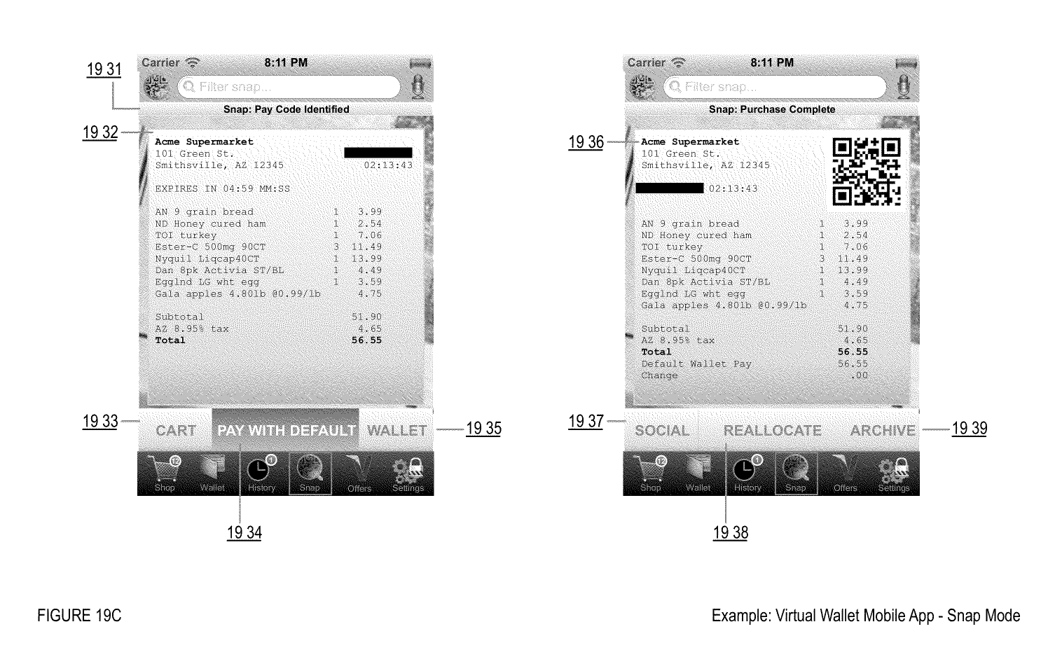

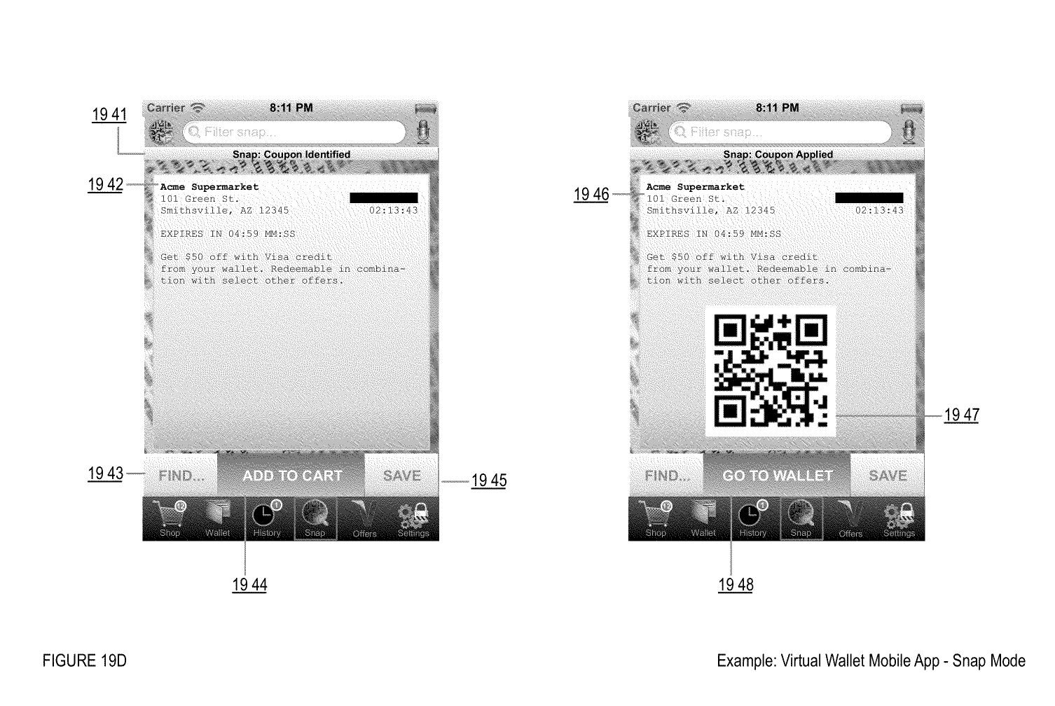

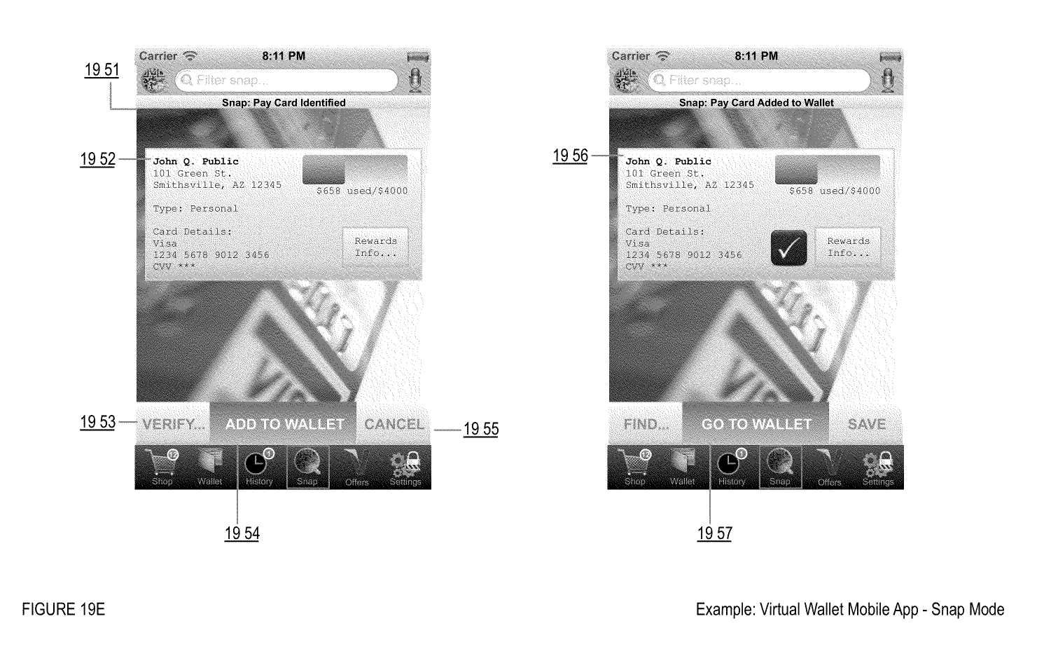

FIGS. 19A-E show user interface diagrams illustrating example features of virtual wallet applications in a snap mode, in some embodiments of the GSS. With reference to FIG. 19A, in one embodiment, a user may select the snap mode 2110 to access its snap features. The snap mode may handle any machine-readable representation of data. Examples of such data may include linear and 2D bar codes such as UPC code and QR codes. These codes may be found on receipts, product packaging, and/or the like. The snap mode may also process and handle pictures of receipts, products, offers, credit cards or other payment devices, and/or the like. An example user interface in snap mode is shown in FIG. 19A. A user may use his or her mobile phone to take a picture of a QR code 1915 and/or a barcode 1914. In one implementation, the bar 1913 and snap frame 1915 may assist the user in snapping codes properly. For example, the snap frame 1915, as shown, does not capture the entirety of the code 1916. As such, the code captured in this view may not be resolvable as information in the code may be incomplete. This is indicated by the message on the bar 1913 that indicates that the snap mode is still seeking the code. When the code 1916 is completely framed by the snap frame 1915, the bar message may be updated to, for example, “snap found.” Upon finding the code, in one implementation, the user may initiate code capture using the mobile device camera. In another implementation, the snap mode may automatically snap the code using the mobile device camera.

With reference to FIG. 19B, in one embodiment, the snap mode may facilitate payment reallocation post transaction. For example, a user may buy grocery and prescription items from a retailer Acme Supermarket. The user may, inadvertently or for ease of checkout for example, use his or her Visa card to pay for both grocery and prescription items. However, the user may have an FSA account that could be used to pay for prescription items, and which would provide the user tax benefits. In such a situation, the user may use the snap mode to initiate transaction reallocation.

As shown, the user may enter a search term (e.g., bills) in the search bar 2121. The user may then identify in the tab 1922 the receipt 1923 the user wants to reallocate. Alternatively, the user may directly snap a picture of a barcode on a receipt, and the snap mode may generate and display a receipt 1923 using information from the barcode. The user may now reallocate 1925. In some implementations, the user may also dispute the transaction 1924 or archive the receipt 1926.

In one implementation, when the reallocate button 1925 is selected, the wallet application may perform optical character recognition (OCR) of the receipt. Each of the items in the receipt may then be examined to identify one or more items which could be charged to which payment device or account for tax or other benefits such as cash back, reward points, etc. In this example, there is a tax benefit if the prescription medication charged to the user's Visa card is charged to the user's FSA. The wallet application may then perform the reallocation as the back end. The reallocation process may include the wallet contacting the payment processor to credit the amount of the prescription medication to the Visa card and debit the same amount to the user's FSA account. In an alternate implementation, the payment processor (e.g., Visa or MasterCard) may obtain and OCR the receipt, identify items and payment accounts for reallocation and perform the reallocation. In one implementation, the wallet application may request the user to confirm reallocation of charges for the selected items to another payment account. The receipt 1927 may be generated after the completion of the reallocation process. As discussed, the receipt shows that some charges have been moved from the Visa account to the FSA.

With reference to FIG. 19C, in one embodiment, the snap mode may facilitate payment via pay code such as barcodes or QR codes. For example, a user may snap a QR code of a transaction that is not yet complete. The QR code may be displayed at a merchant POS terminal, a web site, or a web application and may be encoded with information identifying items for purchase, merchant details and other relevant information. When the user snaps such as a QR code, the snap mode may decode the information in the QR code and may use the decoded information to generate a receipt 1932. Once the QR code is identified, the navigation bar 1931 may indicate that the pay code is identified. The user may now have an option to add to cart 1933, pay with a default payment account 1934 or pay with wallet 1935.

In one implementation, the user may decide to pay with default 1934. The wallet application may then use the user's default method of payment, in this example the wallet, to complete the purchase transaction. Upon completion of the transaction, a receipt may be automatically generated for proof of purchase. The user interface may also be updated to provide other options for handling a completed transaction. Example options include social 1937 to share purchase information with others, reallocate 1938 as discussed with regard to FIG. 19B, and archive 1939 to store the receipt.

With reference to FIG. 19D, in one embodiment, the snap mode may also facilitate offer identification, application and storage for future use. For example, in one implementation, a user may snap an offer code 1941 (e.g., a bar code, a QR code, and/or the like). The wallet application may then generate an offer text 1942 from the information encoded in the offer code. The user may perform a number of actions on the offer code. For example, the user use the find button 1943 to find all merchants who accept the offer code, merchants in the proximity who accept the offer code, products from merchants that qualify for the offer code, and/or the like. The user may also apply the offer code to items that are currently in the cart using the add to cart button 1944. Furthermore, the user may also save the offer for future use by selecting the save button 1945.

In one implementation, after the offer or coupon 1946 is applied, the user may have the option to find qualifying merchants and/or products using find, the user may go to the wallet using 1948, and the user may also save the offer or coupon 1946 for later use.

With reference to FIG. 19E, in one embodiment, the snap mode may also offer facilities for adding a funding source to the wallet application. In one implementation, a pay card such as a credit card, debit card, pre-paid card, smart card and other pay accounts may have an associated code such as a bar code or QR code. Such a code may have encoded therein pay card information including, but not limited to, name, address, pay card type, pay card account details, balance amount, spending limit, rewards balance, and/or the like. In one implementation, the code may be found on a face of the physical pay card. In another implementation, the code may be obtained by accessing an associated online account or another secure location. In yet another implementation, the code may be printed on a letter accompanying the pay card. A user, in one implementation, may snap a picture of the code. The wallet application may identify the pay card 1951 and may display the textual information 1952 encoded in the pay card. The user may then perform verification of the information 1952 by selecting the verify button 1953. In one implementation, the verification may include contacting the issuer of the pay card for confirmation of the decoded information 1952 and any other relevant information. In one implementation, the user may add the pay card to the wallet by selecting the ‘add to wallet’ button 1954. The instruction to add the pay card to the wallet may cause the pay card to appear as one of the forms of payment under the funds tab 1716 discussed in FIG. 17A. The user may also cancel importing of the pay card as a funding source by selecting the cancel button 1955. When the pay card has been added to the wallet, the user interface may be updated to indicate that the importing is complete via the notification display 1956. The user may then access the wallet 1957 to begin using the added pay card as a funding source.

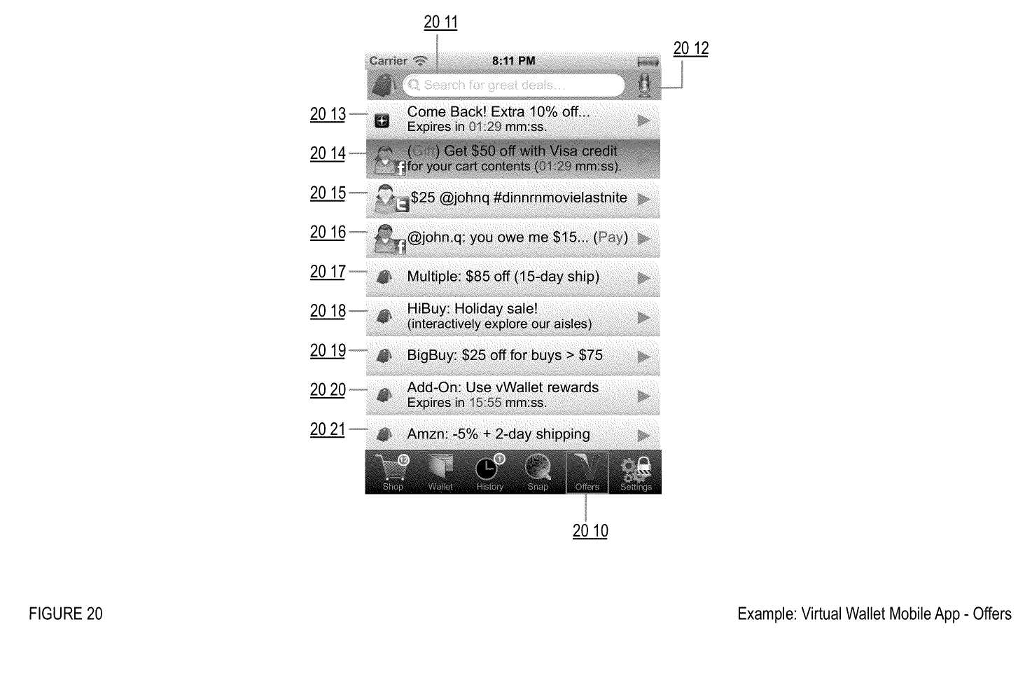

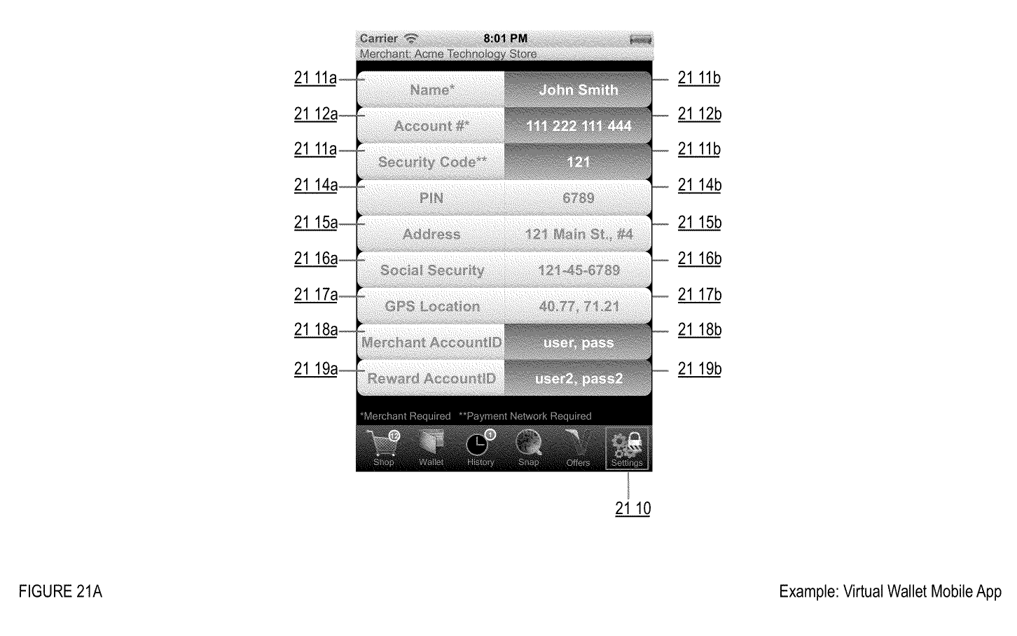

FIG. 20 shows a user interface diagram illustrating example features of virtual wallet applications, in an offers mode, in some embodiments of the GSS. In some implementations, the GSS may allow a user to search for offers for products and/or services from within the virtual wallet mobile application. For example, the user may enter text into a graphical user interface (“GUI”) element 2011, or issue voice commands by activating GUI element 2012 and speaking commands into the device. In some implementations, the GSS may provide offers based on the user's prior behavior, demographics, current location, current cart selection or purchase items, and/or the like. For example, if a user is in a brick-and-mortar store, or an online shopping website, and leaves the (virtual) store, then the merchant associated with the store may desire to provide a sweetener deal to entice the consumer back into the (virtual) store. The merchant may provide such an offer 2013. For example, the offer may provide a discount, and may include an expiry time. In some implementations, other users may provide gifts (e.g., 2014) to the user, which the user may redeem. In some implementations, the offers section may include alerts as to payment of funds outstanding to other users (e.g., 2015). In some implementations, the offers section may include alerts as to requesting receipt of funds from other users (e.g., 2016). For example, such a feature may identify funds receivable from other applications (e.g., mail, calendar, tasks, notes, reminder programs, alarm, etc.), or by a manual entry by the user into the virtual wallet application. In some implementations, the offers section may provide offers from participating merchants in the GSS, e.g., 2017-2019, 2020. These offers may sometimes be assembled using a combination of participating merchants, e.g., 2017. In some implementations, the GSS itself may provide offers for users contingent on the user utilizing particular payment forms from within the virtual wallet application, e.g., 2020.

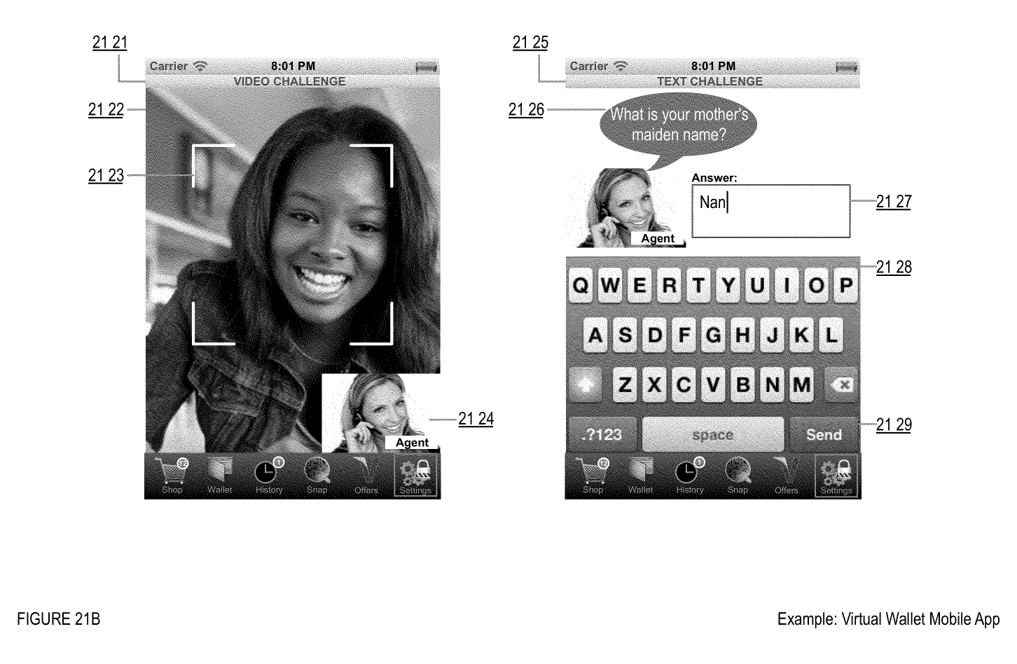

FIGS. 21A-B show user interface diagrams illustrating example features of virtual wallet applications, in a security and privacy mode, in some embodiments of the GSS. With reference to FIG. 21A, in some implementations, the user may be able to view and/or modify the user profile and/or settings of the user, e.g., by activating a user interface element. For example, the user may be able to view/modify a user name (e.g., 2111a-b), account number (e.g., 2112a-b), user security access code (e.g., 2113-b), user pin (e.g., 2114-b), user address (e.g., 2115-b), social security number associated with the user (e.g., 2116-b), current device GPS location (e.g., 2117-b), user account of the merchant in whose store the user currently is (e.g., 2118-b), the user's rewards accounts (e.g., 2119-b), and/or the like. In some implementations, the user may be able to select which of the data fields and their associated values should be transmitted to facilitate the purchase transaction, thus providing enhanced data security for the user. For example, in the example illustration in FIG. 21A, the user has selected the name 2111a, account number 2112a, security code 2113a, merchant account ID 2118a and rewards account ID 2119a as the fields to be sent as part of the notification to process the purchase transaction. In some implementations, the user may toggle the fields and/or data values that are sent as part of the notification to process the purchase transactions. In some implementations, the app may provide multiple screens of data fields and/or associated values stored for the user to select as part of the purchase order transmission. In some implementations, the app may provide the GSS with the GPS location of the user. Based on the GPS location of the user, the GSS may determine the context of the user (e.g., whether the user is in a store, doctor's office, hospital, postal service office, etc.). Based on the context, the user app may present the appropriate fields to the user, from which the user may select fields and/or field values to send as part of the purchase order transmission.

For example, a user may go to doctor's office and desire to pay the co-pay for doctor's appointment. In addition to basic transactional information such as account number and name, the app may provide the user the ability to select to transfer medical records, health information, which may be provided to the medical provider, insurance company, as well as the transaction processor to reconcile payments between the parties. In some implementations, the records may be sent in a Health Insurance Portability and Accountability Act (HIPAA)-compliant data format and encrypted, and only the recipients who are authorized to view such records may have appropriate decryption keys to decrypt and view the private user information.

With reference to FIG. 21B, in some implementations, the app executing on the user's device may provide a “VerifyChat” feature for fraud prevention. For example, the GSS may detect an unusual and/or suspicious transaction. The GSS may utilize the VerifyChat feature to communicate with the user, and verify the authenticity of the originator of the purchase transaction. In various implementations, the GSS may send electronic mail message, text (SMS) messages, Facebook® messages, Twitter™ tweets, text chat, voice chat, video chat (e.g., Apple FaceTime), and/or the like to communicate with the user. For example, the GSS may initiate a video challenge for the user, e.g., 2121. For example, the user may need to present him/her-self via a video chat, e.g., 2122. In some implementations, a customer service representative, e.g., agent 2124, may manually determine the authenticity of the user using the video of the user. In some implementations, the GSS may utilize face, biometric and/or like recognition (e.g., using pattern classification techniques) to determine the identity of the user. In some implementations, the app may provide reference marker (e.g., cross-hairs, target box, etc.), e.g., 2123, so that the user may the video to facilitate the GSS's automated recognition of the user. In some implementations, the user may not have initiated the transaction, e.g., the transaction is fraudulent. In such implementations, the user may cancel the challenge. The GSS may then cancel the transaction, and/or initiate fraud investigation procedures on behalf of the user.

In some implementations, the GSS may utilize a text challenge procedure to verify the authenticity of the user, e.g., 2125. For example, the GSS may communicate with the user via text chat, SMS messages, electronic mail, Facebook® messages, Twitter™ tweets, and/or the like. The GSS may pose a challenge question, e.g., 2126, for the user. The app may provide a user input interface element(s) (e.g., virtual keyboard 2128) to answer the challenge question posed by the GSS. In some implementations, the challenge question may be randomly selected by the GSS automatically; in some implementations, a customer service representative may manually communicate with the user. In some implementations, the user may not have initiated the transaction, e.g., the transaction is fraudulent. In such implementations, the user may cancel the text challenge. The GSS may cancel the transaction, and/or initiate fraud investigation on behalf of the user.

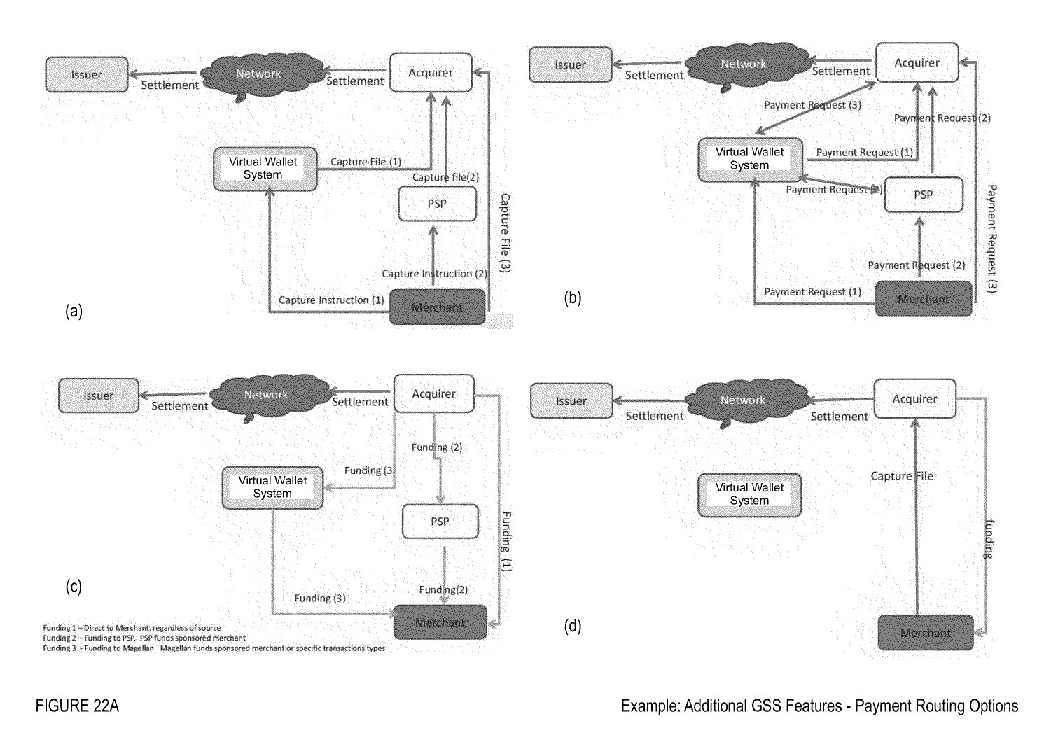

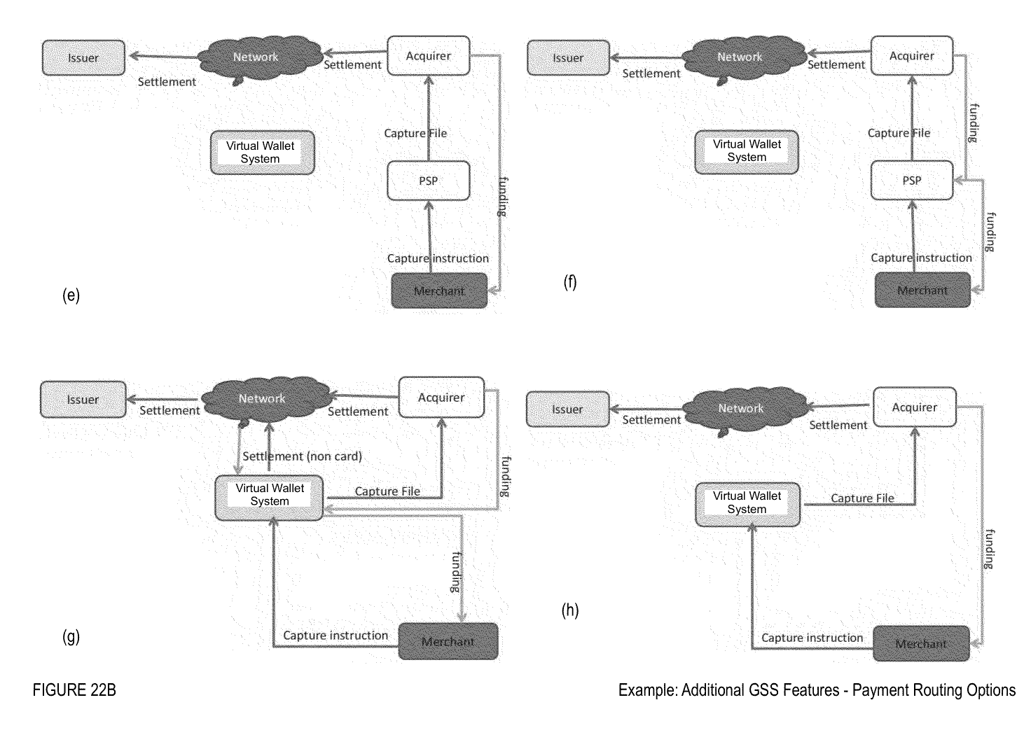

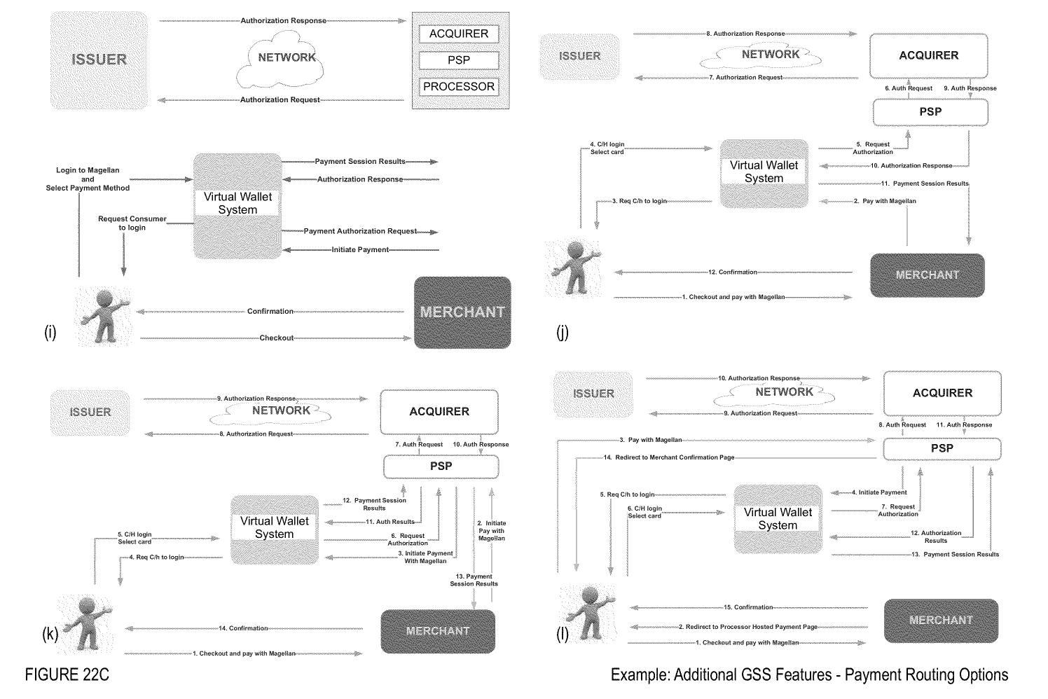

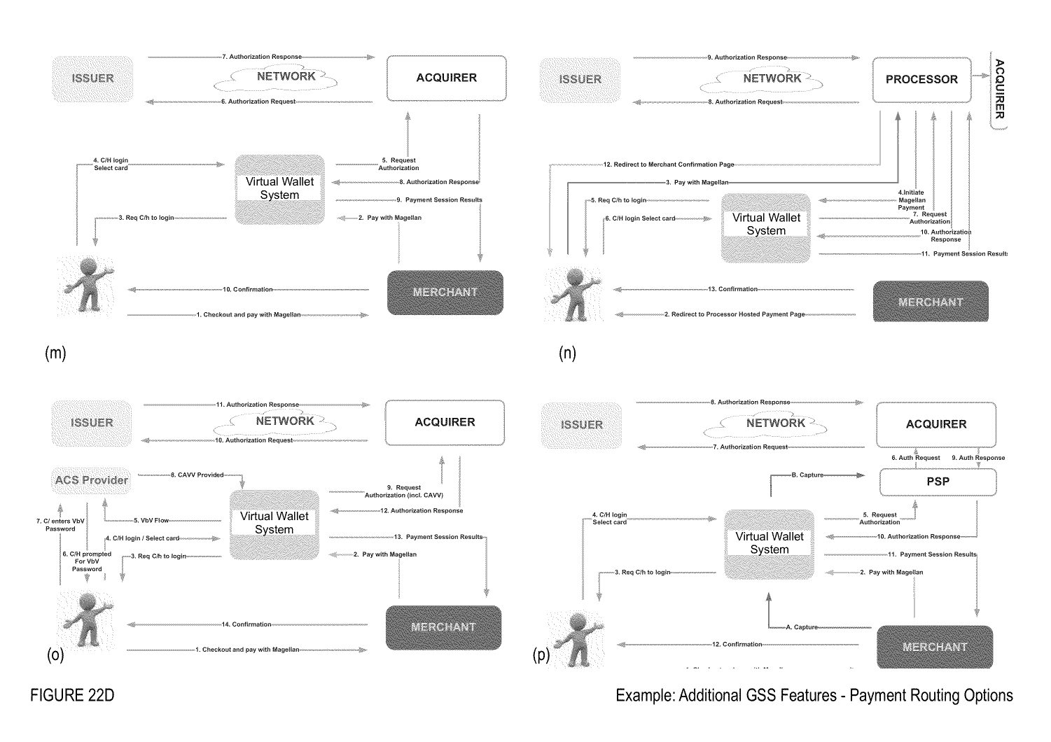

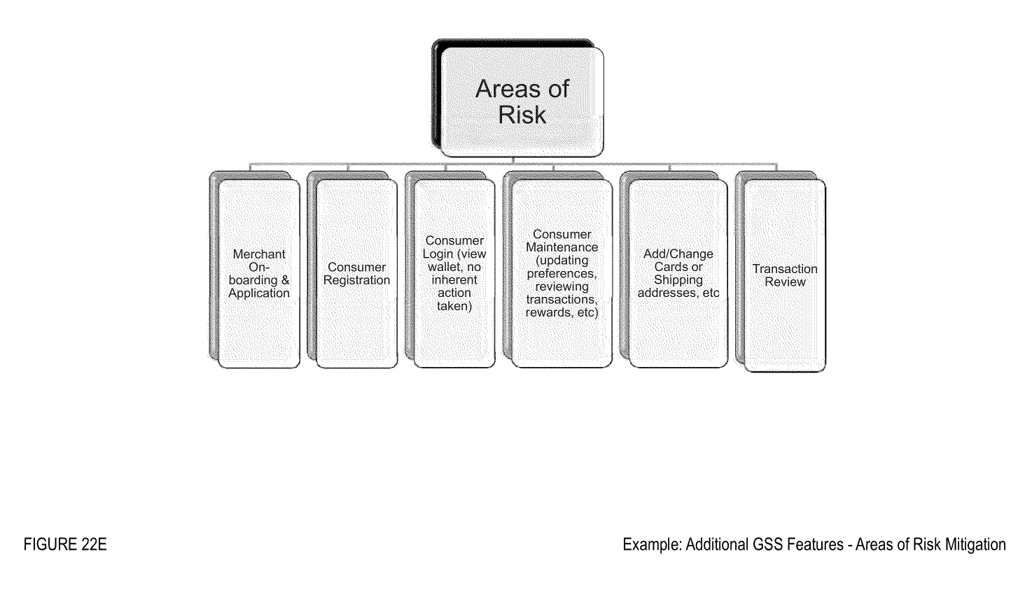

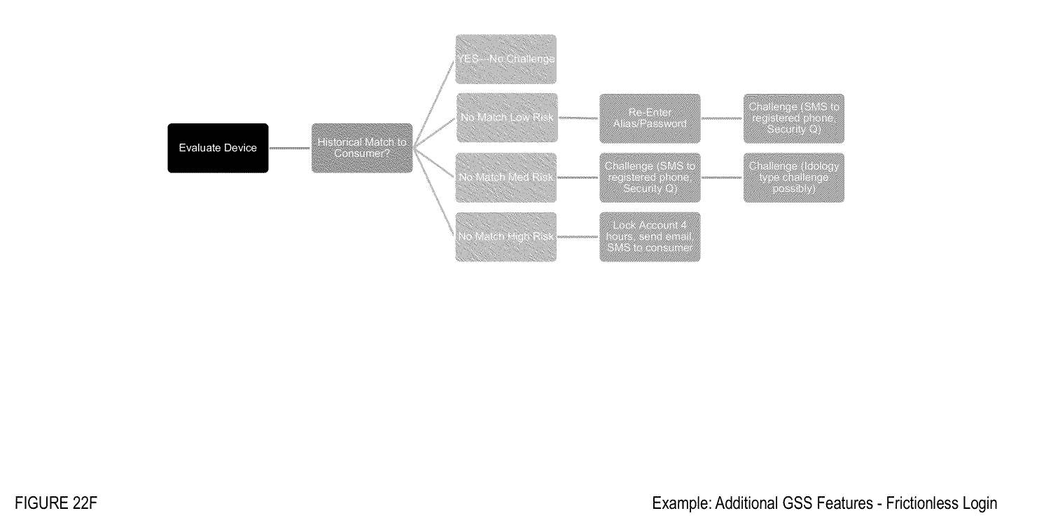

FIGS. 22A-F include example data flows, where the GSS may be effected, and illustrates various additional advantageous aspects of the GSS. With reference to FIGS. 22A-D, effectuation of the GSS may include additional example embodiments such as those depicted in sub-figures (a)-(p). With reference to FIG. 22E, in some embodiments, the GSS may apply graduated authentication and fraud review appropriate to the action being taken, and may thus mitigate risk in a variety of risk areas, as illustrated. With reference to FIG. 22F, in some embodiments, the GSS may provide graduated authentication-based consumer protection. Consumer registration may be graduated based on the source of the registration and the actions being taken. Some embodiments may reduce consumer enrollment friction using features such as Visa RightCliq. For example, a consumer registering from a participating issuer's website through a secure session may already have been screened by the issuer; in such implementations, the enrollment process may be less intrusive to the consumer than if they came directly to the enrollment site. The GSS may utilize tools to evaluate risk of a consumer including, without limitation, device firngerprint and IP geolocation information, consumer entered data including email address, consumer settings and consumer/virtual wallet interaction. For example, an example consumer login may be made frictionless—the GSS may vary authentication methods so that the consumer does not feel that they are being challenged every time they take an action.

### GSS Controller

FIG. 23 shows a block diagram illustrating example aspects of a GSS controller 2301. In this embodiment, the GSS controller 2301 may serve to aggregate, process, store, search, serve, identify, instruct, generate, match, and/or facilitate interactions with a computer through various technologies, and/or other related data.

Users, e.g., 2333a, which may be people and/or other systems, may engage information technology systems (e.g., computers) to facilitate information processing. In turn, computers employ processors to process information; such processors 2303 may be referred to as central processing units (CPU). One form of processor is referred to as a microprocessor. CPUs use communicative circuits to pass binary encoded signals acting as instructions to enable various operations. These instructions may be operational and/or data instructions containing and/or referencing other instructions and data in various processor accessible and operable areas of memory 2329 (e.g., registers, cache memory, random access memory, etc.). Such communicative instructions may be stored and/or transmitted in batches (e.g., batches of instructions) as programs and/or data components to facilitate desired operations. These stored instruction codes, e.g., programs, may engage the CPU circuit components and other motherboard and/or system components to perform desired operations. One type of program is a computer operating system, which, may be executed by CPU on a computer; the operating system enables and facilitates users to access and operate computer information technology and resources. Some resources that may be employed in information technology systems include: input and output mechanisms through which data may pass into and out of a computer; memory storage into which data may be saved; and processors by which information may be processed. These information technology systems may be used to collect data for later retrieval, analysis, and manipulation, which may be facilitated through a database program. These information technology systems provide interfaces that allow users to access and operate various system components.

In one embodiment, the GSS controller 2301 may be connected to and/or communicate with entities such as, but not limited to: one or more users from user input devices 2311; peripheral devices 2312; an optional cryptographic processor device 2328; and/or a communications network 2313. For example, the GSS controller 2301 may be connected to and/or communicate with users, e.g., 2333a, operating client device(s), e.g., 2333b, including, but not limited to, personal computer(s), server(s) and/or various mobile device(s) including, but not limited to, cellular telephone(s), smartphone(s) (e.g., iPhone®, Blackberry®, Android OS-based phones etc.), tablet computer(s) (e.g., Apple iPad™, HP Slate™, Motorola Xoom™, etc.), eBook reader(s) (e.g., Amazon Kindle™, Barnes and Noble's Nook™ eReader, etc.), laptop computer(s), notebook(s), netbook(s), gaming console(s) (e.g., XBOX Live™, Nintendo® DS, Sony PlayStation® Portable, etc.), portable scanner(s), and/or the like.

Networks are commonly thought to comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The GSS controller 2301 may be based on computer systems that may comprise, but are not limited to, components such as: a computer systemization 2302 connected to memory 2329.

### Computer Systemization

A computer systemization 2302 may comprise a clock 2330, central processing unit (“CPU(s)” and/or “processor(s)” (these terms are used interchangeably throughout the disclosure unless noted to the contrary)) 2303, a memory 2329 (e.g., a read only memory (ROM) 2306, a random access memory (RAM) 2305, etc.), and/or an interface bus 2307, and most frequently, although not necessarily, are all interconnected and/or communicating through a system bus 2304 on one or more (mother)board(s) 2302 having conductive and/or otherwise transportive circuit pathways through which instructions (e.g., binary encoded signals) may travel to effectuate communications, operations, storage, etc. The computer systemization may be connected to a power source 2386; e.g., optionally the power source may be internal. Optionally, a cryptographic processor 2326 and/or transceivers (e.g., ICs) 2374 may be connected to the system bus. In another embodiment, the cryptographic processor and/or transceivers may be connected as either internal and/or external peripheral devices via the interface bus I/O. In turn, the transceivers may be connected to antenna(s) 2375, thereby effectuating wireless transmission and reception of various communication and/or sensor protocols; for example the antenna(s) may connect to: a Texas Instruments WiLink WL1283 transceiver chip (e.g., providing 802.11n, Bluetooth 3.0, FM, global positioning system (GPS) (thereby allowing GSS controller to determine its location)); Broadcom BCM4329FKUBG transceiver chip (e.g., providing 802.11n, Bluetooth 2.1+EDR, FM, etc.), BCM28150 (HSPA+) and BCM2076 (Bluetooth 4.0, GPS, etc.); a Broadcom BCM47501UB8 receiver chip (e.g., GPS); an Infineon Technologies X-Gold 618-PMB9800 (e.g., providing 2G/3G HSDPA/HSUPA communications); Intel's XMM 7160 (LTE & DC-HSPA), Qualcom's CDMA(2000), Mobile Data/Station Modem, Snapdragon; and/or the like. The system clock may have a crystal oscillator and generates a base signal through the computer systemization's circuit pathways. The clock may be coupled to the system bus and various clock multipliers that will increase or decrease the base operating frequency for other components interconnected in the computer systemization. The clock and various components in a computer systemization drive signals embodying information throughout the system. Such transmission and reception of instructions embodying information throughout a computer systemization may be referred to as communications. These communicative instructions may further be transmitted, received, and the cause of return and/or reply communications beyond the instant computer systemization to: communications networks, input devices, other computer systemizations, peripheral devices, and/or the like. It should be understood that in alternative embodiments, any of the above components may be connected directly to one another, connected to the CPU, and/or organized in numerous variations employed as exemplified by various computer systems.

The CPU comprises at least one high-speed data processor adequate to execute program components for executing user and/or system-generated requests. Often, the processors themselves will incorporate various specialized processing units, such as, but not limited to: floating point units, integer processing units, integrated system (bus) controllers, logic operating units, memory management control units, etc., and even specialized processing sub-units like graphics processing units, digital signal processing units, and/or the like. Additionally, processors may include internal fast access addressable memory, and be capable of mapping and addressing memory 2329 beyond the processor itself; internal memory may include, but is not limited to: fast registers, various levels of cache memory (e.g., level 1, 2, 3, etc.), RAM, etc. The processor may access this memory through the use of a memory address space that is accessible via instruction address, which the processor can construct and decode allowing it to access a circuit path to a specific memory address space having a memory state/value. The CPU may be a microprocessor such as: AMD's Athlon, Duron and/or Opteron; ARM's classic (e.g., ARM7/9/11), embedded (Coretx-M/R), application (Cortex-A), embedded and secure processors; IBM and/or Motorola's DragonBall and PowerPC; IBM's and Sony's Cell processor; Intel's Atom, Celeron (Mobile), Core (2/Duo/i3/i5/i7), Itanium, Pentium, Xeon, and/or XScale; and/or the like processor(s). The CPU interacts with memory through instruction passing through conductive and/or transportive conduits (e.g., (printed) electronic and/or optic circuits) to execute stored instructions (i.e., program code). Such instruction passing facilitates communication within the GSS controller and beyond through various interfaces. Should processing requirements dictate a greater amount speed and/or capacity, distributed processors (e.g., Distributed GSS), mainframe, multi-core, parallel, and/or super-computer architectures may similarly be employed. Alternatively, should deployment requirements dictate greater portability, smaller mobile devices (e.g., smartphones, Personal Digital Assistants (PDAs), etc.) may be employed.

Depending on the particular implementation, features of the GSS may be achieved by implementing a microcontroller such as CAST's R8051XC2 microcontroller; Intel's MCS 51 (i.e., 8051 microcontroller); and/or the like. Also, to implement certain features of the GSS, some feature implementations may rely on embedded components, such as: Application-Specific Integrated Circuit (“ASIC”), Digital Signal Processing (“DSP”), Field Programmable Gate Array (“FPGA”), and/or the like embedded technology. For example, any of the GSS component collection (distributed or otherwise) and/or features may be implemented via the microprocessor and/or via embedded components; e.g., via ASIC, coprocessor, DSP, FPGA, and/or the like. Alternately, some implementations of the GSS may be implemented with embedded components that are configured and used to achieve a variety of features or signal processing.

Depending on the particular implementation, the embedded components may include software solutions, hardware solutions, and/or some combination of both hardware/software solutions. For example, GSS features discussed herein may be achieved through implementing FPGAs, which are a semiconductor devices containing programmable logic components called “logic blocks”, and programmable interconnects, such as the high performance FPGA Virtex series and/or the low cost Spartan series manufactured by Xilinx. Logic blocks and interconnects can be programmed by the customer or designer, after the FPGA is manufactured, to implement any of the GSS features. A hierarchy of programmable interconnects allow logic blocks to be interconnected as needed by the GSS system designer/administrator, somewhat like a one-chip programmable breadboard. An FPGA's logic blocks can be programmed to perform the operation of basic logic gates such as AND, and XOR, or more complex combinational operators such as decoders or simple mathematical operations. In most FPGAs, the logic blocks also include memory elements, which may be circuit flip-flops or more complete blocks of memory. In some circumstances, the GSS may be developed on regular FPGAs and then migrated into a fixed version that more resembles ASIC implementations. Alternate or coordinating implementations may migrate GSS controller features to a final ASIC instead of or in addition to FPGAs. Depending on the implementation all of the aforementioned embedded components and microprocessors may be considered the “CPU” and/or “processor” for the GSS.

### Power Source

The power source 2386 may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell 2386 is connected to at least one of the interconnected subsequent components of the GSS thereby providing an electric current to all the interconnected components. In one example, the power source 2386 is connected to the system bus component 2304. In an alternative embodiment, an outside power source 2386 is provided through a connection across the I/O 2308 interface. For example, a USB and/or IEEE 1394 connection carries both data and power across the connection and is therefore a suitable source of power.

### Interface Adapters

Interface bus(ses) 2307 may accept, connect, and/or communicate to a number of interface adapters, frequently, although not necessarily in the form of adapter cards, such as but not limited to: input output interfaces (I/O) 2308, storage interfaces 2309, network interfaces 2310, and/or the like. Optionally, cryptographic processor interfaces 2327 similarly may be connected to the interface bus. The interface bus provides for the communications of interface adapters with one another as well as with other components of the computer systemization. Interface adapters are adapted for a compatible interface bus. Interface adapters may connect to the interface bus via expansion and/or slot architecture. Various expansion and/or slot architectures may be employed, such as, but not limited to: Accelerated Graphics Port (AGP), Card Bus, ExpressCard, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), Thunderbolt, and/or the like.

Storage interfaces 2309 may accept, communicate, and/or connect to a number of storage devices such as, but not limited to: storage devices 2314, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, Ethernet, fiber channel, Small Computer Systems Interface (SCSI), Thunderbolt, Universal Serial Bus (USB), and/or the like.

Network interfaces 2310 may accept, communicate, and/or connect to a communications network 2313. Through a communications network 2313, the GSS controller is accessible through remote clients 2333b (e.g., computers with web browsers) by users 2333a. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. Should processing requirements dictate a greater amount speed and/or capacity, distributed network controllers (e.g., Distributed GSS), architectures may similarly be employed to pool, load balance, and/or otherwise increase the communicative bandwidth required by the GSS controller. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces 2310 may be used to engage with various communications network types 2313. For example, multiple network interfaces may be employed to allow for the communication over broadcast, multicast, and/or unicast networks.

Input Output interfaces (I/O) 2308 may accept, communicate, and/or connect to user input devices 2311, peripheral devices 2312, cryptographic processor devices 2328, and/or the like. I/O may employ connection protocols such as, but not limited to: audio: analog, digital, monaural, RCA, stereo, and/or the like; data: Apple Desktop Bus (ADB), Bluetooth, IEEE 1394a-b, serial, universal serial bus (USB); infrared; joystick; keyboard; midi; optical; PC AT; PS/2; parallel; radio; video interface: Apple Desktop Connector (ADC), BNC, coaxial, component, composite, digital, DisplayPort, Digital Visual Interface (DVI), high-definition multimedia interface (HDMI), RCA, RF antennae, S-Video, VGA, and/or the like; wireless transceivers: 802.11a/b/g/n/x; Bluetooth; cellular (e.g., code division multiple access (CDMA), high speed packet access (HSPA(+)), high-speed downlink packet access (HSDPA), global system for mobile communications (GSM), long term evolution (LTE), WiMax, etc.); and/or the like. One output device may be a video display, which may take the form of a Cathode Ray Tube (CRT), Liquid Crystal Display (LCD), Light Emitting Diode (LED), Organic Light Emitting Diode (OLED), Plasma, and/or the like based monitor with an interface (e.g., VGA, DVI circuitry and cable) that accepts signals from a video interface. The video interface composites information generated by a computer systemization and generates video signals based on the composited information in a video memory frame. Another output device is a television set, which accepts signals from a video interface. Often, the video interface provides the composited video information through a video connection interface that accepts a video display interface (e.g., an RCA composite video connector accepting an RCA composite video cable; a DVI connector accepting a DVI display cable, HDMI, etc.).

User input devices 2311 often are a type of peripheral device 2312 (see below) and may include: card readers, dongles, finger print readers, gloves, graphics tablets, joysticks, keyboards, microphones, mouse (mice), remote controls, retina readers, touch screens (e.g., capacitive, resistive, etc.), trackballs, trackpads, sensors (e.g., accelerometers, ambient light, GPS, gyroscopes, proximity, etc.), styluses, and/or the like.

Peripheral devices 2312 may be connected and/or communicate to I/O and/or other facilities of the like such as network interfaces, storage interfaces, directly to the interface bus, system bus, the CPU, and/or the like. Peripheral devices may be external, internal and/or part of the GSS controller. Peripheral devices may include: antenna, audio devices (e.g., line-in, line-out, microphone input, speakers, etc.), cameras (e.g., still, video, webcam, etc.), dongles (e.g., for copy protection, ensuring secure transactions with a digital signature, and/or the like), external processors (for added capabilities; e.g., crypto devices 2328), force-feedback devices (e.g., vibrating motors), near field communication (NFC) devices, network interfaces, printers, radio frequency identifiers (RFIDs), scanners, storage devices, transceivers (e.g., cellular, GPS, etc.), video devices (e.g., goggles, monitors, etc.), video sources, visors, and/or the like. Peripheral devices often include types of input devices (e.g., microphones, cameras, etc.).

It should be noted that although user input devices and peripheral devices may be employed, the GSS controller may be embodied as an embedded, dedicated, and/or monitor-less (i.e., headless) device, wherein access would be provided over a network interface connection.

Cryptographic units such as, but not limited to, microcontrollers, processors 2326, interfaces 2327, and/or devices 2328 may be attached, and/or communicate with the GSS controller. A MC68HC16 microcontroller, manufactured by Motorola Inc., may be used for and/or within cryptographic units. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of the CPU. Equivalent microcontrollers and/or processors may also be used. Other commercially available specialized cryptographic processors include: the Broadcom's CryptoNetX and other Security Processors; nCipher's nShield (e.g., Solo, Connect, etc.), SafeNet's Luna PCI (e.g., 7100) series; Semaphore Communications' 40 MHz Roadrunner 184; sMIP's (e.g., 208956); Sun's Cryptographic Accelerators (e.g., Accelerator 6000 PCIe Board, Accelerator 500 Daughtercard); Via Nano Processor (e.g., L2100, L2200, U2400) line, which is capable of performing 500+MB/s of cryptographic instructions; VLSI Technology's 33 MHz 6868; and/or the like.

### Memory

Generally, any mechanization and/or embodiment allowing a processor to affect the storage and/or retrieval of information is regarded as memory 2329. However, memory is a fungible technology and resource, thus, any number of memory embodiments may be employed in lieu of or in concert with one another. It is to be understood that the GSS controller and/or a computer systemization may employ various forms of memory 2329. For example, a computer systemization may be configured wherein the operation of on-chip CPU memory (e.g., registers), RAM, ROM, and any other storage devices are provided by a paper punch tape or paper punch card mechanism; however, such an embodiment would result in an extremely slow rate of operation. In one configuration, memory 2329 may include ROM 2306, RAM 2305, and a storage device 2314. A storage device 2314 may employ any number of computer storage devices/systems. Storage devices may include a drum; a (fixed and/or removable) magnetic disk drive; a magneto-optical drive; an optical drive (i.e., Blueray, CD ROM/RAM/Recordable (R)/ReWritable (RW), DVD R/RW, HD DVD R/RW etc.); an array of devices (e.g., Redundant Array of Independent Disks (RAID)); solid state memory devices (USB memory, solid state drives (SSD), etc.); other processor-readable storage mediums; and/or other devices of the like. Thus, a computer systemization generally requires and makes use of memory.

### Component Collection

The memory 2329 may contain a collection of program and/or database components and/or data such as, but not limited to: operating system component(s) 2315 (operating system); information server component(s) 2316 (information server); user interface component(s) 2317 (user interface); Web browser component(s) 2318 (Web browser); database(s) 2319; mail server component(s) 2321; mail client component(s) 2322; cryptographic server component(s) 2320 (cryptographic server); the GSS component(s) 2335; and/or the like (i.e., collectively a component collection). These components may be stored and accessed from the storage devices and/or from storage devices accessible through an interface bus. Although non-conventional program components such as those in the component collection may be stored in a local storage device 2314, they may also be loaded and/or stored in memory such as: peripheral devices, RAM, remote storage facilities through a communications network, ROM, various forms of memory, and/or the like.

### Operating System

The operating system component 2315 is an executable program component facilitating the operation of the GSS controller. The operating system may facilitate access of I/O, network interfaces, peripheral devices, storage devices, and/or the like. The operating system may be a highly fault tolerant, scalable, and secure system such as: Apple Macintosh OS X (Server); AT&T Plan 9; Be OS; Unix and Unix-like system distributions (such as AT&T's UNIX; Berkley Software Distribution (BSD) variations such as FreeBSD, NetBSD, OpenBSD, and/or the like; Linux distributions such as Red Hat, Ubuntu, and/or the like); and/or the like operating systems. However, more limited and/or less secure operating systems also may be employed such as Apple Macintosh OS, IBM OS/2, Microsoft DOS, Microsoft Windows 2000/2003/3.1/95/98/CE/Millenium/NT/Vista/XP (Server), Palm OS, and/or the like. In addition, emobile operating systems such as Apple's iOS, Google's Android, Hewlett Packard's WebOS, Microsofts Windows Mobile, and/or the like may be employed. Any of these operating systems may be embedded within the hardware of the NICK controller, and/or stored/loaded into memory/storage. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the GSS controller to communicate with other entities through a communications network 2313. Various communication protocols may be used by the GSS controller as a subcarrier transport mechanism for interaction, such as, but not limited to: multicast, TCP/IP, UDP, unicast, and/or the like.

### Information Server

An information server component 2316 is a stored program component that is executed by a CPU. The information server may be an Internet information server such as, but not limited to Apache Software Foundation's Apache, Microsoft's Internet Information Server, and/or the like. The information server may allow for the execution of program components through facilities such as Active Server Page (ASP), ActiveX, (ANSI) (Objective-) C (++), C# and/or .NET, Common Gateway Interface (CGI) scripts, dynamic (D) hypertext markup language (HTML), FLASH, Java, JavaScript, Practical Extraction Report Language (PERL), Hypertext Pre-Processor (PHP), pipes, Python, wireless application protocol (WAP), WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), messaging protocols (e.g., America Online (AOL) Instant Messenger (AIM), Apple's iMessage, Application Exchange (APEX), ICQ, Internet Relay Chat (IRC), Microsoft Network (MSN) Messenger Service, Presence and Instant Messaging Protocol (PRIM), Internet Engineering Task Force's (IETF's) Session Initiation Protocol (SIP), SIP for Instant Messaging and Presence Leveraging Extensions (SIMPLE), open XML-based Extensible Messaging and Presence Protocol (XMPP) (i.e., Jabber or Open Mobile Alliance's (OMA's) Instant Messaging and Presence Service (IMPS)), Yahoo! Instant Messenger Service, and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the GSS controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 21, and/or the like. An information server may communicate to and/or with other components in a component collection, including itself, and/or facilities of the like. Most frequently, the information server communicates with the GSS database 2319, operating systems, other program components, user interfaces, Web browsers, and/or the like.

Access to the GSS database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the GSS. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the GSS as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

### User Interface

Computer interfaces in some respects are similar to automobile operation interfaces. Automobile operation interface elements such as steering wheels, gearshifts, and speedometers facilitate the access, operation, and display of automobile resources, and status. Computer interaction interface elements such as check boxes, cursors, menus, scrollers, and windows (collectively and commonly referred to as widgets) similarly facilitate the access, capabilities, operation, and display of data and computer hardware and operating system resources, and status. Operation interfaces are commonly called user interfaces. Graphical user interfaces (GUIs) such as the Apple Macintosh Operating System's Aqua and iOS's Cocoa Touch, IBM's OS/2, Google's Android Mobile UI, Microsoft's Windows 2000/2003/3.1/95/98/CE/Millenium/Mobile/NT/XP/Vista/7/8 (i.e., Aero, Metro), Unix's X-Windows (e.g., which may include additional Unix graphic interface libraries and layers such as K Desktop Environment (KDE), mythTV and GNU Network Object Model Environment (GNOME)), web interface libraries (e.g., ActiveX, AJAX, (D)HTML, FLASH, Java, JavaScript, etc. interface libraries such as, but not limited to, Dojo, jQuery(UI), MooTools, Prototype, script.aculo.us, SWFObject, Yahoo! User Interface, any of which may be used and) provide a baseline and means of accessing and displaying information graphically to users.

A user interface component 2317 is a stored program component that is executed by a CPU. The user interface may be a graphic user interface as provided by, with, and/or atop operating systems and/or operating environments such as already discussed. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

### Web Browser

A Web browser component 2318 is a stored program component that is executed by a CPU. The Web browser may be a hypertext viewing application such as Goofle's (Mobile) Chrome, Microsoft Internet Explorer, Netscape Navigator, Apple's (Mobile) Safari, embedded web browser objects such as through Apple's Cocoa (Touch) object class, and/or the like. Secure Web browsing may be supplied with 128 bit (or greater) encryption by way of HTTPS, SSL, and/or the like. Web browsers allowing for the execution of program components through facilities such as ActiveX, AJAX, (D)HTML, FLASH, Java, JavaScript, web browser plug-in APIs (e.g., Chrome, FireFox, Internet Explorer, Safari Plug-in, and/or the like APIs), and/or the like. Web browsers and like information access tools may be integrated into PDAs, cellular telephones, smartphones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Also, in place of a Web browser and information server, a combined application may be developed to perform similar operations of both. The combined application would similarly effect the obtaining and the provision of information to users, user agents, and/or the like from the GSS equipped nodes. The combined application may be nugatory on systems employing standard Web browsers.

### Mail Server

A mail server component 2321 is a stored program component that is executed by a CPU 2303. The mail server may be an Internet mail server such as, but not limited to Apple's Mail Server (3), dovect, sendmail, Microsoft Exchange, and/or the like. The mail server may allow for the execution of program components through facilities such as ASP, ActiveX, (ANSI) (Objective-) C (++), C# and/or .NET, CGI scripts, Java, JavaScript, PERL, PHP, pipes, Python, WebObjects, and/or the like. The mail server may support communications protocols such as, but not limited to: Internet message access protocol (IMAP), Messaging Application Programming Interface (MAPI)/Microsoft Exchange, post office protocol (POP3), simple mail transfer protocol (SMTP), and/or the like. The mail server can route, forward, and process incoming and outgoing mail messages that have been sent, relayed and/or otherwise traversing through and/or to the GSS.

Access to the GSS mail may be achieved through a number of APIs offered by the individual Web server components and/or the operating system.

Also, a mail server may contain, communicate, generate, obtain, and/or provide program component, system, user, and/or data communications, requests, information, and/or responses.

### Mail Client

A mail client component 2322 is a stored program component that is executed by a CPU 2303. The mail client may be a mail viewing application such as Apple (Mobile) Mail, Microsoft Entourage, Microsoft Outlook, Microsoft Outlook Express, Mozilla, Thunderbird, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

### Cryptographic Server

A cryptographic server component 2320 is a stored program component that is executed by a CPU 2303, cryptographic processor 2326, cryptographic processor interface 2327, cryptographic processor device 2328, and/or the like. Cryptographic processor interfaces will allow for expedition of encryption and/or decryption requests by the cryptographic component; however, the cryptographic component, alternatively, may run on a CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash operation), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the GSS may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for an digital audio file. A cryptographic component may communicate to and/or with other components in a component collection, including itself, and/or facilities of the like. The cryptographic component supports encryption schemes allowing for the secure transmission of information across a communications network to enable the GSS component to engage in secure transactions if so desired. The cryptographic component facilitates the secure accessing of resources on the GSS and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

### The GSS Database

The GSS database component 2319 may be embodied in a database and its stored data. The database is a stored program component, which is executed by the CPU; the stored program component portion configuring the CPU to process the stored data. The database may be any of a number of fault tolerant, relational, scalable, secure databases, such as DB2, MySQL, Oracle, Sybase, and/or the like. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the GSS database may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of capabilities encapsulated within a given object. If the GSS database is implemented as a data-structure, the use of the GSS database 2319 may be integrated into another component such as the GSS component 2335. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the database component 2319 includes several tables 2319a-r. A Users table 2319a may include fields such as, but not limited to: user_id, ssn, dob, first_name, last_name, age, state, address_firstline, address_secondline, zipcode, devices_list, contact_info, contact_type, alt_contact_info, alt_contact_type, and/or the like. The Users table may support and/or track multiple entity accounts on a GSS. A Devices table 2319b may include fields such as, but not limited to: device_ID, device_name, device_IP, device_GPS, device_MAC, device_serial, device_ECID, device_UDID, device_browser, device_type, device_model, device_version, device_OS, device_apps_list, device_securekey, wallet_app_installed_flag, and/or the like. An Apps table 2319c may include fields such as, but not limited to: app_ID, app_name, app_type, app_dependencies, app_access_code, user_pin, and/or the like. An Accounts table 2319d may include fields such as, but not limited to: account_number, account_security_code, account_name, issuer_acquirer_flag, issuer_name, acquirer_name, account_address, routing_number, access_API_call, linked_wallets_list, and/or the like. A Merchants table 2319e may include fields such as, but not limited to: merchant_id, merchant_name, merchant_address, store_id, ip_address, mac_address, auth_key, port_num, security_settings_list, and/or the like. An Issuers table 2319f may include fields such as, but not limited to: issuer_id, issuer_name, issuer_address, ip_address, mac_address, auth_key, port_num, security_settings_list, and/or the like. An Acquirers table 2319g may include fields such as, but not limited to: account_firstname, account_lastname, account_type, account_num, account_balance list, billingaddress_line1, billingaddress_line2, billing_zipcode, billing_state, shipping_preferences, shippingaddress_line1, shippingaddress_line2, shipping_zipcode, shipping_state, and/or the like. A Pay Gateways table 2319h may include fields such as, but not limited to: gateway_ID, gateway_IP, gateway_MAC, gateway_secure_key, gateway_access_list, gateway_API_call_list, gateway_services_list, and/or the like. A Shop Sessions table 2319i may include fields such as, but not limited to: user_id, session_id, alerts_URL, timestamp, expiry_lapse, merchant_id, store_id, device_type, device_ID, device_IP, device_MAC, device_browser, device_serial, device_ECID, device_model, device_OS, wallet_app_installed, total_cost, cart_ID list, product_params_list, social_flag, social_message, social_networks_list, coupon_lists, accounts_list, CVV2_lists, charge_ratio_list, charge_priority_list, value_exchange_symbols_list, bill_address, ship_address, cloak_flag, pay_mode, alerts_rules_list, and/or the like. A Transactions table 2319j may include fields such as, but not limited to: order_id, user_id, timestamp, transaction_cost, purchase_details_list, num_products, products_list, product_type, product_params_list, product_title, product_summary, quantity, user_id, client_id, client_ip, client_type, client_model, operating_system, os_version, app_installed_flag, user_id, account_firstname, account_lastname, account_type, account_num, account_priority_account_ratio, billingaddress_line1, billingaddress_line2, billing_zipcode, billing_state, shipping_preferences, shippingaddress_line1, shippingaddress_line2, shipping_zipcode, shipping_state, merchant_id, merchant_name, merchant_auth_key, and/or the like. A Batches table 2319k may include fields such as, but not limited to: batch_id, transaction_id_list, timestamp_list, cleared_flag_list, clearance_trigger_settings, and/or the like. A Ledgers table 2319l may include fields such as, but not limited to: request_id, timestamp, deposit_amount, batch_id, transaction_id, clear_flag, deposit_account, transaction_summary, payor_name, payor_account, and/or the like. A Products table 2319m may include fields such as, but not limited to: product_ID, product_title, product_attributes_list, product_price, tax_info_list, related_products_list, offers_list, discounts_list, rewards_list, merchants_list, merchant_availability_list, and/or the like. An Offers table 2319n may include fields such as, but not limited to: offer_ID, offer_title, offer_attributes_list, offer_price, offer_expiry, related_products_list, discounts_list, rewards_list, merchants_list, merchant_availability_list, and/or the like. A Behavior Data table 23190 may include fields such as, but not limited to: user_id, timestamp, activity_type, activity_location, activity_attribute_list, activity_attribute_values_list, and/or the like. An Analytics table 2319p may include fields such as, but not limited to: report_id, user_id, report_type, report_algorithm_id, report_destination_address, and/or the like. A Fraud Reports table 2319q may include fields such as, but not limited to: report_id, user_id, session_id, merchant_id, fraud_type, fraud_description, products_list, transaction_cost, timestamp, contact_info, and/or the like. A Risk Rules table 2319r may include fields such as, but not limited to: rule_id, risk_type, transaction_type, rule_elements, rule_inputs, rule_processing, rule_outputs, rule_threshold, geo_scope, last_updated, and/or the like. An Escalation Rules table 2319s may include fields such as, but not limited to: rule_id, risk_type, transaction_type, entity_type, rule_elements, rule_inputs, rule_processing, rule_outputs, rule_thresholds_list, geo_scope, last_updated, and/or the like.

In one embodiment, the GSS database may interact with other database systems. For example, employing a distributed database system, queries and data access by search GSS component may treat the combination of the GSS database, an integrated data security layer database as a single database entity.

In one embodiment, user programs may contain various user interface primitives, which may serve to update the GSS. Also, various accounts may require custom database tables depending upon the environments and the types of clients the GSS may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components 2319a-r. The GSS may be configured to keep track of various settings, inputs, and parameters via database controllers.

The GSS database may communicate to and/or with other components in a component collection, including itself, and/or facilities of the like. Most frequently, the GSS database communicates with the GSS component, other program components, and/or the like. The database may contain, retain, and provide information regarding other nodes and data.

### The GSSs

The GSS component 2335 is a stored program component that is executed by a CPU. In one embodiment, the GSS component incorporates any and/or all combinations of the aspects of the GSS discussed in the previous figures. As such, the GSS affects accessing, obtaining and the provision of information, services, transactions, and/or the like across various communications networks. The features and embodiments of the GSS discussed herein increase network efficiency by reducing data transfer requirements the use of more efficient data structures and mechanisms for their transfer and storage. As a consequence, more data may be transferred in less time, and latencies with regard to transactions, are also reduced. In many cases, such reduction in storage, transfer time, bandwidth requirements, latencies, etc., will reduce the capacity and structural infrastructure requirements to support the GSS's features and facilities, and in many cases reduce the costs, energy consumption/requirements, and extend the life of GSS's underlying infrastructure; this has the added benefit of making the GSS more reliable. Similarly, many of the features and mechanisms are designed to be easier for users to use and access, thereby broadening the audience that may enjoy/employ and exploit the feature sets of the GSS; such ease of use also helps to increase the reliability of the GSS. In addition, the feature sets include heightened security as noted via the Cryptographic components 2320, 2326, 2328 and throughout, making access to the features and data more reliable and secure.

The GSS component may transform user virtual wallet activity and historical fraud reports via GSS components into transaction authorization triggers generated pursuant to graduated, transaction risk-appropriate, escalated security protocols, and/or the like and use of the GSS. In one embodiment, the GSS component 2335 takes inputs (e.g., current transaction request/security input 211; historical wallet activity data 212; historical wallet fraud data reports 213; transaction risk allocation offer acceptance 220; wallet activity 311; fraud report request input 511; fraud report form 514; fraud report form input 517; checkout request 911; product data 915; wallet access input 1111; transaction authorization input 1114; payment gateway address 1118; payment network address 1122; issuer server address(es) 1125; funds authorization request(s) 1126; user(s) account(s) data 1128; batch data 1312; payment network address 1316; issuer server address(es) 1324; individual payment request 1325; payment ledger, merchant account data 1331; and/or the like) etc., and transforms the inputs via various components (e.g., GSPE 2348; TRA 2347; SRA 2346; FDR 2345; UWAR 2344; UPC 2341; PTA 2342; PTC 2343; and/or the like), into outputs (e.g., transaction risk assessment data/rules 215; risk types/risk scores 217; transaction risk allocation offers 219; transaction authorization 226; transaction denial 225; security data request 224; user wallet activity record 314-315; fraud report data record 519; checkout request message 913; checkout data 917; card authorization request 1116, 1123; funds authorization response(s) 1130; transaction authorization response 1132; batch append data 1134; purchase receipt 1135; batch clearance request 1314; batch payment request 1318; transaction data 1320; individual payment confirmation 1328, 1329; updated payment ledger, merchant account data 1333; and/or the like).

The GSS component enabling access of information between nodes may be developed by employing standard development tools and languages such as, but not limited to: Apache components, Assembly, ActiveX, binary executables, (ANSI) (Objective-) C (++), C# and/or .NET, database adapters, CGI scripts, Java, JavaScript, mapping tools, procedural and object oriented development tools, PERL, PHP, Python, shell scripts, SQL commands, web application server extensions, web development environments and libraries (e.g., Microsoft's ActiveX; Adobe AIR, FLEX & FLASH; AJAX; (D)HTML; Dojo, Java; JavaScript; jQuery(UI); MooTools; Prototype; script.aculo.us; Simple Object Access Protocol (SOAP); SWFObject; Yahoo! User Interface; and/or the like), WebObjects, and/or the like. In one embodiment, the GSS server employs a cryptographic server to encrypt and decrypt communications. The GSS component may communicate to and/or with other components in a component collection, including itself, and/or facilities of the like. Most frequently, the GSS component communicates with the GSS database, operating systems, other program components, and/or the like. The GSS may contain, communicate, generate, obtain, and/or provide program component, system, user, and/or data communications, requests, and/or responses.

### Distributed GSSs

The structure and/or operation of any of the GSS node controller components may be combined, consolidated, and/or distributed in any number of ways to facilitate development and/or deployment. Similarly, the component collection may be combined in any number of ways to facilitate deployment and/or development. To accomplish this, one may integrate the components into a common code base or in a facility that can dynamically load the components on demand in an integrated fashion.

The component collection may be consolidated and/or distributed in countless variations through standard data processing and/or development techniques. Multiple instances of any one of the program components in the program component collection may be instantiated on a single node, and/or across numerous nodes to improve performance through load-balancing and/or data-processing techniques. Furthermore, single instances may also be distributed across multiple controllers and/or storage devices; e.g., databases. All program component instances and controllers working in concert may do so through standard data processing communication techniques.

The configuration of the GSS controller will depend on the context of system deployment. Factors such as, but not limited to, the budget, capacity, location, and/or use of the underlying hardware resources may affect deployment requirements and configuration. Regardless of if the configuration results in more consolidated and/or integrated program components, results in a more distributed series of program components, and/or results in some combination between a consolidated and distributed configuration, data may be communicated, obtained, and/or provided. Instances of components consolidated into a common code base from the program component collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like.

If component collection components are discrete, separate, and/or external to one another, then communicating, obtaining, and/or providing data with and/or to other components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), Jini local and remote application program interfaces, JavaScript Object Notation (JSON), Remote Method Invocation (RMI), SOAP, process pipes, shared files, and/or the like. Messages sent between discrete component components for inter-application communication or within memory spaces of a singular component for intra-application communication may be facilitated through the creation and parsing of a grammar. A grammar may be developed by using development tools such as lex, yacc, XML, and/or the like, which allow for grammar generation and parsing capabilities, which in turn may form the basis of communication messages within and between components.

For example, a grammar may be arranged to recognize the tokens of an HTTP post command, e.g.:

w3c -post http://... Value1

where Value1 is discerned as being a parameter because “http://” is part of the grammar syntax, and what follows is considered part of the post value. Similarly, with such a grammar, a variable “Value1” may be inserted into an “http://” post command and then sent. The grammar syntax itself may be presented as structured data that is interpreted and/or otherwise used to generate the parsing mechanism (e.g., a syntax description text file as processed by lex, yacc, etc.). Also, once the parsing mechanism is generated and/or instantiated, it itself may process and/or parse structured data such as, but not limited to: character (e.g., tab) delineated text, HTML, structured text streams, XML, and/or the like structured data. In another embodiment, inter-application data processing protocols themselves may have integrated and/or readily available parsers (e.g., JSON, SOAP, and/or like parsers) that may be employed to parse (e.g., communications) data. Further, the parsing grammar may be used beyond message parsing, but may also be used to parse: databases, data collections, data stores, structured data, and/or the like. Again, the desired configuration will depend upon the context, environment, and requirements of system deployment.

For example, in some implementations, the GSS controller may be executing a PHP script implementing a Secure Sockets Layer (“SSL”) socket server via the information server, which listens to incoming communications on a server port to which a client may send data, e.g., data encoded in JSON format. Upon identifying an incoming communication, the PHP script may read the incoming message from the client device, parse the received JSON-encoded text data to extract information from the JSON-encoded text data into PHP script variables, and store the data (e.g., client identifying information, etc.) and/or extracted information in a relational database accessible using the Structured Query Language (“SQL”). An exemplary listing, written substantially in the form of PHP/SQL commands, to accept JSON-encoded input data from a client device via a SSL connection, parse the data to extract variables, and store the data to a database, is provided below:

```
<?PHP
header(‘Content-Type: text/plain’);
// set ip address and port to listen to for incoming data
$address = ‘192.168.0.100’;
$port = 255;
// create a server-side SSL socket, listen for/accept incoming
communication
$sock = socket_create(AF_INET, SOCK_STREAM, 0);
socket_bind($sock, $address, $port) or die(‘Could not bind to address’);
socket_listen($sock);
$client = socket_accept($sock);
// read input data from client device in 1024 byte blocks until end of
message
do {
  $input = “”;
  $input = socket_read($client, 1024);
  $data .= $input;
} while($input != “”);
// parse data to extract variables
$obj = json_decode($data, true);
// store input data in a database
mysql_connect(“201.408.185.132”,$DBserver,$password); // access
database server
mysql_select(“CLIENT_DB.SQL”); // select database to append
mysql_query(“INSERT INTO UserTable (transmission)
VALUES ($data)”); // add data to UserTable table in a CLIENT database
mysql_close(“CLIENT_DB.SQL”); // close connection to database
?>
```

Also, the following resources may be used to provide example embodiments regarding SOAP parser implementation:

http://www.xav.com/perl/site/lib/SOAP/Parser.html
http://publib.boulder.ibm.com/infocenter/tivihelp/v2r1/index.jsp?topic=/
com.ibm.IBMDI.doc/referenceguide295.htm

and other parser implementations:

http://publib.boulder.ibm.com/infocenter/tivihelp/v2r1/index.jsp?topic=/
com.ibm.IBMDI.doc/referenceguide259.htm

all of which are hereby expressly incorporated by reference herein.

In order to address various issues and advance the art, the entirety of this application for GRADUATED SECURITY SEASONING APPARATUSES, METHODS AND SYSTEMS (including the Cover Page, Title, Headings, Field, Background, Summary, Brief Description of the Drawings, Detailed Description, Claims, Abstract, Figures, Appendices and/or otherwise) shows by way of illustration various example embodiments in which the claimed innovations may be practiced. The advantages and features of the application are of a representative sample of embodiments only, and are not exhaustive and/or exclusive. They are presented only to assist in understanding and teach the claimed principles. It should be understood that they are not representative of all claimed innovations. As such, certain aspects of the disclosure have not been discussed herein. That alternate embodiments may not have been presented for a specific portion of the innovations or that further undescribed alternate embodiments may be available for a portion is not to be considered a disclaimer of those alternate embodiments. It will be appreciated that many of those undescribed embodiments incorporate the same principles of the innovations and others are equivalent. Thus, it is to be understood that other embodiments may be utilized and functional, logical, operational, organizational, structural and/or topological modifications may be made without departing from the scope and/or spirit of the disclosure. As such, all examples and/or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any data flow sequence(s), program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure. Furthermore, it is to be understood that such features are not limited to serial execution, but rather, any number of threads, processes, processors, services, servers, and/or the like that may execute asynchronously, concurrently, in parallel, simultaneously, synchronously, and/or the like are also contemplated by the disclosure. As such, some of these features may be mutually contradictory, in that they cannot be simultaneously present in a single embodiment. Similarly, some features are applicable to one aspect of the innovations, and inapplicable to others. In addition, the disclosure includes other innovations not presently claimed. Applicant reserves all rights in those presently unclaimed innovations, including the right to claim such innovations, file additional applications, continuations, continuations-in-part, divisions, and/or the like thereof. As such, it should be understood that advantages, embodiments, examples, functional, features, logical, operational, organizational, structural, topological, and/or other aspects of the disclosure are not to be considered limitations on the disclosure as defined by the claims or limitations on equivalents to the claims. It is to be understood that, depending on the particular needs and/or characteristics of a GSS individual and/or enterprise user, database configuration and/or relational model, data type, data transmission and/or network framework, syntax structure, and/or the like, various embodiments of the GSS may be implemented that allow a great deal of flexibility and customization. For example, aspects of the GSS may be adapted for building management, resource management, collaborative document production security, and/or like security systems. While various embodiments and discussions of the GSS have been directed to electronic security, however, it is to be understood that the embodiments described herein may be readily configured and/or customized for a wide variety of other applications and/or implementations.

What is claimed is:

1. A graduated security protocol escalation processor-implemented method, comprising:
obtaining a current transaction request, the current transaction request utilizing a user virtual wallet account for purchase payment;
identifying a transaction risk type associated with the current transaction request;
calculating, via a processor, a transaction risk level associated with the transaction risk type;
selecting a security protocol, based on the calculated transaction risk level, for processing the current transaction request; and
providing a security data request in accordance with the selected security protocol.

2. The method of claim 1, further comprising:
obtaining data on prior user wallet activity associated with the user virtual wallet account from a database; and
wherein the transaction risk type is identified using the data on the prior user wallet activity.

3. The method of claim 2, wherein the prior user wallet activity includes a product barcode price scan.

4. The method of claim 2, wherein the data on the prior user wallet activity includes a geographical location identifier for the prior user wallet activity.

5. The method of claim 4, wherein the grographical location identifier is a computer network address.

6. The method of claim 1, wherein the current transaction request is a service enrollment request.

7. The method of claim 1, wherein the current transaction request is virtual wallet card addition request.

8. The method of claim 1, wherein the current transaction request is a purchase transaction request.

9. The method of claim 8, wherein the purchase transaction request is obtained from a mobile device.

10. The method of claim 1, wherein the transaction risk type is identified based on historical fraud data.

11. The method of claim 1, further comprising:
generating an offer, for an entity involved in processing the current transaction request, of a financial incentive in exchange for assuming the transaction risk level associated with the transaction risk type; and
providing the offer for the entity.

12. The method of claim 11, wherein the entity is one of: a user; a merchant; an issuer; an acquirer; a payment service provider; and a payment network.

13. The method of claim 1, wherein the selection of the security protocol is further based on a burden to respond to the security data request.

14. The method of claim 13, wherein the burden is measured by an amount of user intervention to respond to the security data request.

15. The method of claim 13, wherein the burden is measured by a network bandwidth required to respond to the security data request.

16. The method of claim 13, wherein the selection of the security protocol is based on minimizing the burden to respond to the security data request.

17. The method of claim 1, wherein a burden of the security protocol increases with increase in the transaction risk level associated with the transaction risk type.

18. The method of claim 1, further comprising:
identifying a second transaction risk type associated with the current transaction request;
selecting a second security protocol for processing the current transaction request; and
providing a second security data request in accordance with the selected second security protocol.

19. The method of claim 18, wherein the second security data request is provided for an entity different than the one for which the security data request is provided.

20. The method of claim 1, wherein the calculation of the transaction risk level associated with the transaction risk type uses previously obtained security data.

21. A graduated security protocol escalation means, comprising:
means for obtaining a current transaction request, the current transaction request utilizing a user virtual wallet account for purchase payment;
means for identifying a transaction risk type associated with the current transaction request;
means for calculating a transaction risk level associated with the transaction risk type;
means for selecting a security protocol, based on the calculated transaction risk level, for processing the current transaction request; and
means for providing a security data request in accordance with the selected security protocol.

22. The means of claim 21, further comprising:
means for obtaining data on prior user wallet activity associated with the user virtual wallet account from a database; and
wherein the transaction risk type is identified using the data on the prior user wallet activity.

23. The means of claim 22, wherein the prior user wallet activity includes a product barcode price scan.

24. The means of claim 22, wherein the data on the prior user wallet activity includes a geographical location identifier for the prior user wallet activity.

25. The means of claim 24, wherein the grographical location identifier is a computer network address.

26. The means of claim 21, wherein the current transaction request is a service enrollment request.

27. The means of claim 21, wherein the current transaction request is virtual wallet card addition request.

28. The means of claim 21, wherein the current transaction request is a purchase transaction request.

29. The means of claim 28, wherein the purchase transaction request is obtained from a mobile device.

30. The means of claim 21, wherein the transaction risk type is identified based on historical fraud data.

31. The means of claim 21, further comprising:
means for generating an offer, for an entity involved in processing the current transaction request, of a financial incentive in exchange for assuming the transaction risk level associated with the transaction risk type; and
means for providing the offer for the entity.

32. The means of claim 31, wherein the entity is one of: a user; a merchant; an issuer; an acquirer; a payment service provider; and a payment network.

33. The means of claim 21, wherein the selection of the security protocol is further based on a burden to respond to the security data request.

34. The means of claim 33, wherein the burden is measured by an amount of user intervention to respond to the security data request.

35. The means of claim 33, wherein the burden is measured by a network bandwidth required to respond to the security data request.

36. The means of claim 33, wherein the selection of the security protocol is based on minimizing the burden to respond to the security data request.

37. The means of claim 21, wherein a burden of the security protocol increases with increase in the transaction risk level associated with the transaction risk type.

38. The means of claim 21, further comprising:
means for identifying a second transaction risk type associated with the current transaction request;
means for selecting a second security protocol for processing the current transaction request; and
means for providing a second security data request in accordance with the selected second security protocol.

39. The means of claim 28, wherein the second security data request is provided for an entity different than the one for which the security data request is provided.

40. The means of claim 21, wherein the calculation of the transaction risk level associated with the transaction risk type uses previously obtained security data.

41. A graduated security protocol escalation system, comprising:
a processor; and
a memory disposed in communication with the processor and storing processor-executable instructions to:
obtain a current transaction request, the current transaction request utilizing a user virtual wallet account for purchase payment;
identify a transaction risk type associated with the current transaction request;
calculate, via the processor, a transaction risk level associated with the transaction risk type;
select a security protocol, based on the calculated transaction risk level, for processing the current transaction request; and
provide a security data request in accordance with the selected security protocol.

42. The system of claim 41, the memory further storing instructions to:
obtain data on prior user wallet activity associated with the user virtual wallet account from a database; and
wherein the transaction risk type is identified using the data on the prior user wallet activity.

43. The system of claim 42, wherein the prior user wallet activity includes a product barcode price scan.

44. The system of claim 42, wherein the data on the prior user wallet activity includes a geographical location identifier for the prior user wallet activity.

45. The system of claim 44, wherein the grographical location identifier is a computer network address.

46. The system of claim 41, wherein the current transaction request is a service enrollment request.

47. The system of claim 41, wherein the current transaction request is virtual wallet card addition request.

48. The system of claim 41, wherein the current transaction request is a purchase transaction request.

49. The system of claim 48, wherein the purchase transaction request is obtained from a mobile device.

50. The system of claim 41, wherein the transaction risk type is identified based on historical fraud data.

51. The system of claim 41, the memory further storing instructions to:
generate an offer, for an entity involved in processing the current transaction request, of a financial incentive in exchange for assuming the transaction risk level associated with the transaction risk type; and
provide the offer for the entity.

52. The system of claim 51, wherein the entity is one of: a user; a merchant; an issuer; an acquirer; a payment service provider; and a payment network.

53. The system of claim 41, wherein the selection of the security protocol is further based on a burden to respond to the security data request.

54. The system of claim 53, wherein the burden is measured by an amount of user intervention to respond to the security data request.

55. The system of claim 53, wherein the burden is measured by a network bandwidth required to respond to the security data request.

56. The system of claim 53, wherein the selection of the security protocol is based on minimizing the burden to respond to the security data request.

57. The system of claim 41, wherein a burden of the security protocol increases with increase in the transaction risk level associated with the transaction risk type.

58. The system of claim 41, the memory further storing instructions to:
identify a second transaction risk type associated with the current transaction request;
select a second security protocol for processing the current transaction request; and
provide a second security data request in accordance with the selected second security protocol.

59. The system of claim 58, wherein the second security data request is provided for an entity different than the one for which the security data request is provided.

60. The system of claim 41, wherein the calculation of the transaction risk level associated with the transaction risk type uses previously obtained security data.

61. A computer-readable tangible medium storing computer-executable graduated security protocol escalation instructions to:
obtain a current transaction request, the current transaction request utilizing a user virtual wallet account for purchase payment;
identify a transaction risk type associated with the current transaction request;
calculate a transaction risk level associated with the transaction risk type;
select a security protocol, based on the calculated transaction risk level, for processing the current transaction request; and
provide a security data request in accordance with the selected security protocol.

62. The medium of claim 61, further storing instructions to:
obtain data on prior user wallet activity associated with the user virtual wallet account from a database; and
wherein the transaction risk type is identified using the data on the prior user wallet activity.

63. The medium of claim 42, wherein the prior user wallet activity includes a product barcode price scan.

64. The medium of claim 62, wherein the data on the prior user wallet activity includes a geographical location identifier for the prior user wallet activity.

65. The medium of claim 64, wherein the grographical location identifier is a computer network address.

66. The medium of claim 61, wherein the current transaction request is a service enrollment request.

67. The medium of claim 61, wherein the current transaction request is virtual wallet card addition request.

68. The medium of claim 61, wherein the current transaction request is a purchase transaction request.

69. The medium of claim 68, wherein the purchase transaction request is obtained from a mobile device.

70. The medium of claim 61, wherein the transaction risk type is identified based on historical fraud data.

71. The medium of claim 61, further storing instructions to:
generate an offer, for an entity involved in processing the current transaction request, of a financial incentive in exchange for assuming the transaction risk level associated with the transaction risk type; and
provide the offer for the entity.

72. The medium of claim 71, wherein the entity is one of: a user; a merchant; an issuer; an acquirer; a payment service provider; and a payment network.

73. The medium of claim 61, wherein the selection of the security protocol is further based on a burden to respond to the security data request.

74. The medium of claim 73, wherein the burden is measured by an amount of user intervention to respond to the security data request.

75. The medium of claim 73, wherein the burden is measured by a network bandwidth required to respond to the security data request.

76. The medium of claim 73, wherein the selection of the security protocol is based on minimizing the burden to respond to the security data request.

77. The medium of claim 61, wherein a burden of the security protocol increases with increase in the transaction risk level associated with the transaction risk type.

78. The medium of claim 61, further storing instructions to:
identify a second transaction risk type associated with the current transaction request;
select a second security protocol for processing the current transaction request; and
provide a second security data request in accordance with the selected second security protocol.

79. The medium of claim 78, wherein the second security data request is provided for an entity different than the one for which the security data request is provided.

80. The medium of claim 61, wherein the calculation of the transaction risk level associated with the transaction risk type uses previously obtained security data.
